(19) United States
(12) Patent Application Publication
(10) Pub. No.: US 2011/0111378 A1
(43) Pub. Date: May 12, 2011

(54) SYSTEM AND METHOD OF TEACHING AND LEARNING MATHEMATICS

(76) Inventor: Huong Nguyen, Seattle, WA (US)

(21) Appl. No.: 12/942,829

(22) Filed: Nov. 9, 2010

Related U.S. Application Data
(63) Continuation-in-part of application No. 11/955,315, filed on Dec. 12, 2007, now Pat. No. 7,914,287.
Application No. 11/955,315 is a continuation-in-part of application No. 11/381,964, filed on May 5, 2006, now Pat. No. 7,309,233.
(60) Provisional application No. 60/678,048, filed on May 5, 2005.

(51) Int. Cl. G09B 19/02

(52) U.S. Cl. 434/204

(57) ABSTRACT

Numero Cubes and the Whole Number System are disclosed. In one embodiment, the system may comprise cubes, pegs, magnets, dividers, shafts, and a number placement panel. The shafts may comprise individual marks representing the base ten number system. The system may provide a method of learning mathematics through a cognitively authentic learning experience in constructing and building numbers.

### CROSS REFERENCE TO RELATED APPLICATIONS

This application is a continuation-in-part of and incorporates by reference in its entirety to U.S. patent application Ser. No. 11/955,315 filed Dec. 12, 2007, a continuation-in-part of U.S. patent application Ser. No. 11/381,964 filed May 5, 2006, now U.S. Pat. No. 7,309,233 that in turn claims the benefit of priority to and incorporates by reference in its entirety U.S. Provisional Application No. 60/678,048 filed May 5, 2005.

All patent applications incorporated by reference in their entirety.

### COPYRIGHT NOTICE

This disclosure is protected under United States and International Copyright Laws.© 2005 Huong Nguyen. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to a method of teaching mathematics, and in particular, to a method of teaching mathematics using visual aids.

### BACKGROUND OF THE INVENTION

Current methods of teaching mathematics using manipulatives may not be effective in providing a concrete, simple, and in-depth learning experience that promotes a successful rate of learning among school children. Using the typical manipulative techniques, students may have problems recognizing numbers, constructing numbers, adding, subtracting, etc. The explaining process frequently is so complicated that children get lost and may not remember the process the next time they are asked to recall the information. Because children have to rely heavily on memorized mathematical facts and road map memorization, their performance on annual academic tests have been relatively low. Currently, the United States is ranked 42nd amongst the world in mathematics.

Generally, traditional teaching methods do not provide stimulating and engaging experiences in learning mathematical concepts.

### BRIEF DESCRIPTION OF THE DRAWINGS

FIGS. 1A-1G show various components of one embodiment of the present invention;

FIGS. 2A and 2B show an assembled ten unit and an assembled one hundred unit with tray, respectively, of an embodiment of the present invention;

FIG. 3 shows an embodiment of a Numero Placement Panel of the present invention;

FIG. 4 shows the first 10 whole numbers represented by an embodiment of the present invention;

FIGS. 5-23C illustrate the present invention, according to different embodiments;

FIG. 24A-C illustrate top, cross-sectional, and bottom views of an alternate embodiment of the Numero Cube;

FIG. 25A-F illustrate partial top, cross-sectional, and partial bottom views of an alternate embodiment of the Numero Cube base;

FIG. 26A-B illustrates side, and top views of alternate embodiments of the peg and peg base;

FIG. 27A-D illustrates additional views of the peg base;

FIG. 28 illustrates a magnet insert for the Numero Cube base;

FIGS. 29A-B illustrates side and top views of the iron insert for the peg base;

FIGS. 30A-C illustrate cross-sectional, side, and bottom views of an alternate embodiment of a top cap;

FIGS. 31A-C illustrate orthographic views of an alternate embodiment of a number separator;

FIG. 32 schematically illustrates a perspective view of the parts of a Numero Cube System kit laid out for manipulation by a user;

FIG. 33 schematically illustrates as numbers 0-9 suing the Numero Cube System;

FIGS. 34-46 respectively illustrated sequential perspective views of the number cube system laid out for manipulation by a user for numbers 10, 11, 19, 20, 24, 99, 110, 106, 110, 145, 199, 200, and 124;

FIGS. 47-48 illustrate examples of number decomposition;

FIGS. 49-52 schematically illustrate methods employed by the Numero Cube System 10 to demonstrate the Counting Principle and properties of even and odd numbers;

FIGS. 53 and 54 schematically illustrate a method of using the Numero Cube System 10 to visually demonstrate comparing numbers 33 and 213 respectively;

FIGS. 55-56 schematically illustrates methods of using the kit components of the Numero Cube System 10 with regards to teaching addition without Regrouping;

FIGS. 57-58 schematically illustrates methods of using the kit components of the Numero Cube System 10 with regards to teaching addition with Regrouping;

FIGS. 59-60 schematically illustrates methods of using the kit components of the Numero Cube System 10 with regards to teaching subtraction without Regrouping;

FIGS. 61 and 62 schematically illustrate a first method of using the kit components of the Numero Cube System 10 with regards to teaching subtraction with Regrouping for the term 23-7;

FIGS. 63 and 64 schematically illustrate a second method of using the kit components of the Numero Cube System 10 with regards to teaching subtraction with Regrouping for the term 23-7;

FIGS. 65-68 schematically illustrate methods of using the Numero Cube System 10 in algebraic operations involving division having no remainders or having remainders;

FIGS. 69-70 schematically illustrates use of the Numero Cube System 10 in pre-algebra operations to determine the unknown in equations involving addition and subtraction through use of the number separators 125;

FIG. 71 schematically illustrates a method of using the Numero Cube System 10 to determine the unknown of a product;

FIG. 72 schematically illustrates a method of using the Numero Cube System 10 to determine the value “n” for a series of equations involving addition and subtraction; and

FIGS. 71-76 schematically illustrate methods of using the components of the Numero Cube System 10 for solving for the unknown “n” in addition, subtraction, a product, and in a complex algebraic equation.

### DETAILED DESCRIPTION OF THE INVENTION

Disclosed herein are systems and methods for teaching mathematics using the Numero Cubes and/or Whole Number System. In one embodiment, the invention provides an effective and logical solution to teaching mathematics. Students become engaged and active thinkers in the process of seeking out solutions to their given challenging math problems. In one particular embodiment, the Math Logic teaching method may promote self-esteem, resiliency, and teamwork.

In another embodiment, the invention utilizes the base 10 number system. Students may touch, examine, count, compare numbers, develop mathematical patterns, add, multiply, divide, and/or perform simple fractions visually. Students may actively engage in concrete and sequential learning experiences that help them retain information in their short- and long-term memory. Students may think, analyze, evaluate, and construct their solutions to given challenging math problems. The Numero Cubes and/or Whole Number system may offer visual tools to help students accomplish mathematical goals and learning objectives. For example, students may be asked to analyze the number one hundred. In one embodiment, one hundred may be assembled from 10 ten units using two rectangular bars of magnets. These magnets may hold the 10 ten units together. Students may collaborate to create a one hundred unit or may work independently. This may provide an integration of math (i.e. the numbers) and science (i.e. the magnets) and students may learn how science can be used to solve a math problem.

In another embodiment, the invention may permit students to build and/or take apart their creation. For example in subtraction, students may be asked to remove a number of cubes from a peg. The answer to the subtraction problem is what remains on the peg. In another embodiment, students may remove the top peg off of 1 ten unit to have 10 individual cubes when they need to borrow 1 ten. Students may also remove the magnetic bars to have 10 tens when they need to borrow 1 hundred. Therefore, learning may become a visual and/or logical task.

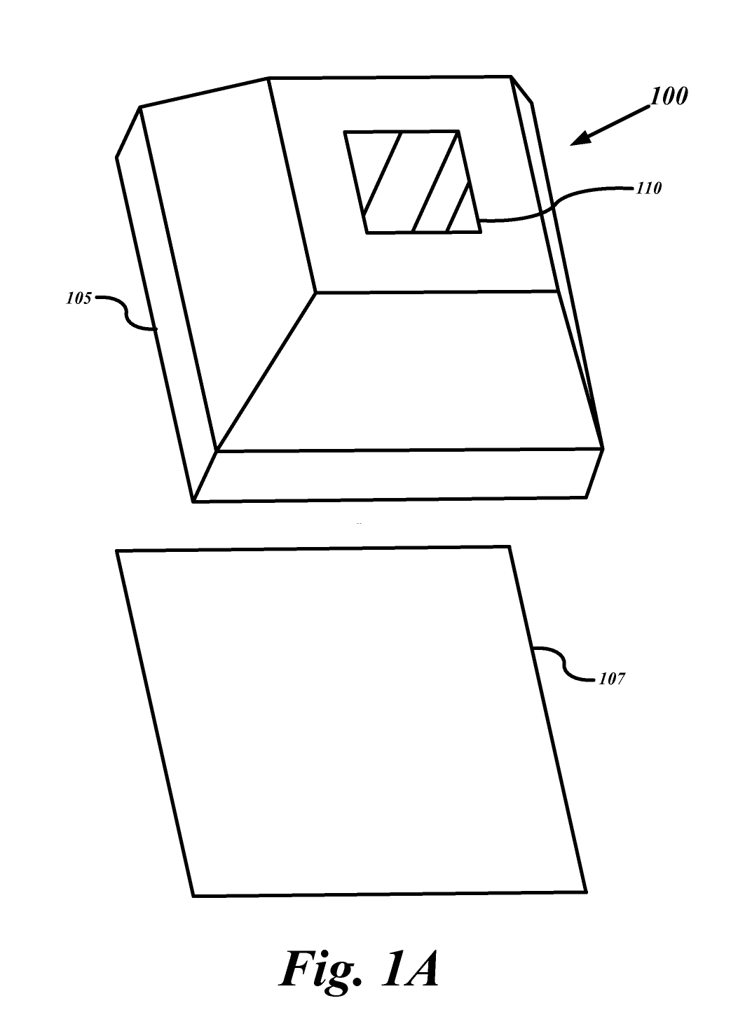

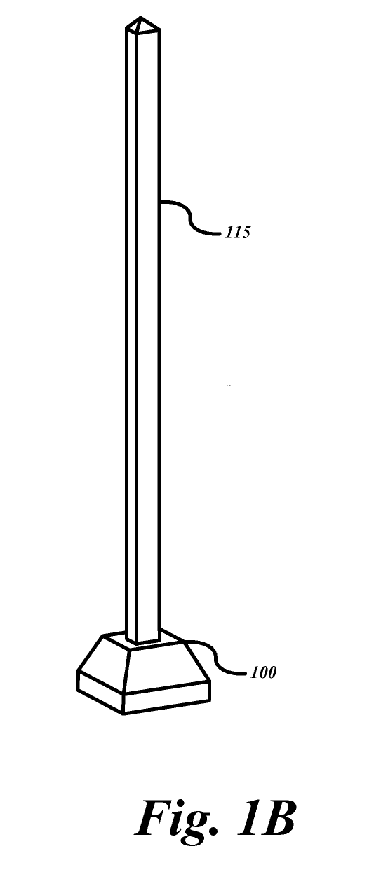

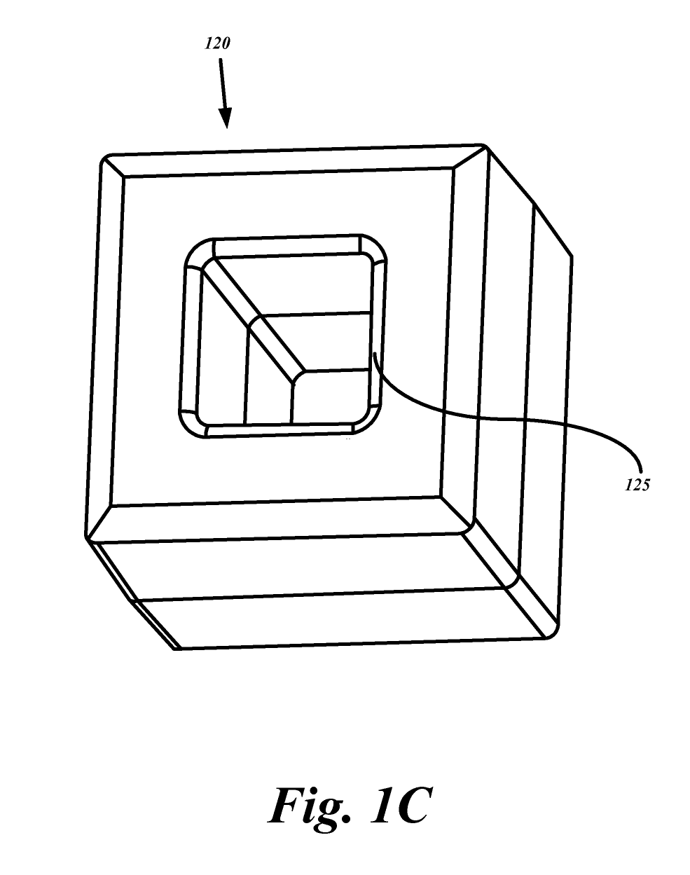

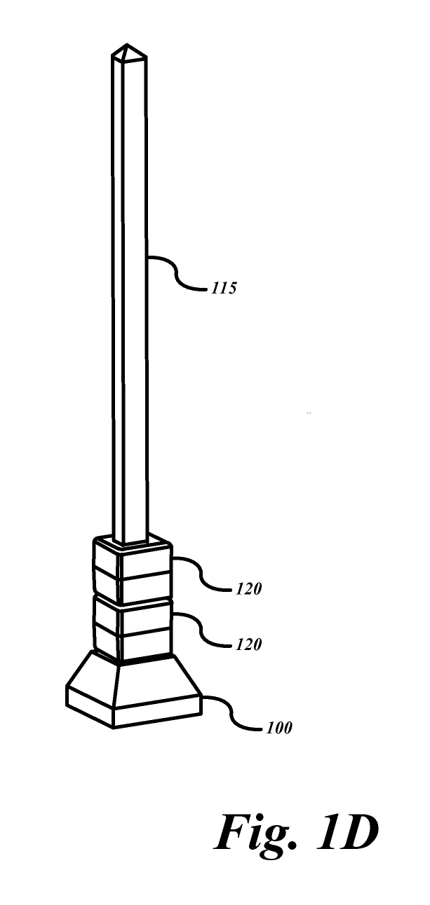

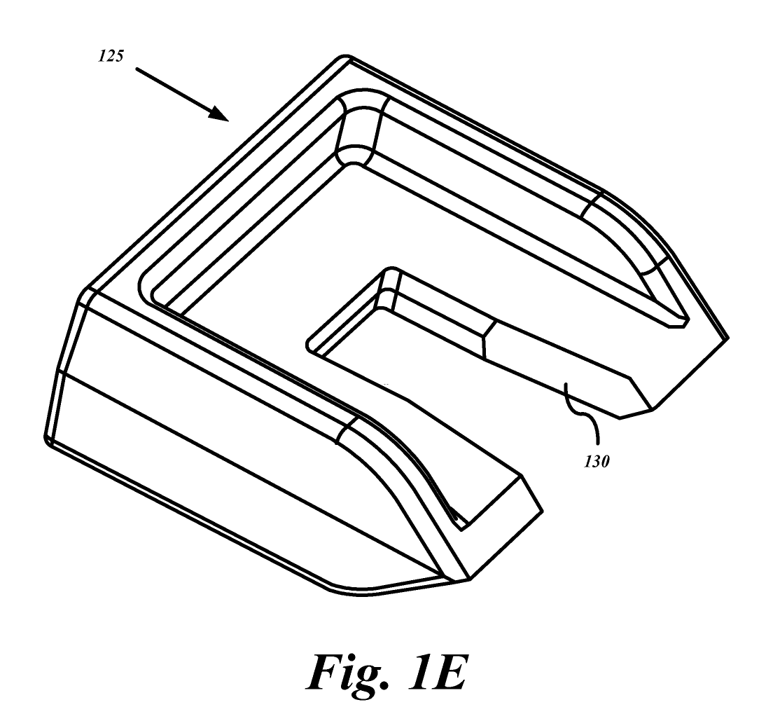

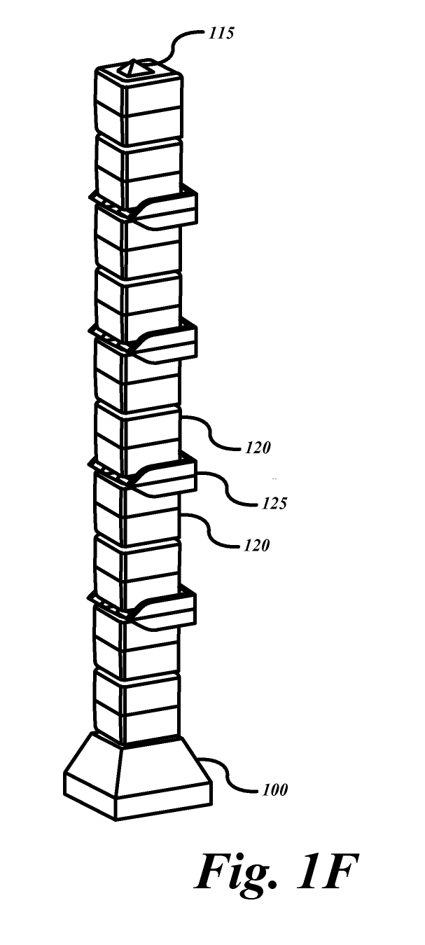

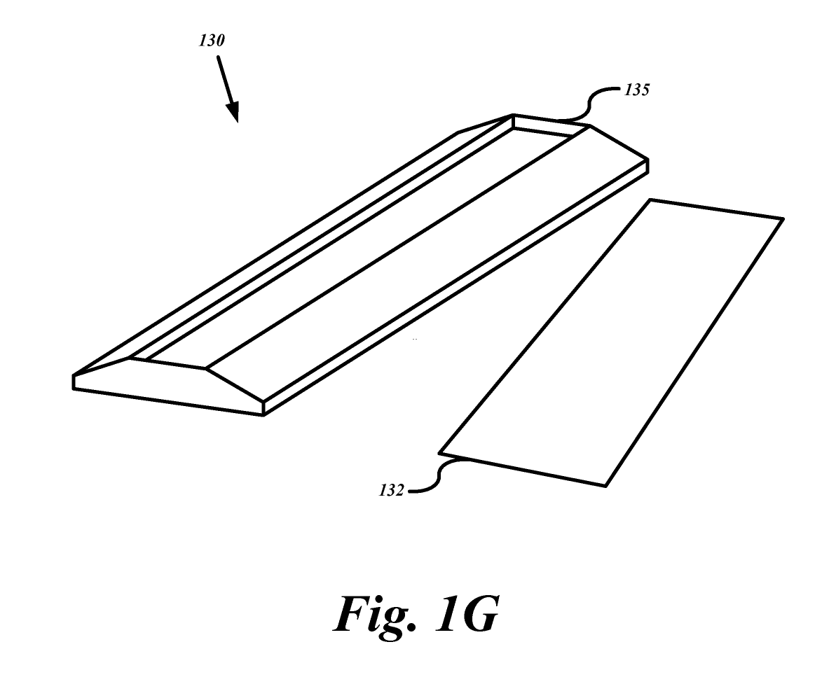

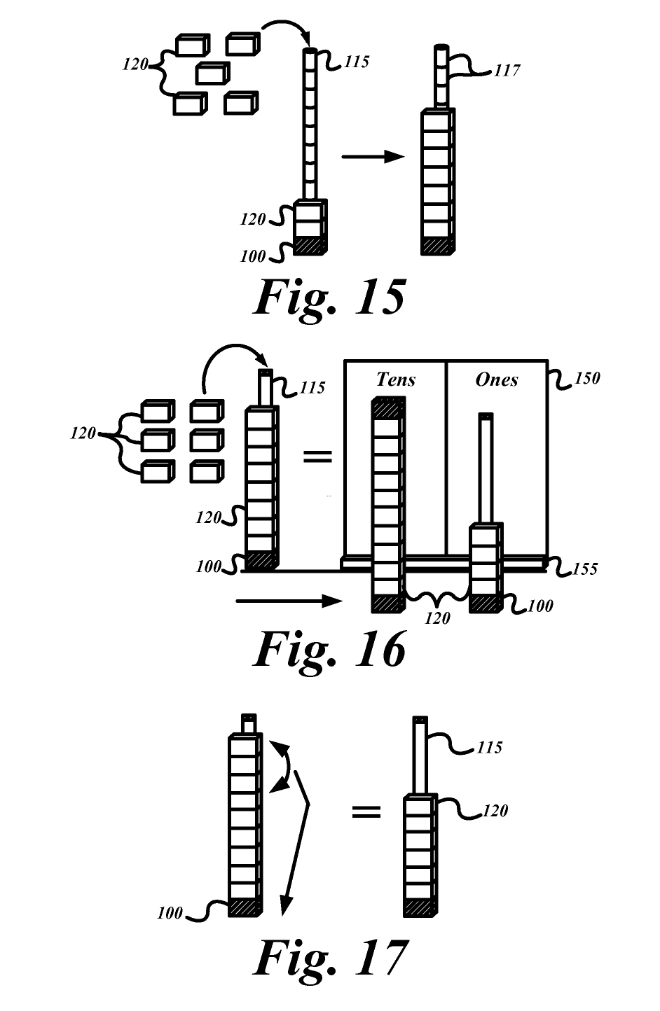

FIGS. 1A-1G shows various components of one embodiment of the present invention. FIG. 1A shows a peg 100 which includes a base 105 and a shaft receptacle 110. The base 105 may include a magnet, for example a magnetic plate 107 attached to the bottom of the base 105. FIG. 1B shows the peg 100 of FIG. 1A with an attached shaft 115. The shaft 115 may be inserted into the shaft receptacle 110 and held in place by friction, or by various attachment means such as nails or screws (not shown). The shaft 115 may include marks 117 (FIG. 15) corresponding inscribed on the shaft. FIG. 1C shows a cube 120. The cube 120 defines a sleeve 125 of a size and/or shape that allows insertion of the shaft 115 into the sleeve 125 and allows the sleeve 125 to freely slide along the length of the shaft 115. FIG. 1D shows a peg 100 with attached shaft 115 and a pair of cubes 120 inserted onto the shaft 115. FIG. 1E shows a divider 125 defining an open slot 130. The slot 130 is sized to accept a shaft 115 when the divider 125 is placed between cubes 120 on a shaft 115, as shown in FIG. 1F. FIG. 1G shows a tray 130 defining a peg receptacle 135 sized to allow pegs 100 to be placed in the receptacle 135. In one embodiment, ten pegs 100 may fit in the receptacle 135. The tray 130 may include a magnet, for example a magnetic plate 132 attached to the bottom of the tray 130.

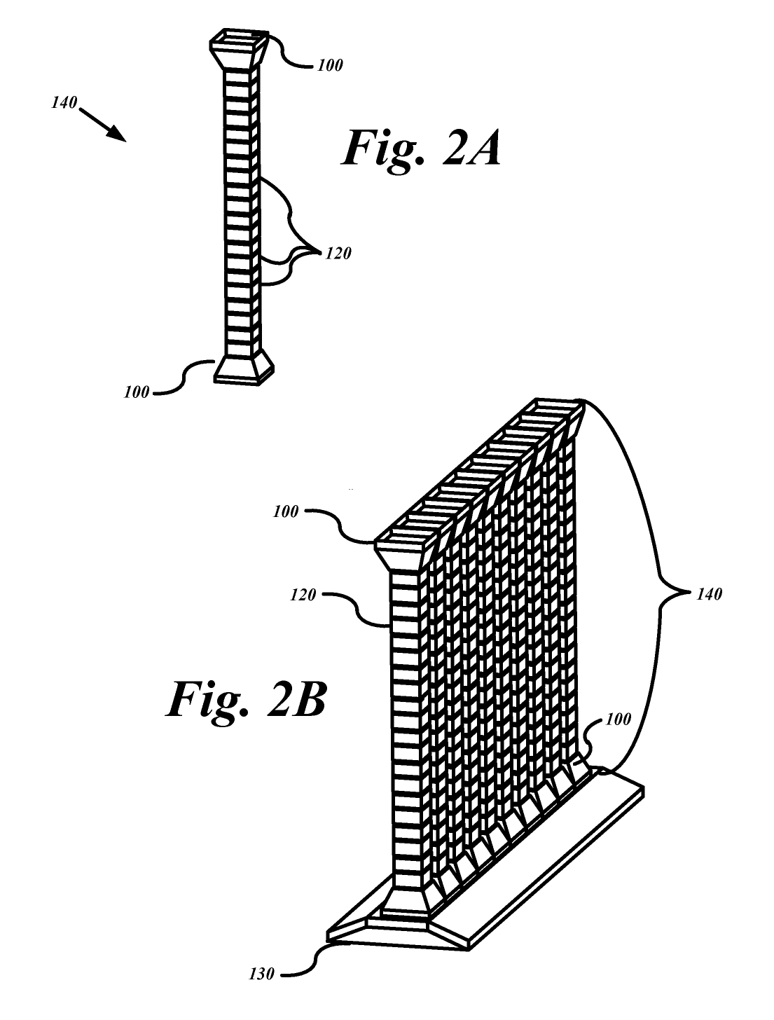

FIG. 2A shows an assembled ten unit 140. The unit 140 includes a shaft (not shown) with ten cubes 120 and a peg 100 attached to each end of the shaft 115, the pegs 100 attached securely enough to prevent the cubes 120 from slipping off of the shaft 115. FIG. 2B shows an assembled hundred unit 145 made up of ten ten units 140. The unit 145 includes ten shafts 115, each with 10 cubes 120 and two pegs 100 attached. One end of each shaft 115 with attached peg 100 is placed in the tray 130. The magnetic plate 132 of the tray 130 may act with the magnetic plate 107 of each peg 100 to exert an attractive force between the tray 130 and the pegs 100. This configuration may aid in manipulation of the unit 145 and/or prevent the unit 145 from falling apart.

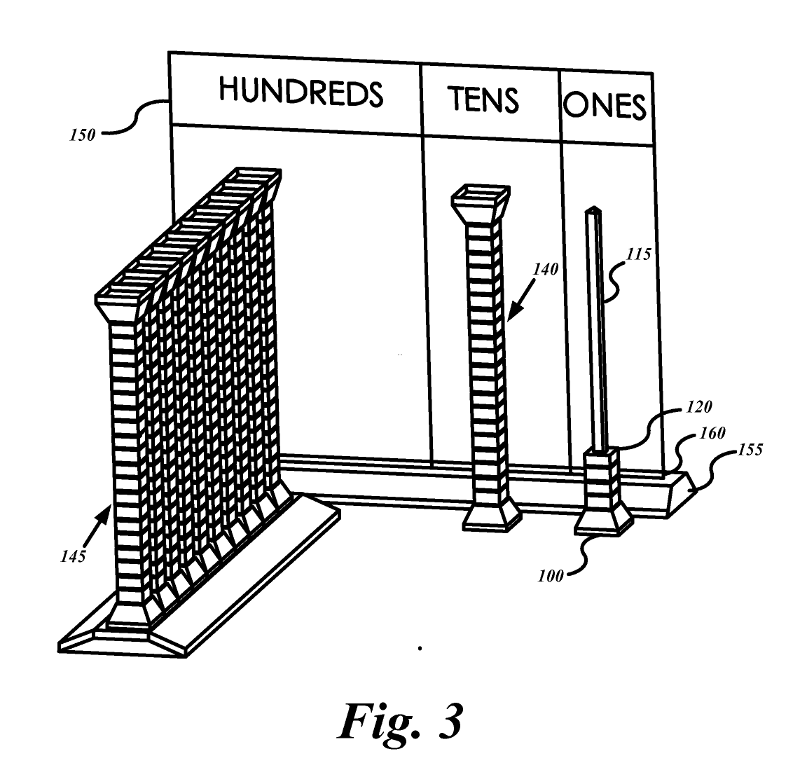

FIG. 3 shows an assembled hundred unit 145, an assembled ten unit 140, a peg 100 and shaft 115 with two cubes 120, and a placement panel 150 and a panel tray 155 defining a panel slot 160. The panel 150 may be a translucent sheet of plastic sized to fit in the panel slot 160. The panel 150 may include a marked hundreds section 152, a tens section 154, and a ones section 156. The panel 150 may provide a concrete image as to why the number 100 is written as 1 with two consecutive 0.

Math Logic comprises an inductive teaching method that may provide students (not shown) with a learning tool to learn mathematics successfully and effectively using cubes 120, pegs 100, placement panel 150, and/or dividers 125. One will appreciate however, that other suitable embodiments of the invention may vary the sizes and/or shapes of the individual components. For example, the pegs 100 may comprise other digit holders, including fasteners and/or security devices such as pins and/or plugs. The pegs 100 may further comprise adhesive or attractive patches or plates, such as magnets and/or Velcro®. In other embodiments, the cubes 120 may comprise any suitable geometric shape, including cube-shaped, rectangular and/or cylindrical.

In another embodiment, students may be able to compare numbers and/or predict a pattern of numbers. This may allow students to perform addition and/or subtraction. Students may be engaged in authentic learning experiences through constructing, building, analyzing, and/or evaluating their processes in finding solutions to challenging and difficult math problems. Generally, young children's′ textbooks and counting books introduce the number 1 as the first number, not zero. In one embodiment of the present invention, zero is the first number of the whole number system. Under the typical method of learning, children may not understand the concept of the number 0 and may not comprehend what zero means as a place holder in numbers such as 10, 100, 1000, etc.

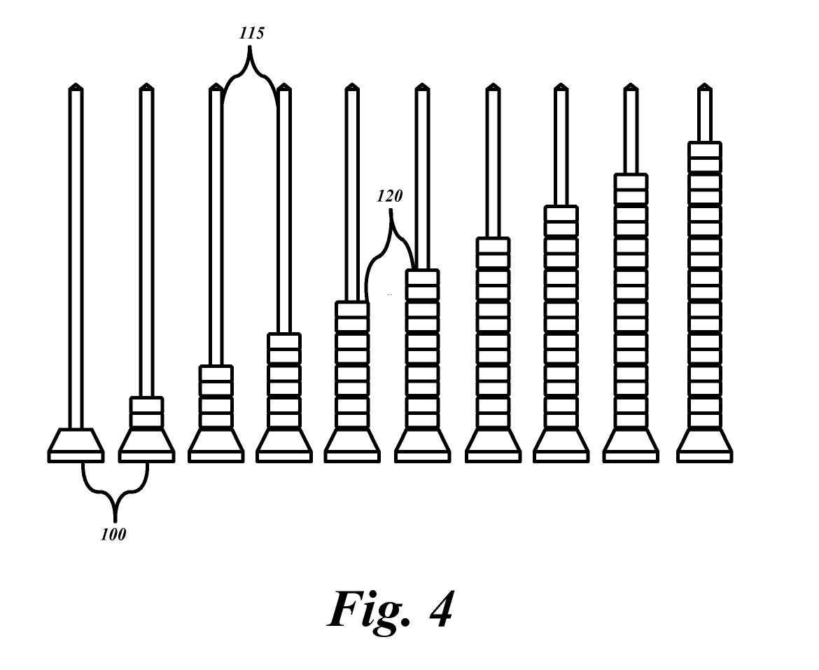

An embodiment of the present invention may show students and young children the importance of the number zero. In one embodiment, zero is the first number of the base 10 whole number system. The peg 100 may be black and each cube 120 white, although any suitably contrasting colors may be applied. Where there is no cube 120 placed on the peg 100, children may clearly visualize the number zero. In one embodiment, zero indicates that there is no cube on the peg. In another embodiment, the base 10 number system comprises 10 basic numbers, 0, 1, 2, 3, 4, 5, 6, 7, 8, and 9. FIG. 4 shows these basic ten numbers represented by an embodiment of the present invention.

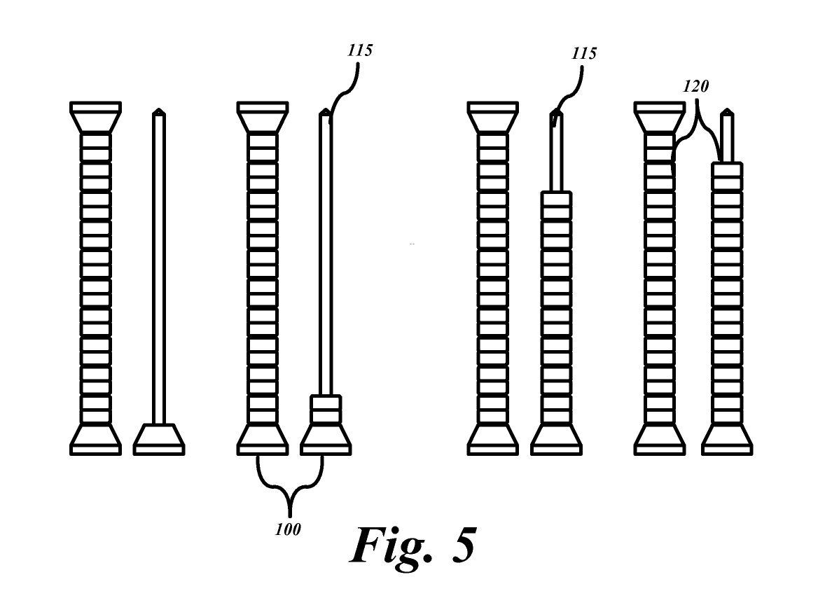

Other numbers may be formed based on basic 10 numbers, 0 through 9. In one embodiment, the one digit number reaches 9 and returns back to 0, thereby forming a pattern. In another embodiment, a second digit, ten, for example, is formed. FIG. 5 shows four two-digit numbers ten, eleven, eighteen, and nineteen, represented in one aspect of the invention.

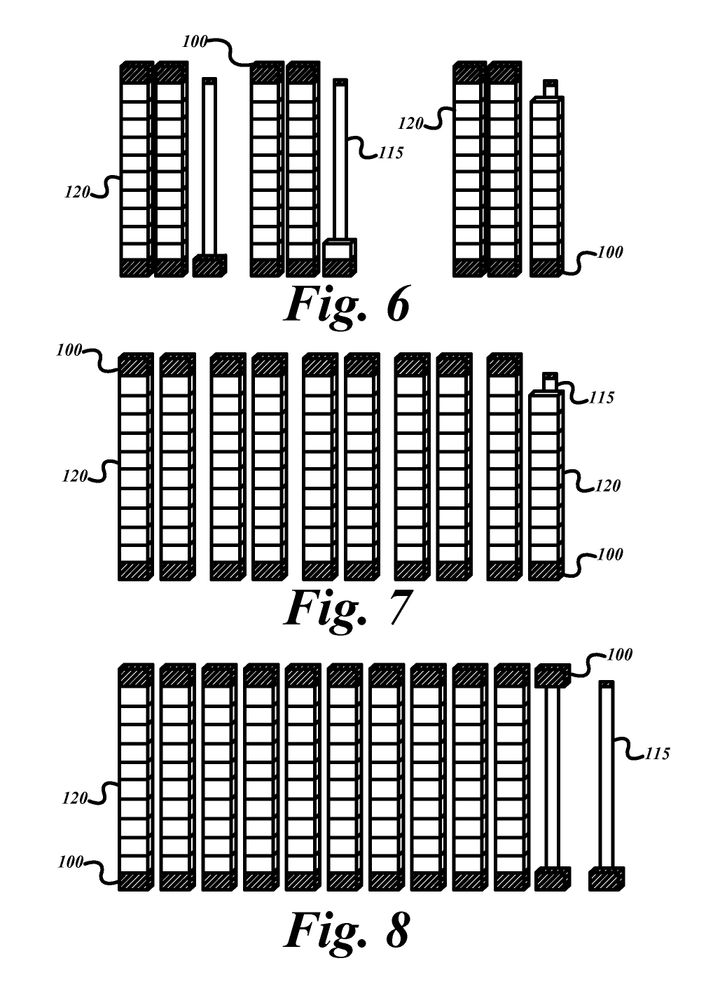

FIG. 6 shows the numbers twenty, twenty-one, and twenty-nine represented by an embodiment of the invention.

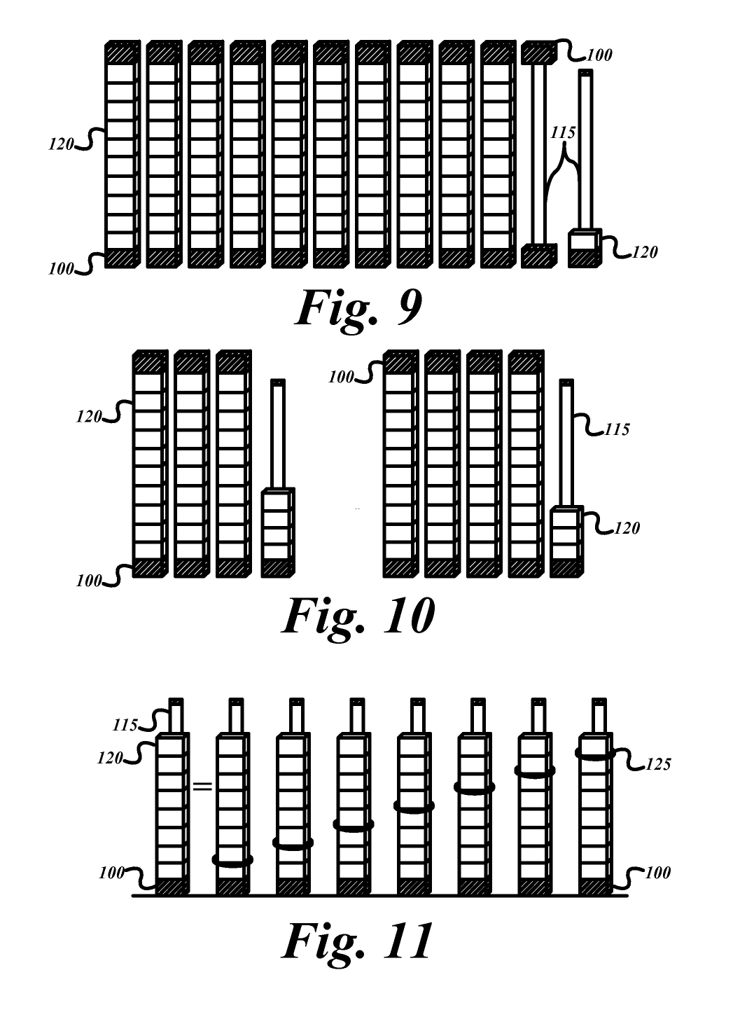

FIG. 7 shows the largest two digit number, ninety-nine, represented by an embodiment of the invention.

FIG. 8 shows the smallest three digit number, one hundred. One hundred may comprise 1 hundred, zero ten, and zero one. The ten and one pegs 100 may have no cubes 120. Students may work together to form 100. An embodiment may show students what each number looks like. Students may see and build numbers.

FIG. 9 shows the number one hundred-one. One hundred-one comprises 1 hundred, 0 ten, and 1 one. The pegs 100 may be used as digit holders. Using the pegs 100, students may decide how many cubes 120 to use and what to do to form each number.

Using an embodiment of the present invention, students may compare numbers. Students may compare numbers using the ‘>’ sign. For example, to compare 34 and 43 students may construct and/or visualize 3 tens and 4 ones in 34 and 4 tens and 3 ones in 43. FIG. 10 shows this comparison.

Still referring to FIG. 10, students may explore other mathematical concepts such as finding the number that succeeds a given number or finding the number that precedes a given number. To find the number that precedes a given number, students may remove a cube 120 from a shaft 115. To find the number that succeeds a given number, students may add a cube 120 to a shaft 115.

Students may separate a given number into a sum. FIG. 11 illustrates separation of a given number to different sums of two numbers. Using the cubes 120 and pegs 100, students may separate a given number into a sum of two or three numbers swiftly, systematically, and accurately. It will be appreciated, however, that other divisions of numbers may be appropriate, including four, five, etc. Students may predict a definite pattern of different sums. Students may systematically separate the given number into different sum using a divider 125, as shown in FIG. 11.

Cubes 120 and dividers 125 may provide students with a systematic method of separating a given number into different sums, although other suitable configurations for separating may be applicable including rope, twine, and/or wire (not shown). By doing this, students may begin to see that a number may be the sum of several combinations of numbers. For example, the number 8 may be a sum of different combinations of 1 through 7. In one embodiment, students may be taught summation before learning addition. In other embodiments, students may be taught summation and addition simultaneously. This process may decrease the time students may take in learning how to add. For example, students may learn that 8=1+7=7+1=2+6=6+2=3+5=5+3. This may comprise a commutative property that students may learn later in algebra.

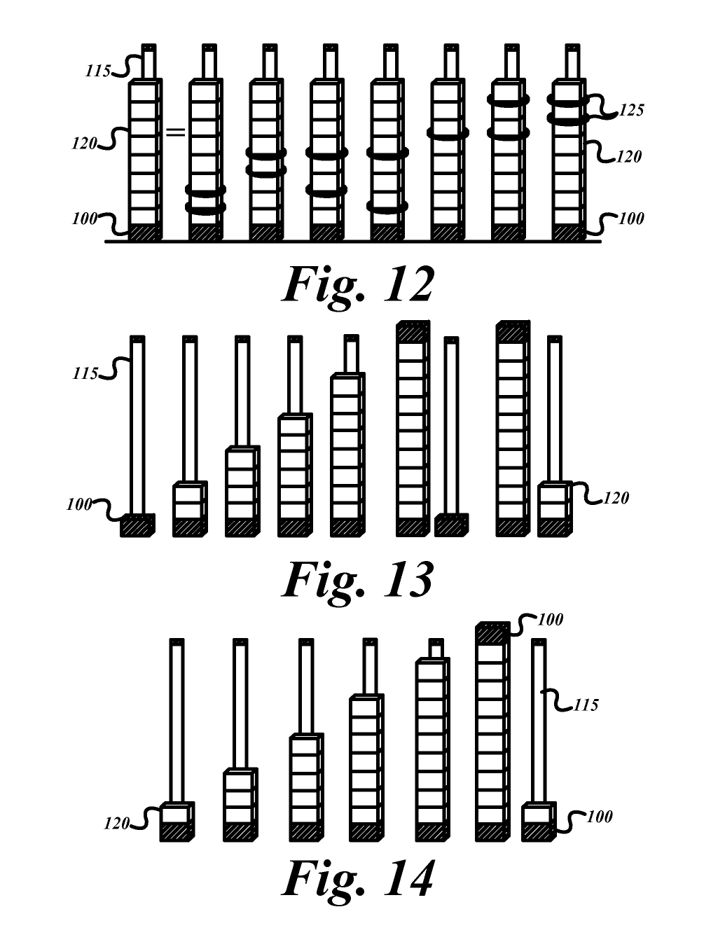

FIG. 12 shows separations of a given number into sums of three different numbers. In one particular embodiment, students may learn that 8=1+1+6=2+1+5=3+1+4=2+2+4=5+2+1=4+2+2=6+1+1. This may also comprise a commutative property that students may learn in algebra. Thus, cubes 120, pegs 100 and dividers 125 may allow students to separate a number into different sums of numbers, although other suitable configurations are applicable. Students may write equations and explore the commutative property further.

Students may learn to find consecutive odd and even numbers using cubes 120 and dividers. Students may work in groups, discuss and collaborate with each other over the meaning of even numbers and/or how to find the next several consecutive even numbers. Even numbers may be explored beginning with the number zero. Students may determine the next succeeding even number by using cubes 120. Students may be asked to determine what these numbers have in common. Students may be asked to find the next even number. By being asked directed questions, students may discover a pattern in determining even numbers. Students may direct questions at one another or explore questions cooperatively. FIG. 13 shows the numbers zero, two, four, six, eight, ten, and twelve as represented by an embodiment of the present invention.

FIG. 14 illustrates odd numbers. A teacher (not shown) may define and/or explain the term “odd numbers”, as well as other related mathematical and/or scientific terms. The teacher may begin with the first odd number, 1, illustrated by one cube 120 on a shaft 115, although one will appreciate starting at any odd number and working up or down from there. To find the next odd number, students may add two cubes 120 to the shaft 115. The next several odd numbers 1, 3, 5, 7, 9, 11, etc., may be shown in a similar manner.

Thus, to find the next even or odd number, students may add two cubes 120 to the current number of cubes 120 already on the shaft 115. Students may start with a first even number, add two cubes 120 to the shaft 115 and determine the next even consecutive number, although one will appreciate starting at any even number and working up or down from there. Students may analyze the differences and similarities between even and odd numbers.

Students may explore number theory before moving onto addition. Students may learn to understand number structure and how to manipulate digits before adding and subtracting. Students may think, analyze, compare and evaluate their work and their learning may become authentic and engaging.

Using an embodiment of the present invention, students may learn addition. By using the cubes 120, students may visualize the process of adding numbers. FIG. 15 shows an example representation of adding two numbers, five and two. Two cubes 120 are placed on the shaft 115 and five more cubes 120 are added. The sum is shown directly on the shaft 115. Further, as shown in FIG. 16, students may add other numbers using the cubes 120 and shafts 115. In one example, students may add six to eight. Because the sum is larger than 10 in this case, students may have to use a peg 100 to enclose the ten cubes 120 on the shaft 115 to make a ten unit 140. One shaft 115 may not be enough because each shaft 115 may only hold ten cubes 120. Students may have to use a second shaft 115 to hold cubes 120 in excess of ten.

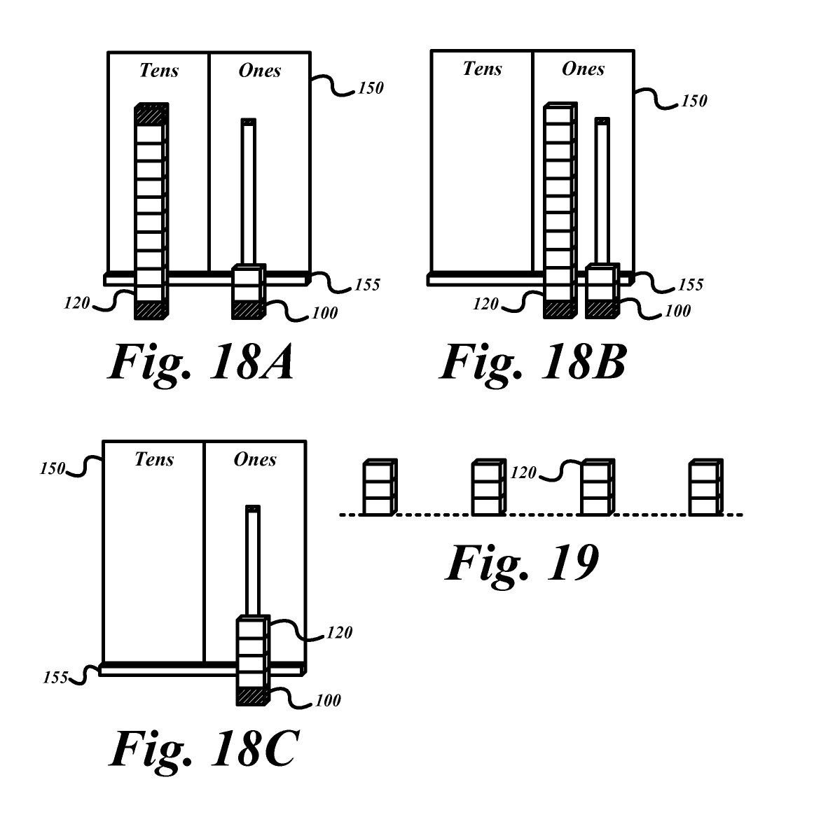

Students may learn subtraction by visualizing the subtraction concept using an embodiment of the present invention. To perform the subtraction, students may remove a number of specified cubes 120 from the existing number of cubes 120 on a shaft 115. The remaining number of cubes 120 left on the shaft 115 is the resultant number. FIG. 17 shows a representation of subtracting three from nine. Students may remove a number of cubes 120 on a given shaft 115. In another example shown in FIGS. 18A-18C, students may subtract but may have to borrow a ten unit 140 because they do not have enough cubes 120 on a given shaft 115.

Traditional methods of teaching and learning multiplication require students to memorize math facts. Students who do not learn basic multiplication math facts may not learn advance multiplication, division, fraction, and/or other advanced mathematical concepts. Math Logic teaching method may provide students with a method to explore multiplication without having to recite the multiplication table. Students may determine a product of a multiplication equation in terms of connection between multiplication and addition. Using cubes 120 and shafts 115, students may learn why the product of 5×0=0 and why 4×3=3×4. The student's addition skill may be reinforced during the process of finding each product.

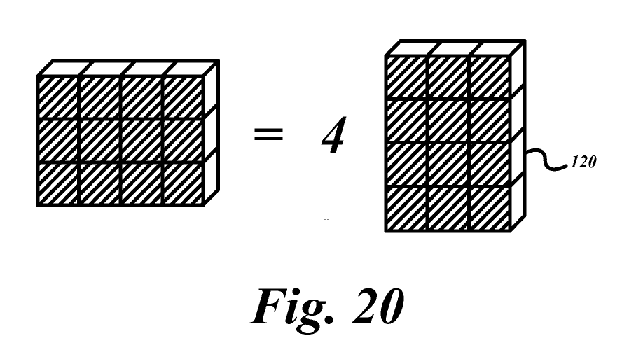

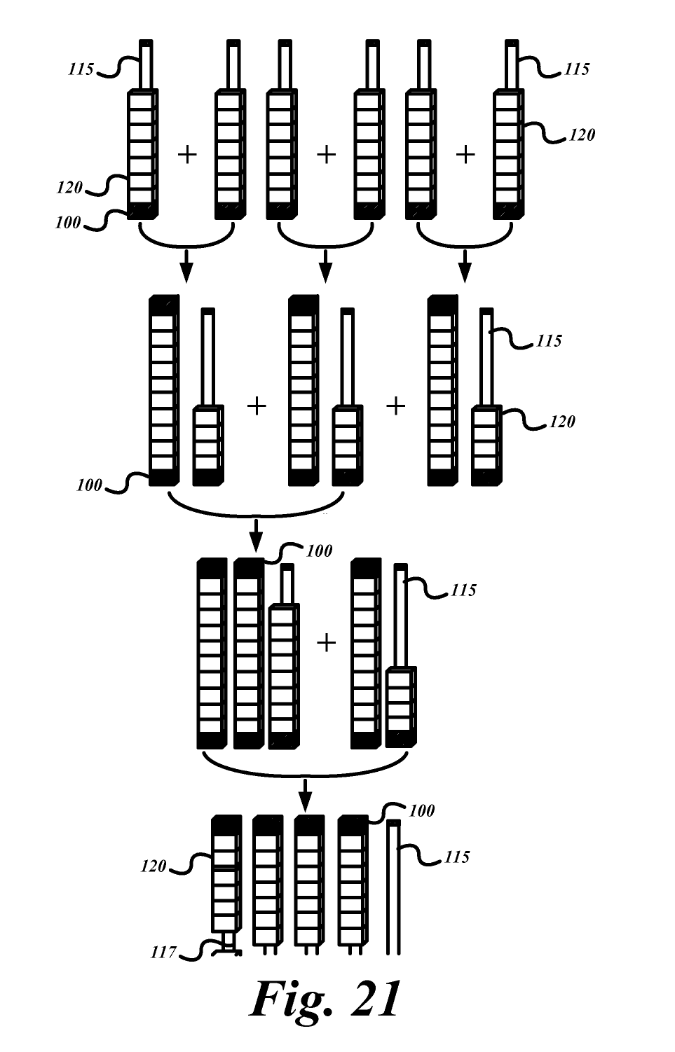

For example, students may be asked to analyze and/or write down a mathematical observation. Their job may be to write some kind of equation to express what they see visually and how they may connect what they see to addition. Students may have to answer questions while going through the analysis phase. For example, they may ask themselves: Is there a pattern here? How many total cubes 120 do I have? How may I write an equation to express the given information? How may I write an equation to show some form of addition here? A sample scenario is illustrated in FIG. 19. Each product 3×4 may be represented by cubes 120. The resulting product is the actual number of cubes 120, as illustrated in FIG. 20.

Math Logic may provide students and young children an effective method of finding the answer for each product without memorizing the multiplication tables. Students may learn to add in groups. Young children's addition skill may be reinforced as they try to find the answer for each product, as illustrated in FIG. 21, for example. Students may develop a concept of 6×7 as meaning six groups of seven. They may learn to find the answer to a multiplication problem by adding numbers.

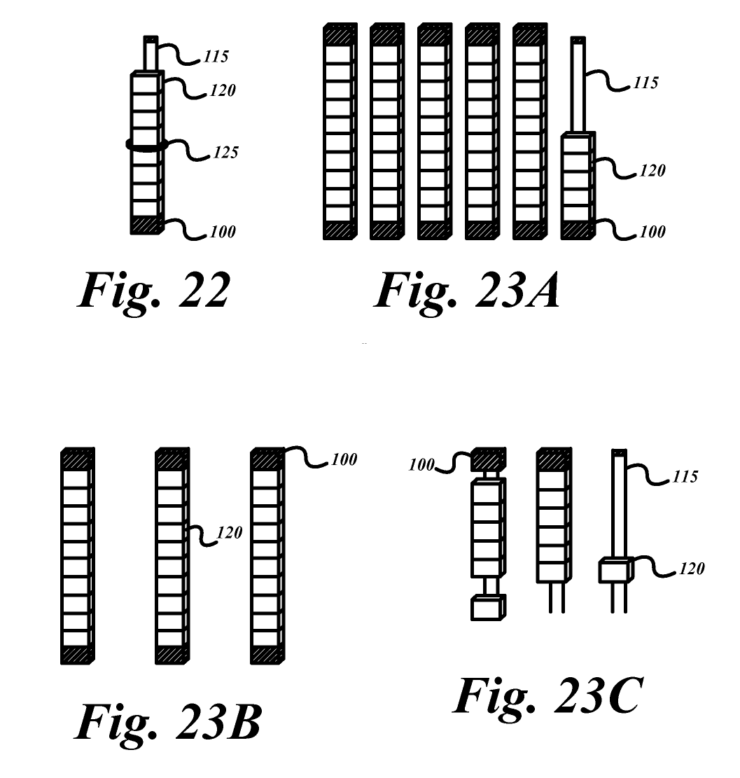

Similarly, current methods of teaching and learning division require rote memorization. Students who do not learn these math facts in elementary school may struggle with more advanced mathematical concepts. The Math Logic teaching method may provide students with concrete examples and/or algorithm to perform division. For example, students may be asked to divide 8 by 2. Students may be asked to determine the following equation: 8÷2. Students may be asked to determine the following equation: 8/2. As illustrated in FIGS. 22 and 23A-23C, division is the reverse process of multiplication. Students may split a given item of the same kind into groups with the same number of items in each group. To determine the answer, students may have to determine how many cubes 120 in each group.

The present embodiment may be taught to young children beginning at approximately 2½ or 3 years of age but may be appropriate to alternative types of students of any age, including elementary students, English as a second-language students, and/or students with mental disabilities. Students may begin learning numbers using the cubes 120. Students may learn a base 10 whole number system logically and sequentially. They may learn that the number zero is one of the most important numbers of the number system. Students may learn that numbers may be built and constructed from the 10 basic numbers, 0 to 9. The present invention may enable students to compare numbers or to find numbers that precede and/or follow a given number using cubes 120 and shafts 115. Numero Cubes and/or Math Logic may provide students with a method of learning mathematics that is relatively easy, simple, logical, systematic, and accurate. The present embodiment may be taught by a teacher, an instructor, a parent, a sibling, a tutor, and/or by peers. Further, embodiments may be incorporated into a computer software program or written publication. For example, a 3D Numero Cube video game illustrating the principles of the Numero Cube system above could be used to accomplish some of the same purposes. This might be especially helpful for students with motor difficulties or handicaps.

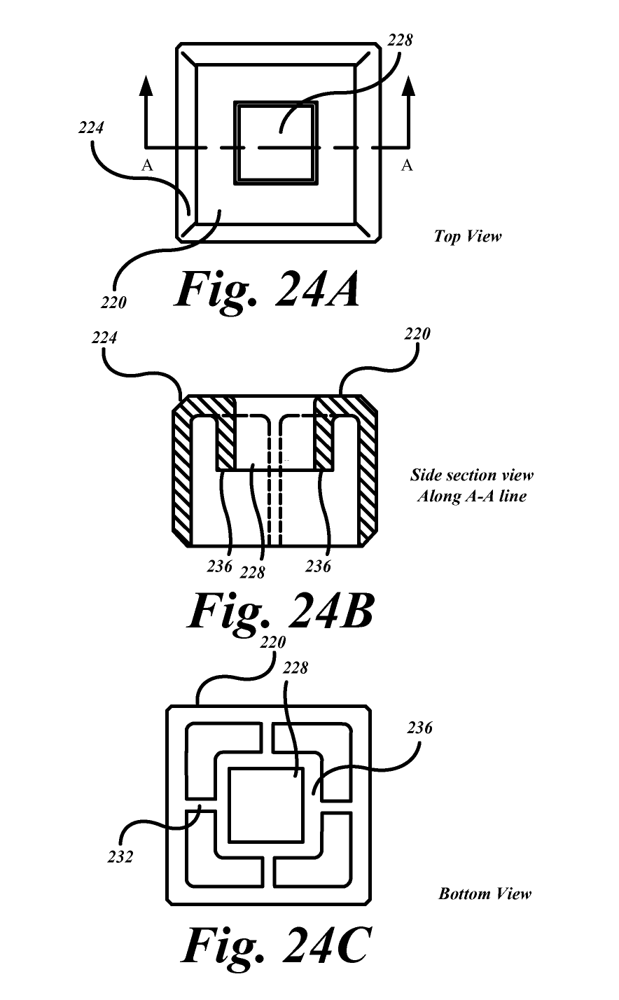

FIG. 24A-C illustrates top, side cross-sectional, and bottom views of an alternate embodiment of the Numero cube 220. The Numero Cube 220 may be made from polystyrene plastics, have a blue color, and exhibit a high polished exterior. It includes an approximate 20 mm by 20 mm top square 220 being circumscribed by a beveled edge 224, and a central square aperture 228 of approximately 7.5 mm by 7.5 mm. The bevel 224 may have a 45-degree taper. FIG. 24B illustrates central walls 236 defining the aperture 228, and side exteriors approximately 13.5 mm deep. FIG. 24C illustrate the central walls 236 defining the square like aperture 228 and secured to the Numero Cube exterior 220 via stacking ribs 232. The stacking ribs 232 may have a thickness of approximately 1.25 mm aperture and the square aperture 228 may be approximately 7.5 mm wide. The length of the central walls 236 may be approximately 7.5 mm.

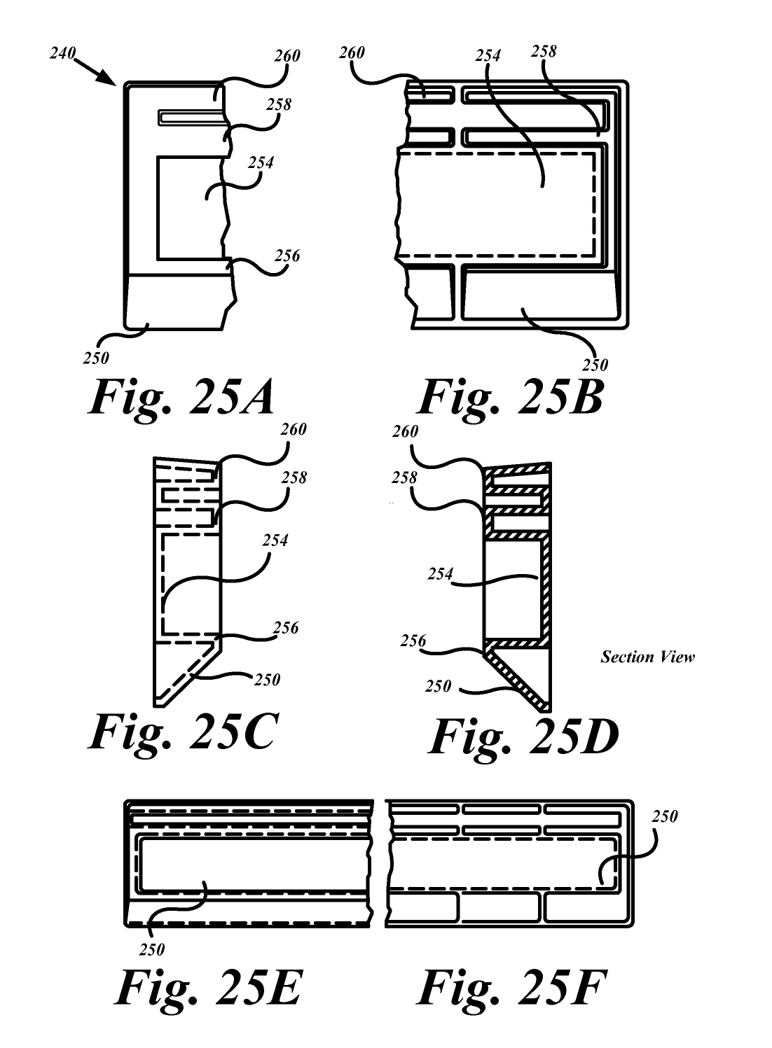

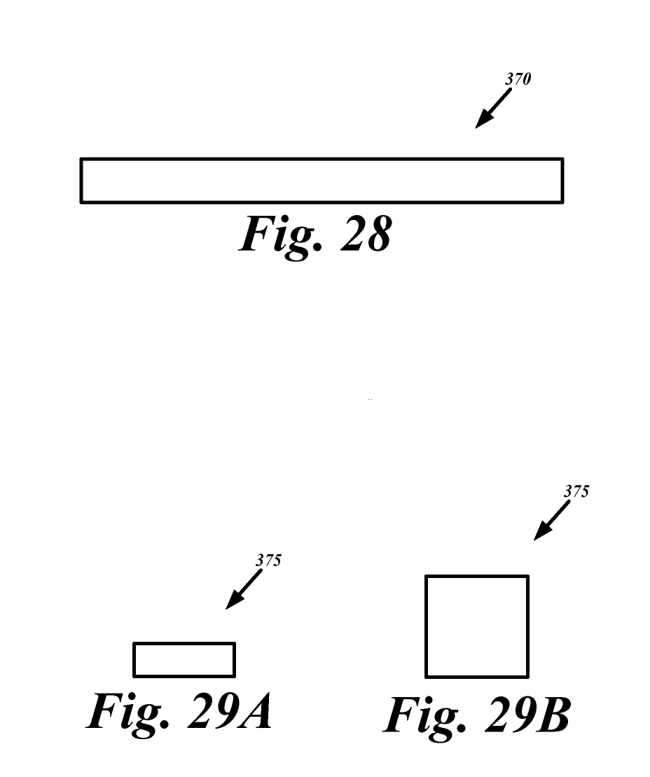

FIG. 25A-F illustrates partial top, cross-sectional side view, and bottom views of an alternate embodiment of the Numero Cube base 240. FIG. 25A illustrates a top view of a portion of the Numero Cube base 240 having a base slant 250, stiffing ribs 256, 258, and 260 and a magnet reservoir 254 located between the stiffening ribs 256 and 258. The magnet reservoir is dimensioned to receive a 28 mm wide, 280 mm long, and 1.6 mm adhesive fastened magnetic strip illustrated in FIG. 28 below. FIG. 25B illustrates a bottom of a portion of the Numero Cube base 240. FIG. 25C is an end view of the Numero Cube base 240. The width the Numero Cube base 240 may be 75 mm and the width of the magnet reservoir 254 may be 31 mm with an inside clearance of 30.5 mm and have a depth of approximately 17 mm. Stiffening ribs 256 and 260 may be 5 mm wide, and stiffening rib 258 may be 10 mm wide. FIG. 25D illustrates a cross-section view of the Numero Cube base 240. The wall thickness may be 3 mm. FIGS. 25E and 25F present alternate top and bottom views of a portion of the Numero Cube base 240.

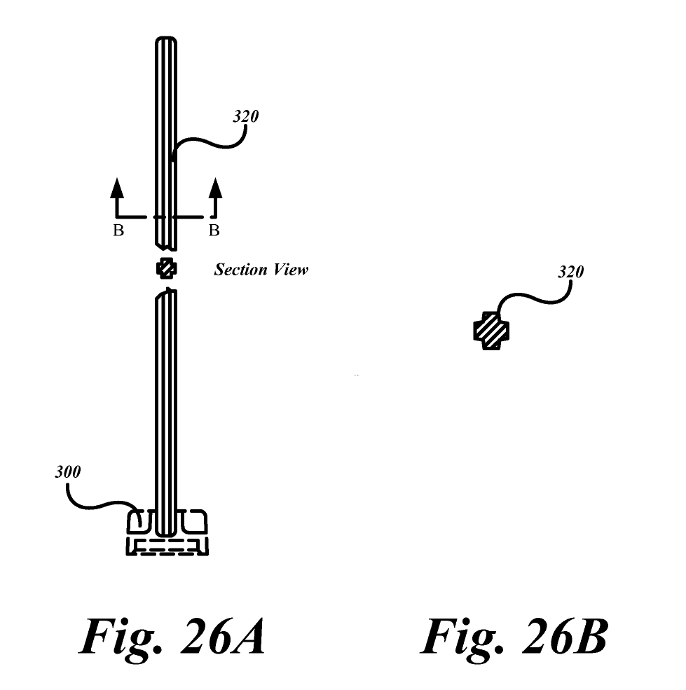

FIG. 26A-B illustrates side, and top views of alternate embodiments of the peg and peg base. FIG. 26A illustrates a side view of a peg base 300 in which a peg 320 is inserted. Section line B-B sows a cross-sectional view of the peg 320. FIG. 26B illustrates a larger cross-sectional view of the peg 320. In a particular embodiment, the base 300 may be square shaped with sides of approximately 27.5 mm. The peg 320 may have a length of approximately 173 mm and be made of molded, clear plastic and colored with varying hues. The peg 320 is cross-shaped and may have be approximately 6.5 mm wide with stubby arms of approximately 2.5 mm.

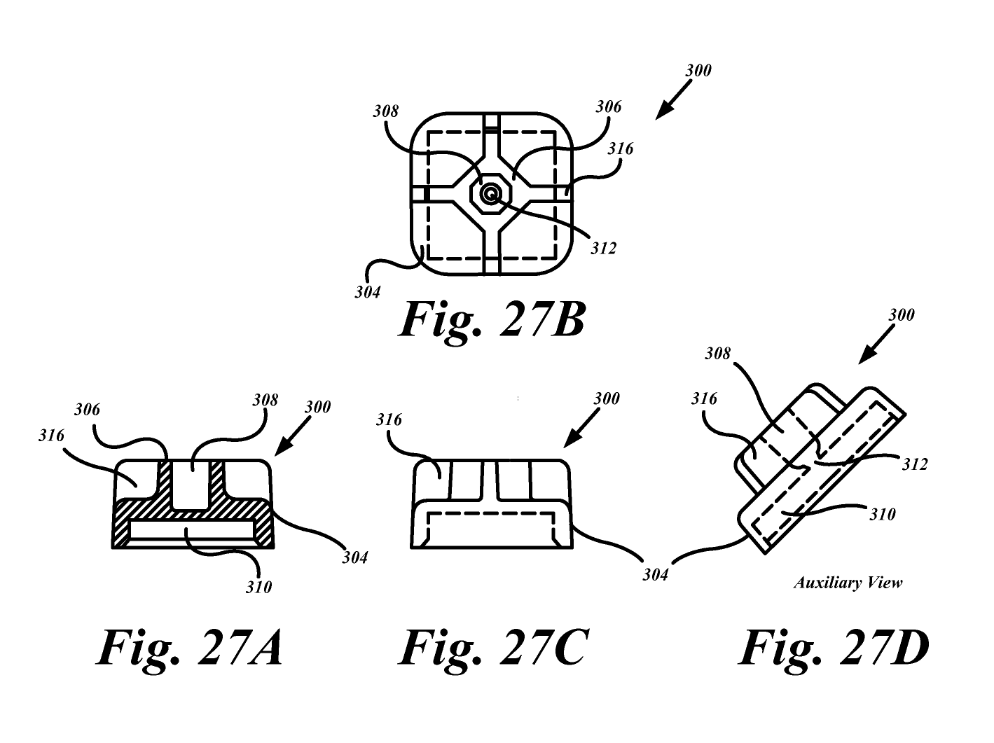

FIG. 27A-D illustrates additional views of the peg base 300. FIG. 27A is a cross-sectional view of the peg base 300 that illustrates peg base cavity 310 having dimensions of approximately 21.5 mm wide and 5 mm high, with an approximately 45 degree internal bevel, and contained with a substantially square configuration having a side 304 of approximately 27.5 mm. The peg base cavity 310 may be configured to receive an adhesive mounted iron pierce to provide a supporting anchor weight or magnetic iron piece to secure the inserted peg 320. The peg base 300 includes a shaft extension 306 of approximately 2.5 mm thick defining a peg holder cavity 308 of approximately 8.8 mm deep and wide enough to securely hold the 6.5 mm wide peg 320. FIG. 27B is a top view of the peg base 300 illustrating the shaft extension 306 having a diamond shape in which the peg holder cavity 308 presents an octagonal configuration within the shaft extension 306. Near the center of the peg holder cavity is a chamfered hole 312. The dashed square delineates the peg base cavity 310 residing within the side 304 by side 304. Rounded corners may occupy the separation between the sides 304. Extending from the diamond shape shaft extension 306 are four support braces 316, each separated by approximately 90 degrees. FIG. 27C is a side view of FIG. 27B. FIG. 27D is an auxiliary view and shows the constricted passageway of the chamfered hole 312 between the peg base cavity 310 and the peg holder cavity 308.

FIG. 28 illustrates a magnet insert 370 that occupies the magnet reservoir 254 shown in FIGS. 25A-F. Dimensions may be approximately 25 mm by 280 mm. Thickness may be 1.6 mm.

FIGS. 29A-B illustrates orthographic views of an iron insert 375 placeable within the peg base cavity 310 of the peg base 300 for detachable magnetic or removable binding with the magnet insert 370 occupying the magnet reservoir 254 of the Numero Cube base 240. FIG. 29A presents a side view having a thickness of approximately 0.5 mm and FIG. 29 B presents a top view of the iron insert 375 have a substantially square configuration with a side dimension of approximately 21 mm. The Iron insert 375 is magnetically attractive, smooth, and posses a substantially clean surface to receive an adhesive derived of ethyl benzene, xylene, or petroleum naphtha for affixing within the peg base cavity 310.

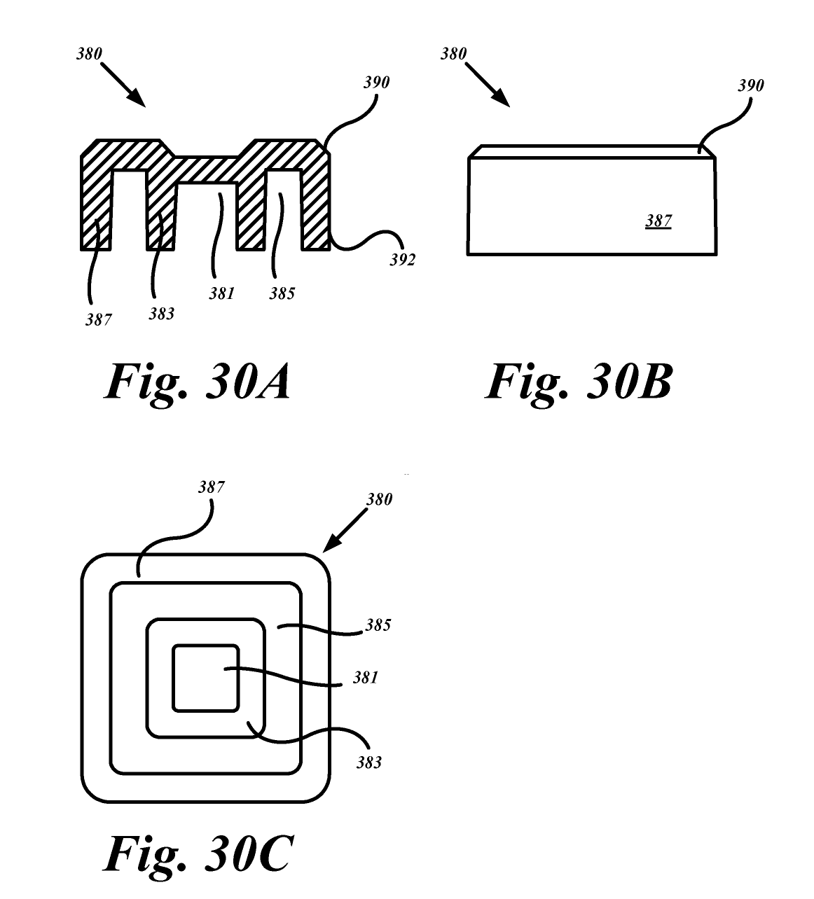

FIGS. 30A-C illustrates cross-sectional, side, and bottom views of an alternate embodiment of a top cap 380. FIG. 30A is a cross-sectional view of the top cap 380 illustrating an inner cavity 381 that is substantially square shaped defined by an inner wall 383 and an outer cavity 385 concentric about the inner cavity 381 that is substantially square shaped and defined by an outer wall 387. The inner and outer walls 385 and 387 are approximately 3 mm thick. The height of the inner cavity 381 is approximately 7.5 mm and the height of the outer cavity 385 is approximately 8.75 mm. The substantially square shaped top cap 380 is approximately 27.5 mm by 27.5 mm. A bevel 390 extends along the top edge of the top cap 380. FIG. 30B presents a side view of the top cap 380 showing the outer wall 387 and bevel 390. FIG. 30C presents a bottom view that correlates to the cross sectional view of the top cap 380. The inner cavity 381 engages with the top portion of the peg 320.

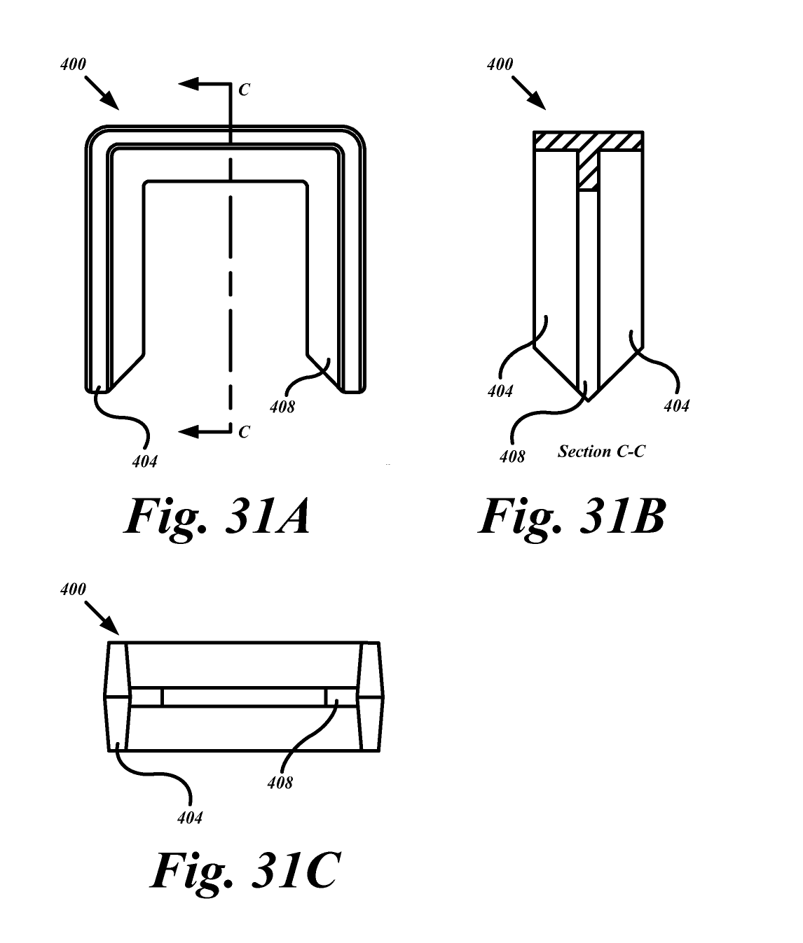

FIGS. 31A-C illustrates orthographic views of an alternate embodiment of a number separator 400. The number separator 400 may be made of polished plastic, clear, and have a red color or other colors and is substantially an open square having three sides of approximately 25 mm. FIG. 31A illustrates a top view showing an outer edge 404 having a double wedge configuration surrounding a beveled slant 408. FIG. 31B illustrates a side cross-sectional view along the lines C-C of FIG. 31A and shows the surfaces of the outer edge 404 in relation to the more centrally located beveled slant 408. FIG. 31C is a side view locking at the opening of the number separator 400 and illustrates the position of the outer edge 404 in relation to the beveled slant 408. The beveled slant 408 may present a 45 degree taper and the thickness may be 2 mm. The inner distance separating the inner edges of the beveled slant may be approximately 15 mm.

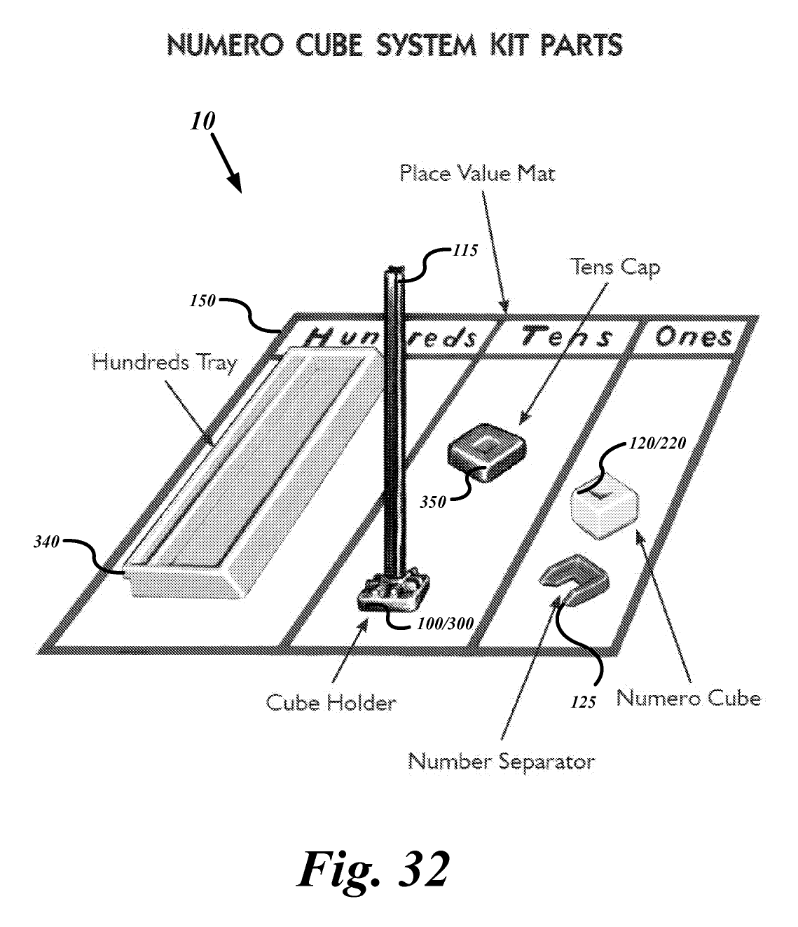

FIG. 32 schematically illustrates component kit parts of a Numero Cube System 10. The system 10 kit parts includes a place value mat 150, at least one peg 115 insertable into a base 100, a number cube 120 insertable or slidably placeable on the shaft portion of the peg 115, a number separator 125, the hundreds tray 340, and the tens cap 350. The place value mat 150 is a card having a ones column, a tens column, and a hundreds column. The hundreds tray 330 may be fitted with a magnetic plate. The peg 115 is alternatively insertable into the alternative base 300 and may also hold the alternative Numero Cube 220. The base 100 or 300 may be fitted with metal plates responsive to the magnetic force from the hundreds tray 340, thereby securely holding fully loaded shafts loaded with ten cubes 120.

The system 10 component kit parts provide for student manipulation and number construction exercises that improve the student's ability to learn several mathematical and algebraic concepts. By constructing number representations, the students learn place value, number decomposition, counting principles related to odd and even numbers, number comparing, addition, subtraction, multiplication and factoring, division, and solving for unknowns utilizing pre-algebraic equations.

The Numero Cube System 10 provides an innovative math teaching tool recommended for preschool to fourth grade. It can also be adapted to the needs of special education students and homeschoolers. The system is simple, friendly, and versatile. The pieces of this kit are easy to handle even for young children. With these bright color cubes, both teachers and parents can successfully provide their students with a solid foundation of basic math concepts such as place value, expanded form, sequences, arithmetic, and factorization. The Numero Cube System 10 uses a hands-on approach based on first constructing and building, and then analyzing and evaluating to find solutions to math problems. Through this process, children develop critical thinking skills, and learn to visually justify their answers and check their own work. Learning with the components of the Numero Cubes System 10 is enjoyable, and engenders an early enthusiasm and appreciation for math. The system 10 provides teaching tools that can be used with any math curriculum. It is aligned with the National Council of Teachers of Mathematics (NCTM) and meets the Washington state math standards. The system 10 is designed to be effective with both individuals and groups, and allow students to work at their own rates in a multi-level classroom.

Discussed below are exercises to help students master the concepts presented. The exercises presented for one child or student can be applied to a group of children or students and vice versa. Many of the exercises provided by the system 10 can be adjusted to fit the needs of both the young child or special education students and the older more advanced learner. At any level, it is recommended that the teacher first guide the student through an example problem and to allow the student ample time to experiment and arrive at the solution on his or her own endeavors. It is suggested to allow the child to wait in order to understand each concept before going on to the next concept. It is good to provide positive feedback while the student endeavors with each exercise of the Numero Cube System 10.

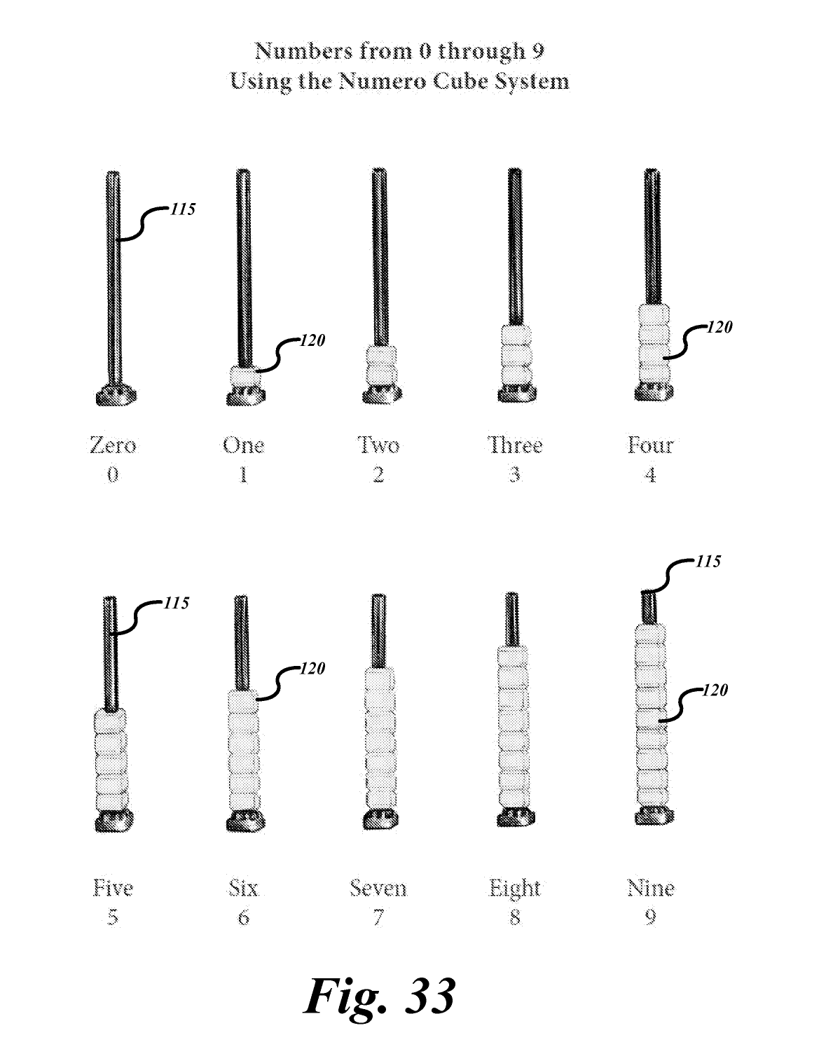

FIG. 33 schematically illustrates the presentation of numbers 0-9 using the Numero Cube System 10. As configured, the Numero Cube System 10 helps students to recognize and construct numbers up to three digits. In other embodiments, the Numero Cube System 10 can be expanded with other kit components to illustrate numbers beyond 3 digits.

All work may be done on top of the place value mat 150, or nearby the place value mat 150 when supported in a vertical position or other position in view of the students. The shaft 115 is also referred to as a stick 115, or a peg 115, or cube holder 115 in which said shaft, stick, peg, or cube holder 115 includes the base 100 or 300 to which cube holder 115 is inserted to allow upright positioning on horizontal surfaces or when place on the place value mat 150 that is similarly overlaid upon a horizontal surface. The base 100 or 300 may be fitted with ferrous metal plates responsive to magnetic forces. The place value mat 150 shows a ones place column, a tens place column, and a hundreds place column. Representation of single-digit numbers zero to nine (0-9) is possible in which a zero is represented by an empty cube holder 115 which is insertable in the base 100/300 and neither holds Numero Cubes 120 nor 220. Whereas numbers 1-9 have from one to nine Numero Cubes 120 or 220 held by the shaft, stick, or peg 115 that is already inserted into the base 100 or 300. That is, each yellow-colored cube 120/220 denotes a value of 1 or unity. To form the numbers from 1 to 9, the appropriate numbers of cubes 120/220 are slidably engagable with the shaft/stick/peg/cube holder 115. Thereafter, an uprightly positioned cube holder 115 is placed on the value mat 150 in the ones (cubes) column.

Exercises may be varied. For example, a series of Numero Cube representations can be created showing the numbers 0 to 9. A game can be played to see how fast the child can name the number. In another exercise, a child is given cube holder 115 and 9 cubes 120. One child or student may build a number between 0 and 9, and another to say the number. Each child or student can write the number down in both numeric and alphabetic form (e.g. 4, four).

In another exercise a list of numbers between 0 and 9 in numeric and alphabetic form is utilized. The students can be asked to use the Numero Cubes 120, cube holder 115, and the place value mat 150 (not shown) to construct each given number. Other student groups can check for correct answers.

In alternate embodiments of the system 10, the place value mat 150 may include a thousandths place column and/or columns beyond the thousandths place. Correspondingly, differently shaped and/or colored Numero Cubes 120 can designate number groupings in the tens, hundreds, thousands and beyond. Similarly, the hundreds tray 340 with magnet plate can be differently shaped and/or colored and used to represent a thousandths tray, or alternatively, a ten-thousandths tray to correspondingly house cube holder 115 to which Numero Cubes 120 having values other than unity are slidaby placed.

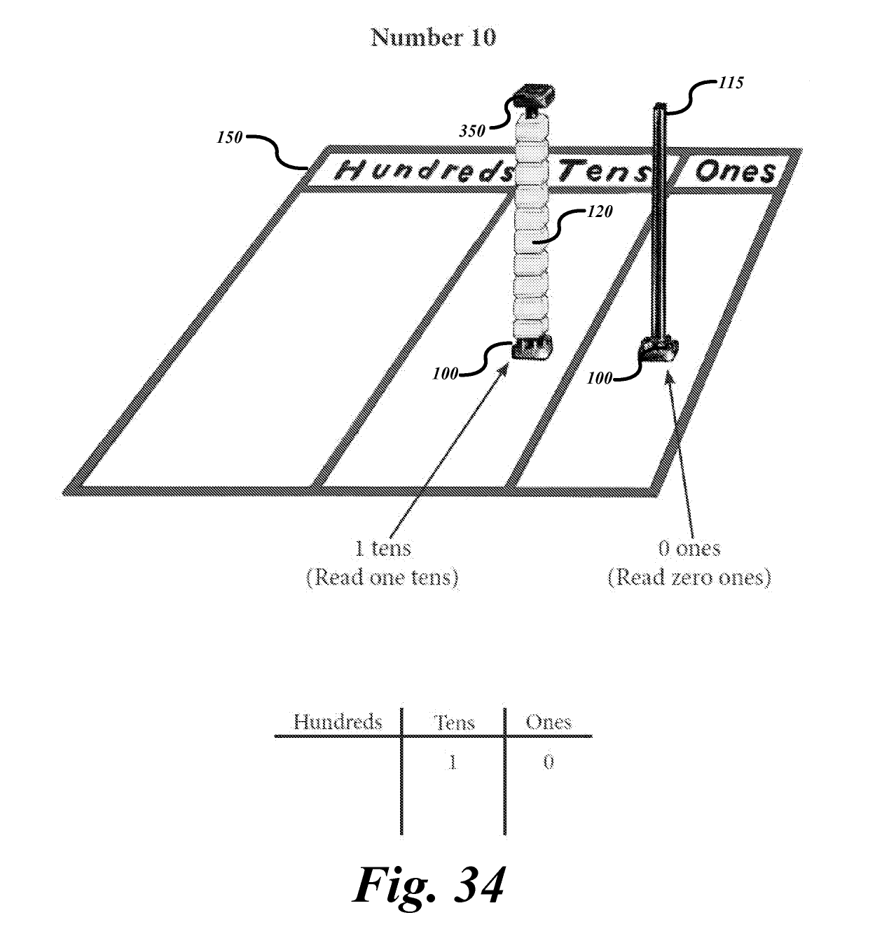

FIGS. 34-46 respectively illustrated sequential perspective views of the Numero Cube System 10 laid out for manipulation by a user to construct and study numbers 10, 11, 19, 20, 24, 99, 100, 110, 106, 145, 199, 200, and 124. The number 10 is represented by sliding 10 cubes 120 on top of the cube holder 100 by engaging the shaft or peg 115, then snapping a tens cap 350 on the top tenth cube held by the peg 115. The whole assembly with 10 cubes and a tens cap 350 as a completed stick or cube holder 100 is placed on the mat in the tens column. Emphasis can be expressed to the students that the tens cap 350 can be used when there is a complete set of 10 cubes 120 on the cube holder 115. Once the tens cap 350 is in place, the assembly can be migrated or transferred from the ones column to the tens column on the place value mat 150.

Consecutive numbers after 10 are represented by continuing to add cubes one-by-one into the ones column and transferring the cube holders 120 into the tens column as soon as they are filled with ten cubes 120 and a tens cap 350.

Suggested exercises for students include building the numbers from 0 to 19 on the mat 150, in which the students are encouraged to count aloud at the same time. The student may be encouraged to notice that the pattern of the ones column repeats from 0 to 9.

The same number in the expanded form would be written as the sum of the total number of cubes in each column.

FIGS. 34-39 schematically illustrates examples of the use of the Numero Cube System for double digit numbers from 10-99. The number 10 is represented by sliding 10 cubes 120 onto the cube holder or peg 115 and snapping a tens cap 350 on top of the 10 cubes 120. The whole assembly 115/100 (one stick) is placed on the mat 150 in the tens column. Emphasize to the students that the tens cap can be used when there is a complete set of 10 cubes on the cube holder. Once the tens cap is in place, the assembly can no longer stay in the ones column and so is moved to the tens column. Consecutive numbers after 10 are represented by continuing to add cubes 120 one-by-one into the ones column and transferring the cube holders or pegs 115 into the tens column as soon as they are filled with ten cubes 120 and have a tens cap 350 mounted to the tip of the shaft 115.

Students may perform exercises to build numbers from 0 to 19 on the place value mat 150, counting aloud at the same time. The students may be encouraged to notice the pattern of the ones column as it repeats from 0 to 9.

| | | | | | |
|---|---|---|---|---|---|
| Hundreds | Tens | Ones | Hundreds | Tens | Ones |

| | | |
|---|---|---|
| 0 | 1 | 0 |
| 1 | 1 | 1 |
| 2 | 1 | 2 |
| 3 | 1 | 3 |
| 4 | 1 | 4 |
| 5 | 1 | 5 |
| 6 | 1 | 6 |
| 7 | 1 | 7 |
| 8 | 1 | 8 |
| 9 | 1 | 9 |

The students obtain the kit components of the Numero Cube System 10, such as the mat 150, some cube holders 115, and an arbitrary number of loose cubes 120. Younger students, such as small children, may prefer to perform manipulations with a fewer number of the cubes 120. The students can be reminded that when a cube 120 holder 115 is filled with 10 cubes 120, a tens cap 350 is placed on the top of the shaft portion of the peg 115 and the whole peg assembly is transferred into the tens column on the card 150. Likewise, if there are ten sticks or pegs 115 are located in the tens column, a tray 340 is acquired and placed within the hundreds column. After the number has been successfully constructed on top of the mat, have the students say the number of digits, saying, and writing each digit in the appropriate column on the mat. For example, get the students to construct the number 95 using the Numero Cubes, the cube holders or peg 115, and the mat 150. After students are done with forming number 95 using the Numero Cube System, they may say out loud, “95 is a 2 digit number, 9 tens (90 cubes) and 5 ones (5 cubes).”

In another exercise each student group may be asked to construct the smallest and the largest two-digit numbers from 4, 2, 6, 9, and 3 digits. Each digit is used only once. Determine whether the students can construct a number that is 10 larger than the smallest number and 10 smaller than the largest number using the Numero Cubes 120. Encourage the students to verify their results. In another student group a fairly large number of cubes 120 that are under 100 may be assembled. Students can estimate the total number of cubes 120 that they manipulate and ascertain whether they can find out the exact number of cubes 120 they possess and compare their results. Representations of the above exercises are schematically illustrated in the following figures.

FIG. 34 schematically illustrates the representation of number 10 by the Numero Cube System 10. A completed stick 115 having 10 cubes 120 and fitted with a tens cap 350 occupies the tens column, and an empty stick 115 having no cubes 120 represents the number zero and stands within the Ones column of the value mat 150. The student is encouraged to recite the completed stick 115 to read or vocalize as “one tens” and the empty stick 115 to read or vocalize “zero ones”.

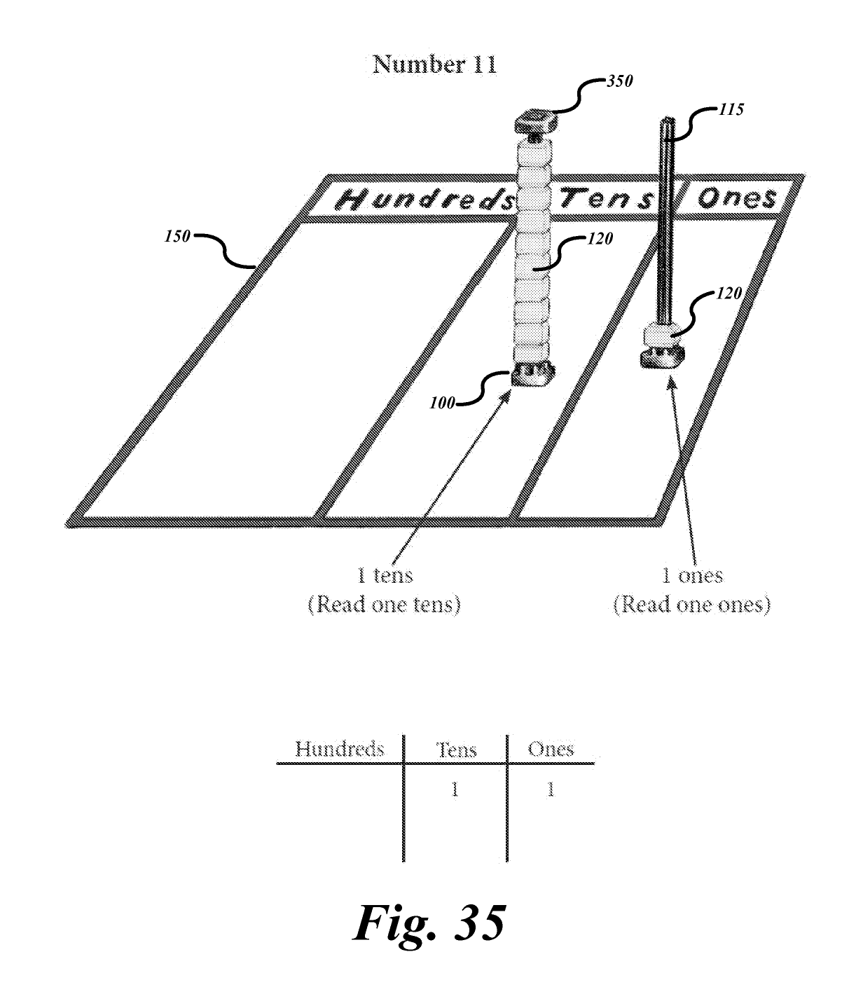

FIG. 35 schematically illustrates the representation of number 11 by the Numero Cube System 10. A completed stick 115 having 10 cubes 120 and fitted with a tens cap 350 occupies the tens column, and an another stick 115 having a single cube 120 represents the number one and stands within the Ones column of the value mat 150. The completed stick 115 is read “one tens” and the stick 115 with a single cube 120 is read “one ones”.

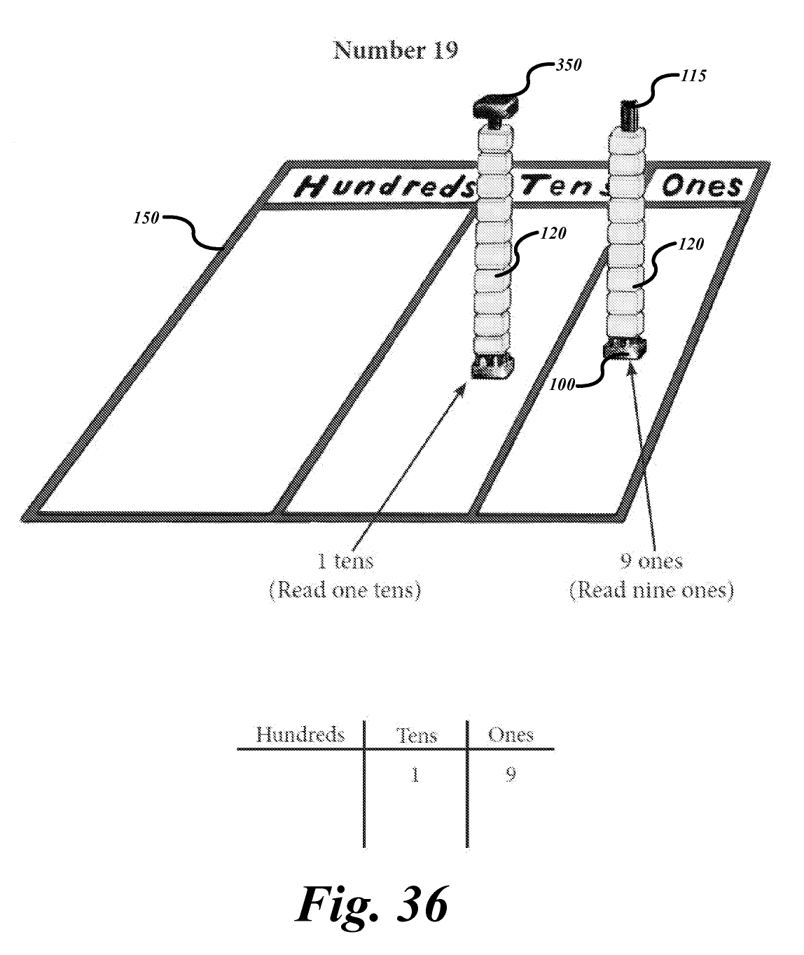

FIG. 36 schematically illustrates the representation of number 19 by the Numero Cube System 10. A completed stick 115 having 10 cubes 120 and fitted with a tens cap 350 occupies the tens column, and an another stick 115 having a nine cubes 120 represents the number one and stands within the Ones column of the value mat 150. The completed stick 115 is read “one tens” and the stick 115 having nine cubes 120 is read “nine ones”.

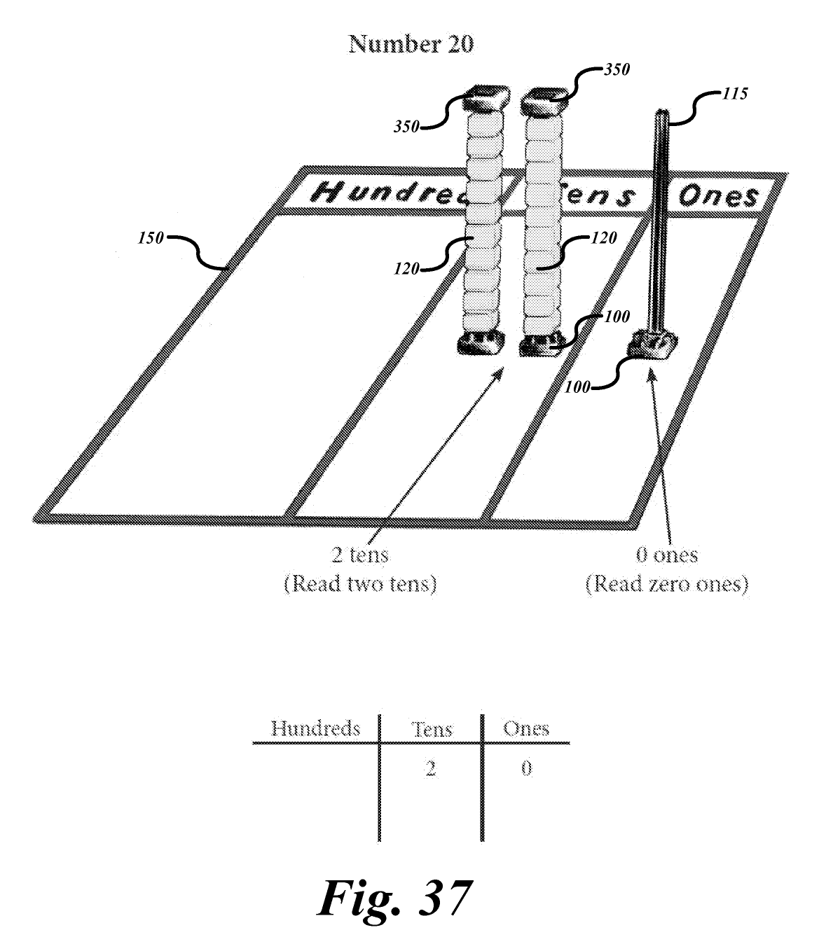

FIG. 37 schematically illustrates the representation of number 20 by the Numero Cube System 10. Two completed sticks 115 each having 10 cubes 120 and each fitted with a tens cap 350 occupies the tens column, and an another stick 115 that is empty, i.e., does not contain any cubes 120 represents the number zero and stands within the Ones column of the value mat 150. The two completed sticks 115 is read or vocalized as “two tens” and the empty stick 115 is read “zero ones”.

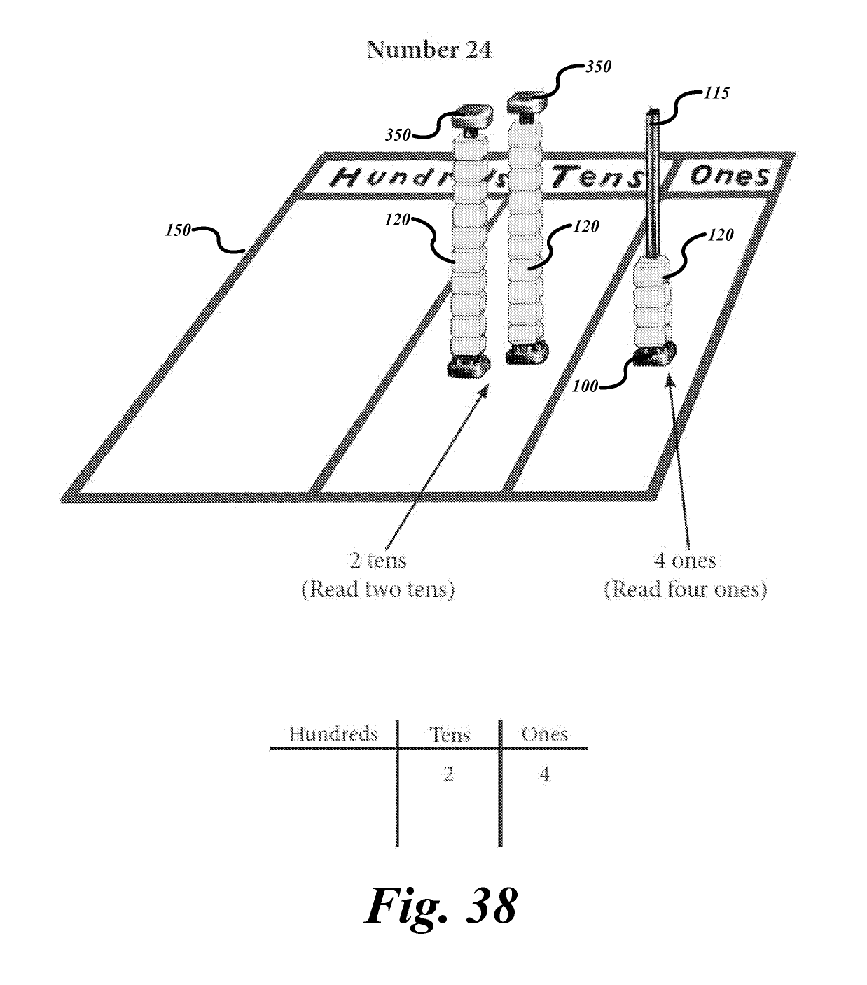

FIG. 38 schematically illustrates the representation of number 24 by the Numero Cube System 10. Two completed sticks 115 each having 10 cubes 120 and each fitted with a tens cap 350 occupies the tens column, and an another stick 115 contains four cubes 120 to represent the number four and stands within the Ones column of the value mat 150. The two completed sticks 115 is read or vocalized as “two tens” and the other stick 115 having four cubes 120 is read or vocalized as “four ones”.

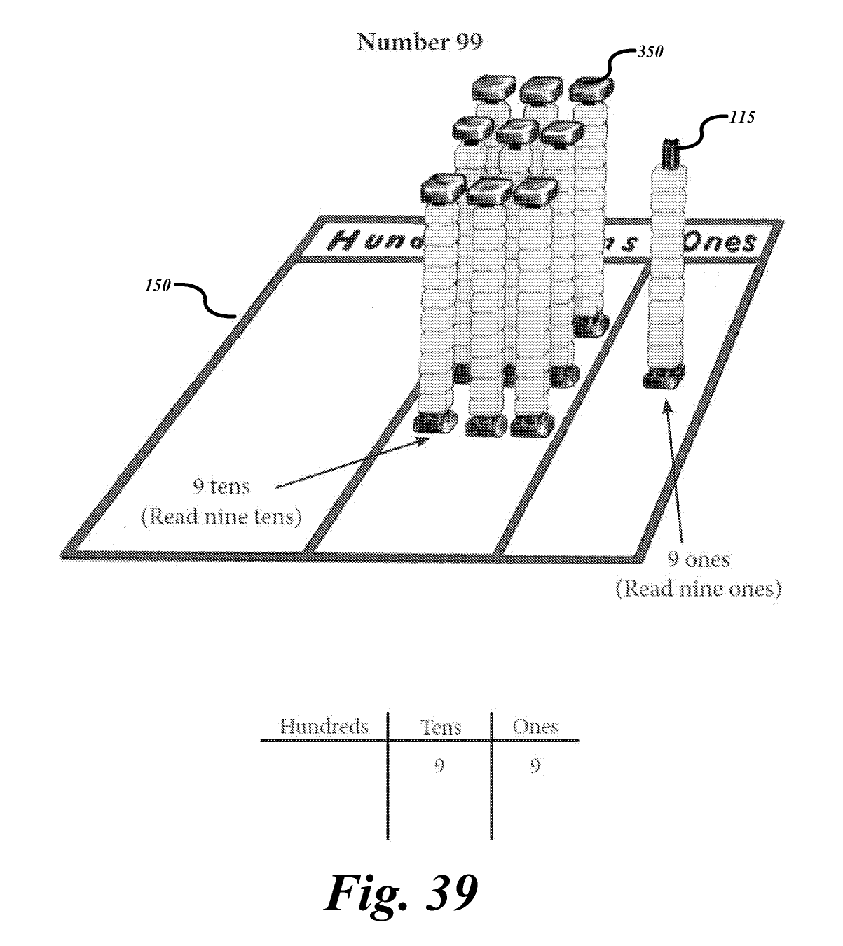

FIG. 39 schematically illustrates the representation of number 99 by the Numero Cube System 10. Nine completed sticks 115 each having 10 cubes 120 and each fitted with a tens cap 350 occupies the tens column, and an another stick 115 contains nine cubes 120 to represent the number nine and stands within the Ones column of the value mat 150. The nine completed sticks 115 is read or vocalized as “nine tens” and the other stick 115 having nine cubes 120 is read or vocalized as “nine ones”.

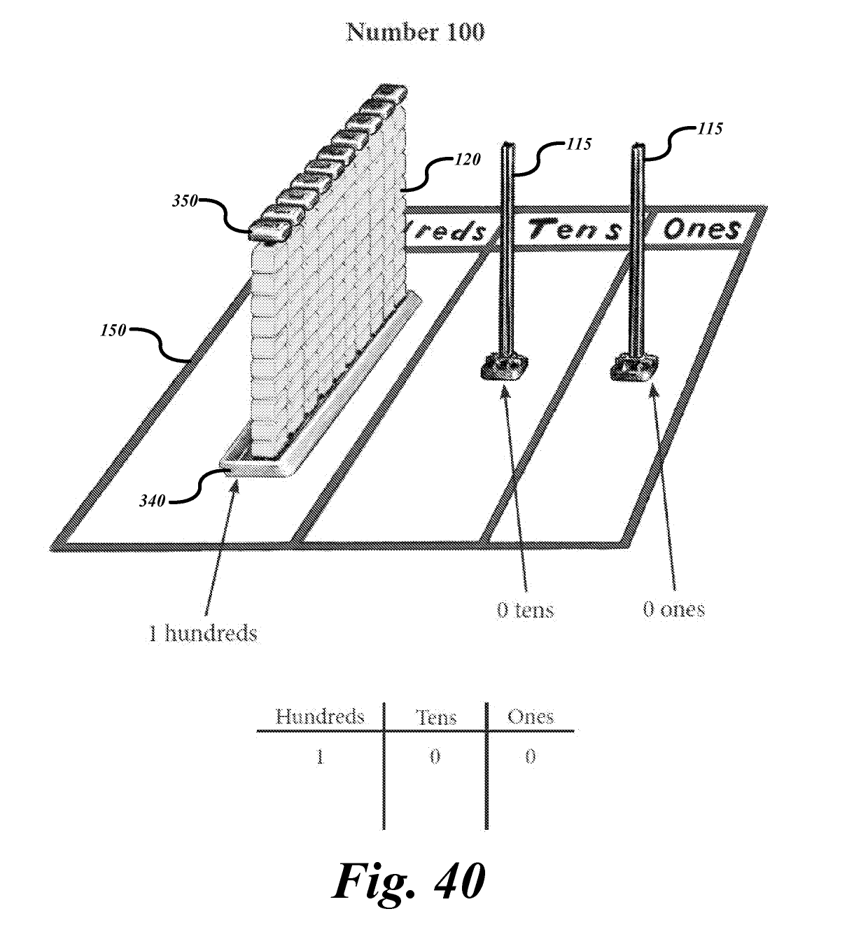

FIGS. 40-45 schematically illustrates examples of the use of the Numero Cube System for examples of triple digit numbers from 100-200. Exercises depicting the representation of 3-digit numbers (100+) are illustrated by using 10 tens (10 sticks or pegs 115) that have been formed or assembled and placed them into a magnetic hundreds tray 340. There are now 100 cubes 120 in the configuration, and the whole tray 340 assembly can now be placed on the mat 150 in the hundreds column. To continue counting, the cubes 120 are added one by one into the ones column, forming sticks or pegs 115 and trays 340 when the place value columns become full.

Counting whole numbers with Numero Cubes 120 may progress from right to left. Constructing numbers, on the other hand, can progress from left to right. When constructing a number, let's say 235, first use a dry eraser marker to write a “2” in the hundreds column, a “3” in the tens column, and a “5” in the ones column.

This shows that in the number 235, there are 2 hundreds, 3 tens, and 5 ones. Then fill up 2 trays and place them in the hundreds column. Next build 3 sticks and place them in the tens column. Lastly, slide 5 cubes onto a cube holder and place it in the ones column. Exercises may include writing a 3-digit number down on the mat, with its digits in the proper columns. Have the students say how many trays 340, sticks 115, and Cubes 120 would be needed to construct the number. After building the number on top of the mat, ask the students to say the value of each digit (the number of cubes) in each column. This is good practice for learning expanded form.

Other exercises provide for giving groups of 4 students over 100 cubes 120 and ask them to construct the number using all of the cubes 120. Students may be reminded in the event that when a cube holder is filled with 10 cubes, a tens cap is installed on top, and the whole stick is be transferred into the tens column. Likewise, if there are ten full sticks 115 in the tens column, a tray 340 is acquired and the 10 full stick 115 each having ten cubes 120 are placed within the tray 340 and the filled tray 340 transferred into the hundreds column of the place value mat 150. After the number has been constructed successfully on the top of the mat 150, the students may say or recite the number of digits, vocalizing, and writing each digit in the appropriate column. For example, the number 240 would look like this on the place value chart. The student would say, “3-digit number, 2 hundreds (200), 4 tens (40), and 0 ones (0 cubes)”.

In another example a student draws a number down on the mat 150, with its digits in the proper columns.

| Hundreds | Tens | Ones | |
|---|---|---|---|
| 2 | 4 | 0 | or 240 |

The student may also say how many trays 340, how many sticks 115, and how many cubes 120/220 would be needed to construct the number. After building the number on the top of the mat 150, the student is encouraged to say or speak the value of each digit (the number of cubes 120/220) in each column. This is good practice for learning expanded form. In yet other exercise students acquire a mat 150 with 1 tray 340, 3 sticks 115, and 3 cubes 120/220 on the Mat 150. Ask the student how to use the existing number to build a new number 150. This provides the student further challenge in developing the critical thinking skill involved in solving a more challenging math problem.

FIG. 40 schematically illustrates the representation of number 100 by the Numero Cube System 10. Ten completed sticks 115 each having 10 cubes 120 and each fitted with a tens cap 350 reside in the hundreds tray 340 that in turn occupies the hundreds column, an empty stick 115 occupies the tens column, and another empty stick 115 occupies the Ones column of the value mat 150. The ten completed sticks 115 is read or vocalized as “one hundreds”, the empty stick 115 occupying the Tens column is read or vocalized as “zero tens”, and the other empty stick 115 occupying the Ones column is read or vocalized as “zero ones”.

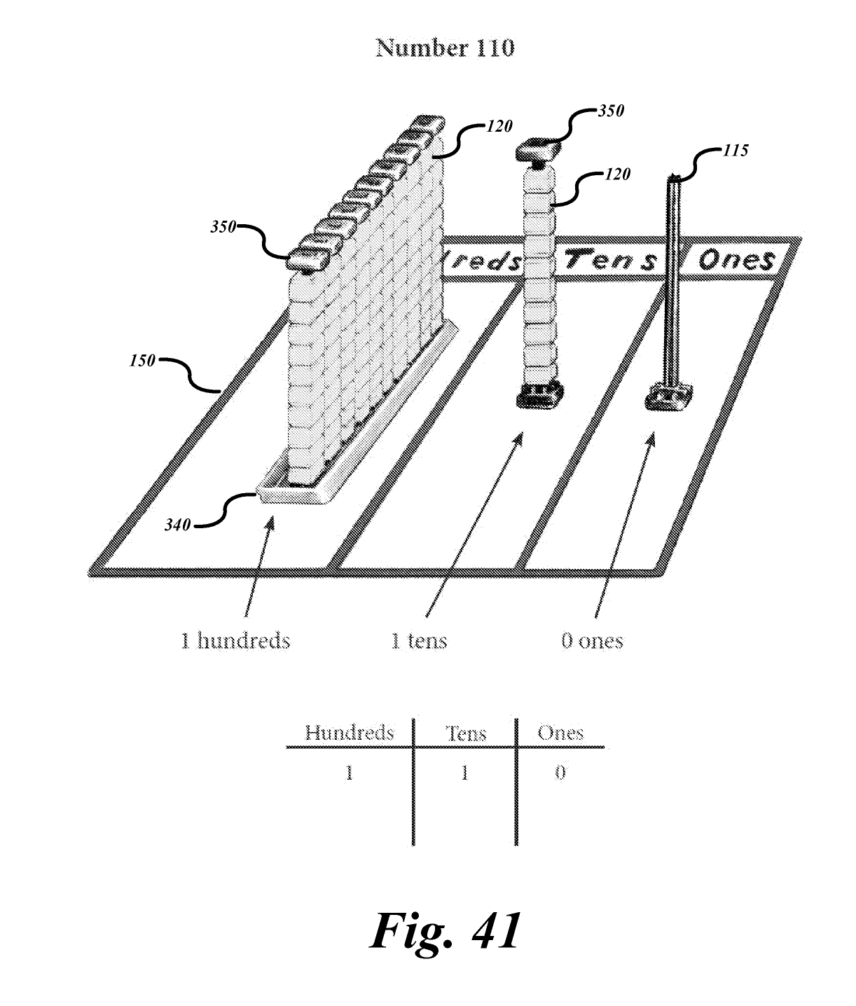

FIG. 41 schematically illustrates the representation of number 110by the Numero Cube System 10. Ten completed sticks 115 each having 10 cubes 120 and each fitted with a tens cap 350 reside in the Hundreds tray 340 that in turn occupies the Hundreds column, a filed stick 115 having ten cubes 120 and fitted with a tens cap 350 occupies the Tens column, and an empty stick 115 occupies the Ones column of the value mat 150. The ten completed sticks 115 is read or vocalized as “one hundreds”, the filled stick 115 occupying the tens column is read or vocalized as “one tens”, and the empty stick 115 occupying the Ones column is read or vocalized as “zero ones”.

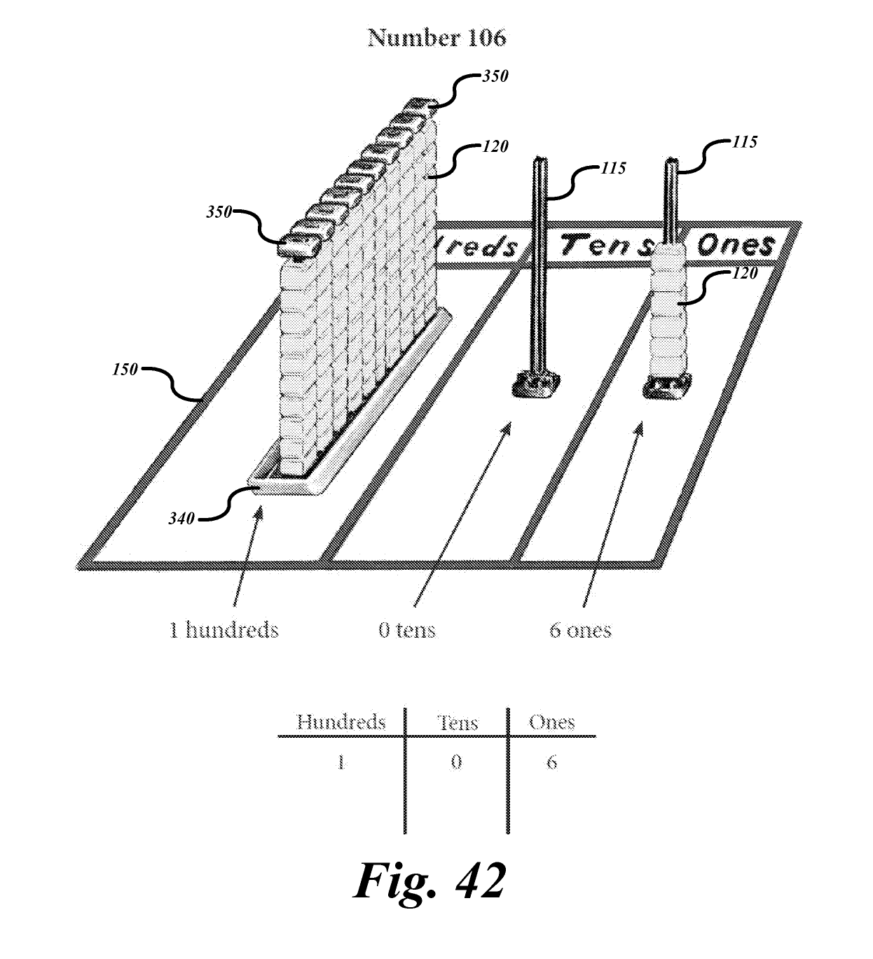

FIG. 42 schematically illustrates the representation of number 106 by the Numero Cube System 10. Ten completed sticks 115 each having 10 cubes 120 and each fitted with a tens cap 350 reside in the Hundreds tray 340 that in turn occupies the Hundreds column, an empty stick 115 occupies the tens column, and a filed stick 115 having six cubes 120 occupies the Ones column of the value mat 150. The ten completed sticks 115 is read or vocalized as “one hundreds”, the empty stick 115 occupying the tens column is read or vocalized as “zero tens”, and the stick 115 having six cubes 120 occupying the Ones column is read or vocalized as “six ones”.

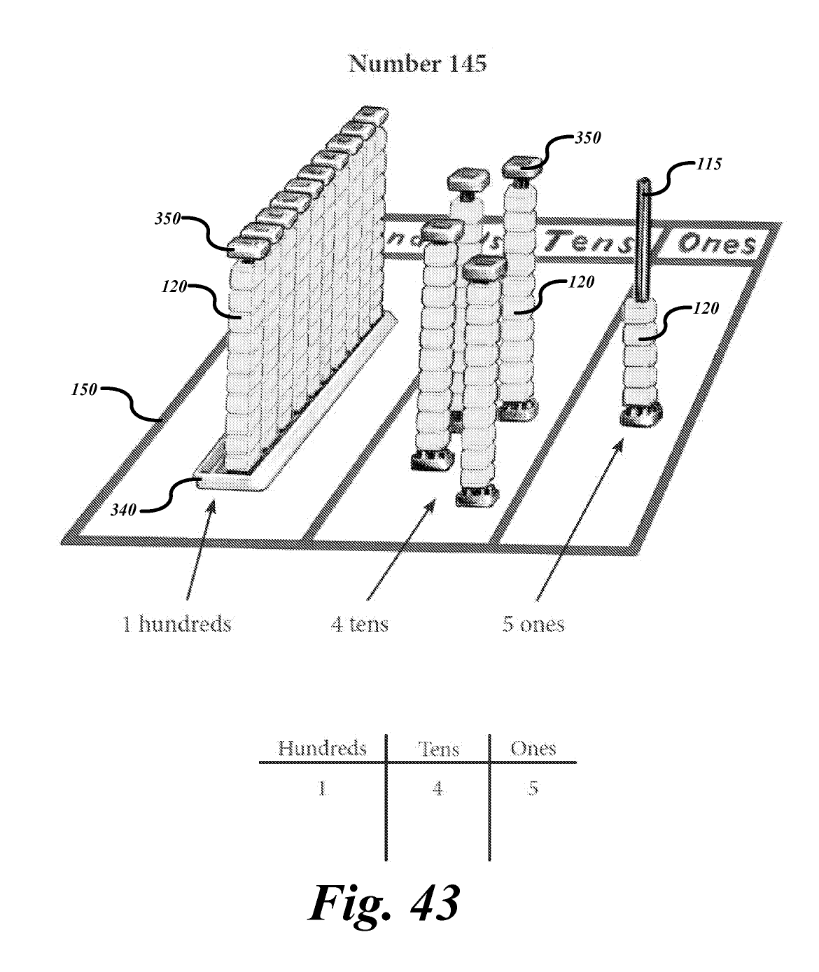

FIG. 43 schematically illustrates the representation of number 145 by the Numero Cube System 10. Ten completed sticks 115 each having 10 cubes 120 and each fitted with a tens cap 350 reside in the Hundreds tray 340 that in turn occupies the Hundreds column, four filed sticks 115 each having ten cubes 120 and each fitted with a tens cap 350 occupies the Tens column, and a partially filled stick 115 having five cubes 120 occupies the Ones column of the value mat 150. The ten completed sticks 115 is read or vocalized as “one hundreds”, the four-filled sticks 115 occupying the tens column is read or vocalized as “four tens”, and the partially-filled stick 115 having five cubes 120 occupying the Ones column is read or vocalized as “five ones”.

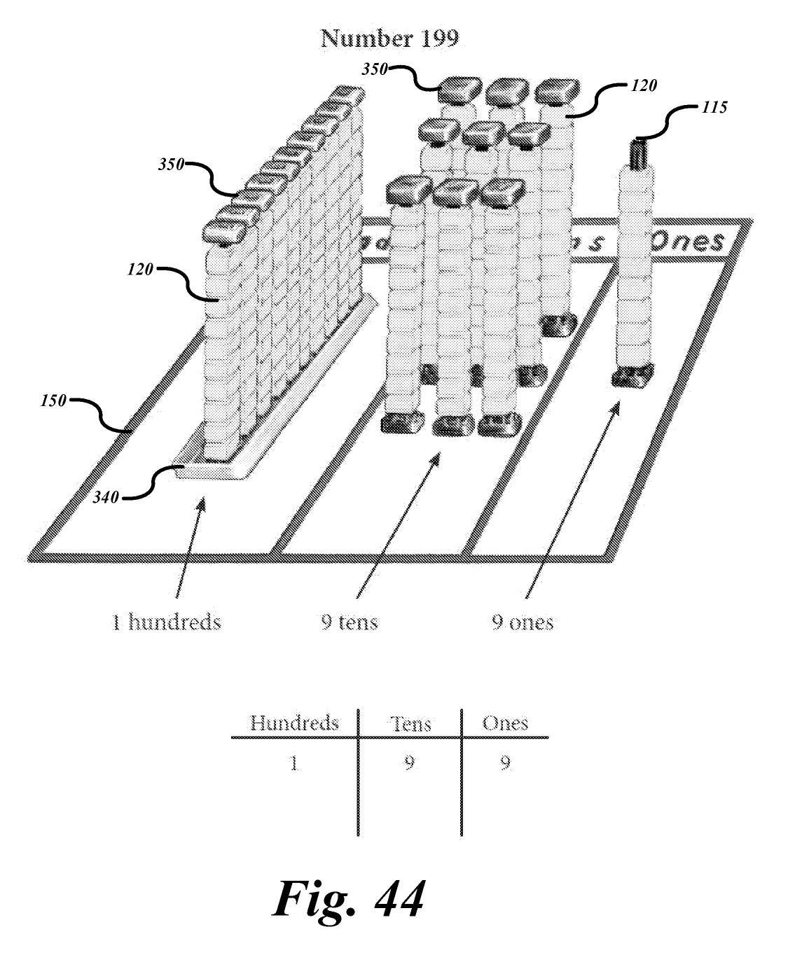

FIG. 44 schematically illustrates the representation of number 199by the Numero Cube System 10. Ten completed sticks 115 each having 10 cubes 120 and each fitted with a tens cap 350 reside in the Hundreds tray 340 that in turn occupies the Hundreds column, nine filed sticks 115 each having ten cubes 120 and each fitted with a tens cap 350 occupies the Tens column, and a partially filled stick 115 having nine cubes 120 occupies the Ones column of the value mat 150. The ten completed sticks 115 is read or vocalized as “one hundreds”, the nine-filled sticks 115 occupying the tens column is read or vocalized as “nine tens”, and the partially-filled stick 115 having nine cubes 120 occupying the Ones column is read or vocalized as “nine ones”.

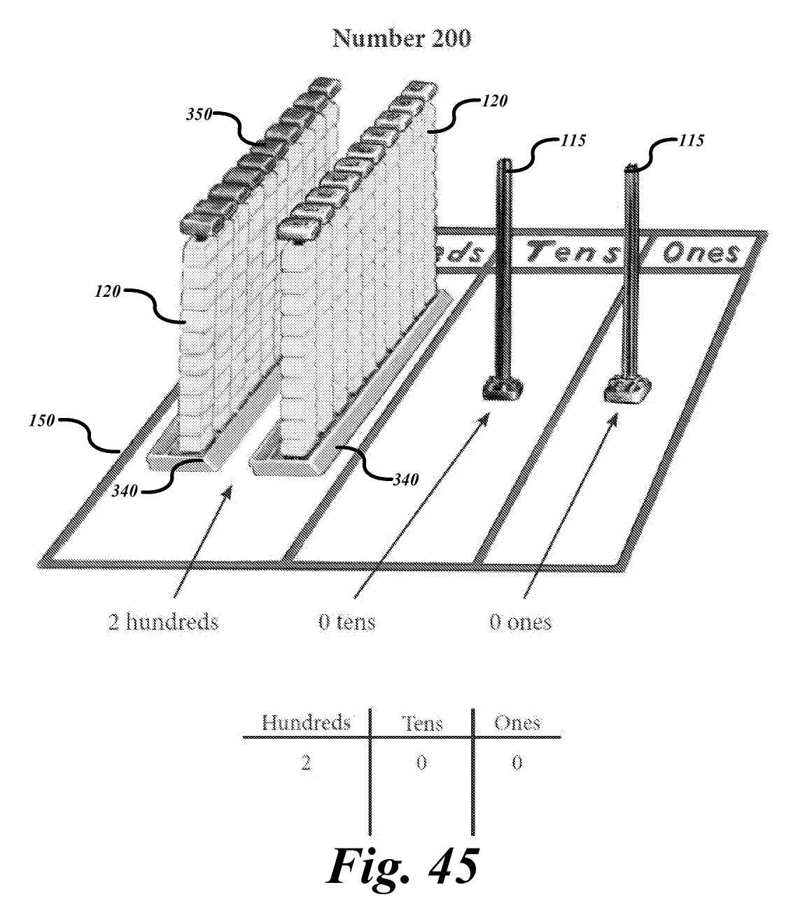

FIG. 45 schematically illustrates the representation of number 200 by the Numero Cube System 10. Two-Ten completed sticks 115 each having 10 cubes 120 and each fitted with a tens cap 350 reside in the two-Hundreds tray 340 that in turn occupies the Hundreds column, an empty stick or peg 115 not having any cubes 120 occupies the Tens column, and another empty stick 115 occupies the Ones column of the value mat 150. The two hundred trays 340 each containing ten completed sticks 115 is read or vocalized as “two hundreds”, the empty sticks 115 occupying the tens column is read or vocalized as “zero tens”, and empty stick occupying the Ones column is read or vocalized as “zero ones”.

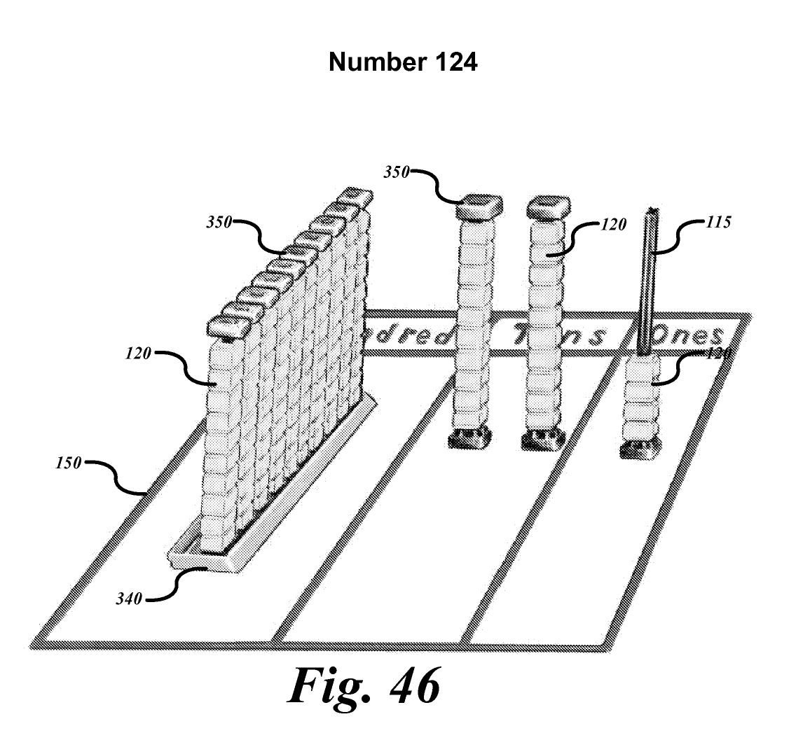

FIG. 46 schematically illustrates an application for converting standard numerical form to expanded numerical form. Numbers are normally written in the standard form, with one digit for each place value used, such as 124. The standard form can be derived by counting the number of trays, sticks, and cubes. The same numbers in expanded form would be expressed as the sum of the values of the digits. Thus, 124 in expanded form is written as 100+20+4. From the Numero Cube construction, there is 1 tray 340 in the hundreds column, 2 sticks in the tens column, and 4 cubes in the ones column. Therefore the number represented by the Numero Cubes 120 is the same number in the expanded form would be written as the sum of the total number of cubes in each column. Thus, 124 cubes=100 cubes+20 cubes+4 cubes. Students are reminded to not write this on the place value mat 150, or it will mean 100(100)+20(10)+4(1)=10204! Keep in mind that each column cannot hold more than nine items each.

Exercises: The students may be queried to construct each number below using the Numero Cubes 120. Students can write down the standard form of the number on the place value mat 150, with the digits in the proper columns. Lastly, the students are encouraged to write the expanded form on a separate sheet of paper as the sum of the number of cubes in each column.

The same number in the expanded form would be written as the sum of the total number of cubes in each column. Thus, 124 cubes=100 cubes+20 cubes+4 cubes. per below.

| Hundreds | Tens | Ones | |
|---|---|---|---|
| 1 | 2 | 4 | or 124 |

The students are discouraged from writing on the value placemat 150 as it could me a another other than 124, for example it could be construed that 10204 is the number that arises from the combination 100(100)+20(10)+4(1). The students are made aware that each column cannot hold more than nine items each.

The students can practice using the components of the Numero Cube System 10 to visualize the following numbers:

| | | | | | |
|---|---|---|---|---|---|
| a) | 40 | g) | 60 | m) | 55 |
| b) | 95 | h) | 37 | n) | 80 |
| c) | 100 | i) | 41 | o) | 109 |
| d) | 102 | j) | 93 | p) | 33 |
| e) | 119 | k) | 106 | q) | 110 |
| f) | 16 | l) | 84 | r) | 72 |

The students write down the standard form of the number positioned on or visually near the place mat 150, with the digits placed within or framed in the proper place columns. Then the students write the expanded form on a separate sheet as the sum of the cubes 120 in each place value column.

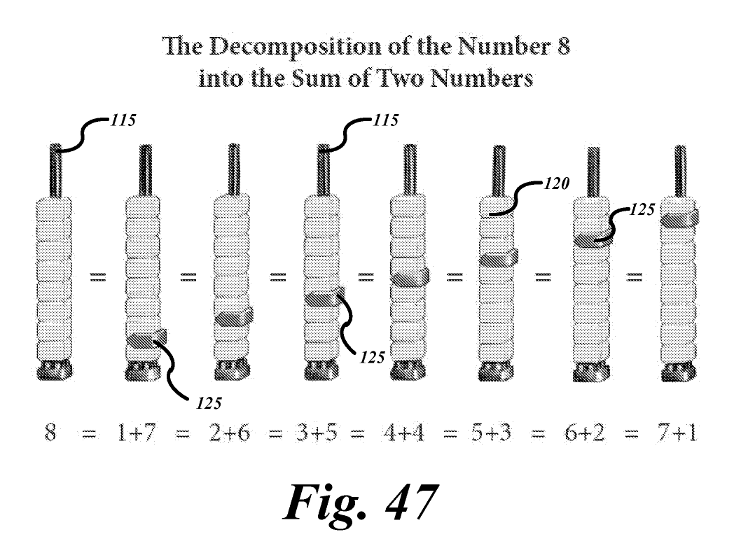

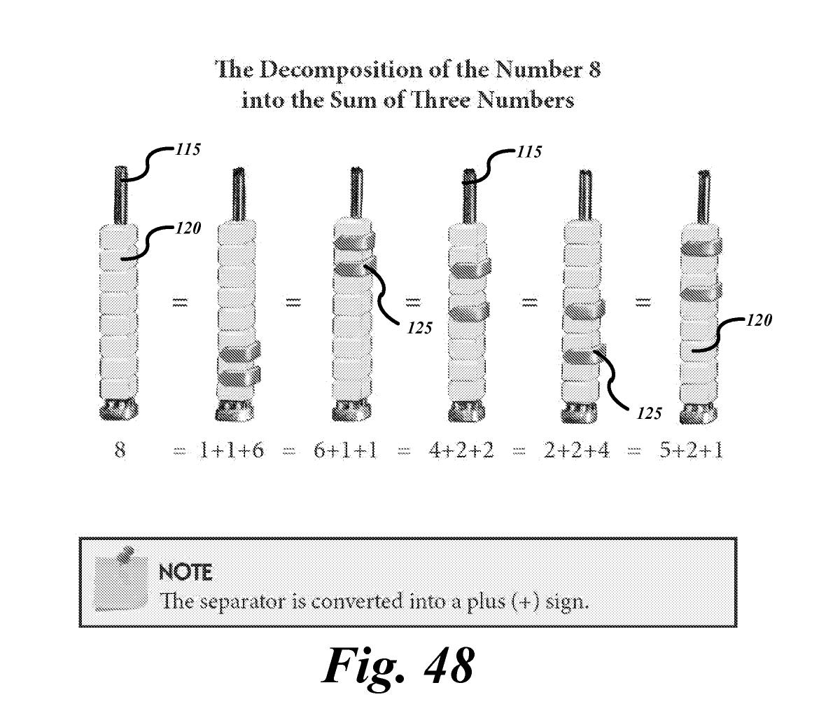

FIGS. 47-48 illustrate examples of number decomposition.

FIG. 47 schematically illustrates the decomposition of the Number 8 into the sum of two numbers. Inserting the number separators 125 between the cubes 120, the students can demonstrate visually how numbers can be written as the sum of two or three other numbers. For FIG. 47, the decomposition of the Number 8 into two numbers visualized by the insertion of the number separators 125 the commutative property of addition is becomes visually and substantially apparent to the student. In this illustration the sum combination of the following two numbers groupings results in the same answer—Number 8:

8=1+7=7+1; 8=2+6=6+2; 8=3+5=5+3

In so doing, the students learn that the order of the parts does not matter, i.e., 8 can be written as either 1+7 or 7+1, or 2+6 or 6+2, etc. The student can further view or interpret the wedged shaped number separator 125 as a translation to a plus (+) sign, i.e., the number separator functions as a plus sign in addition operations.

In accord with the illustrations in FIG. 47, the students are instructed to slide eight cubes 120 onto the cube holder 115 and insert a separator 125 at the base 100 of the cube holder 115. This denotes 8=0+8 to which the students write down. Next, the students are instructed to reposition the separator 125 so that it is in between the bottom cube 120 and the one on the top of that. They are then queried “What equation does this represent?” The class continues to move the separator 125 up on cube 120 at a time, each time writing down the addition equation represented by that configuration. The students are then queried to notice if any patterns develop with the addends.

FIG. 48 schematically illustrates the decomposition of the Number 8 into the sum of three numbers exemplified by the addend sets:

8=1+1+6=6+1+1; 8=4+2+2=2+2+4

The students are encouraged to place two separators 125 to create more patterns with three number sums for the Number 8. Students similarly write down equations on paper with the number separator 125 visualized to function as a plus (+) sign and instructed to notice any patterns that develop with the addends. The commutative property is shown here. By moving the order of the number, each sum results remain the same, that is, a value of 8.

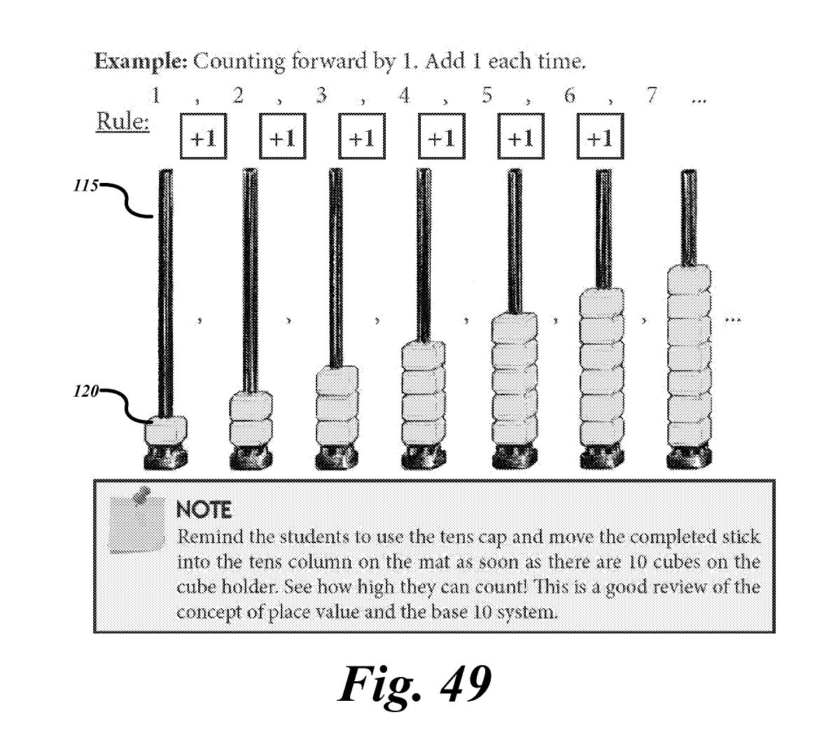

FIGS. 49-52 schematically illustrate methods employed by the Numero Cube System 10 to demonstrate the Counting Principle and properties of even and odd numbers.

FIG. 49 schematically illustrates a method for Counting Forward by one in which 1 is added each time for the number sequence 1, 2, 3, 4, 5, 6, 7, and beyond. Counting forward provides a good review of the concept of place value and the base 10 system.

To count forward is to say a sequence out loudly, starting with a chosen number, and then adding a fixed number to get to the next term in the sequence. Counting backwards using the same principle, except that a fixed number is subtracted each time to get to the next term. In this counting forward exercise the students are reminded to use the tens cap 350 and the move the completed stick 115 in to the tens column on the value mat 150 as soon as there are 10 cubes 120 on the cube holder 115. The students are encouraged to see how high they can count.

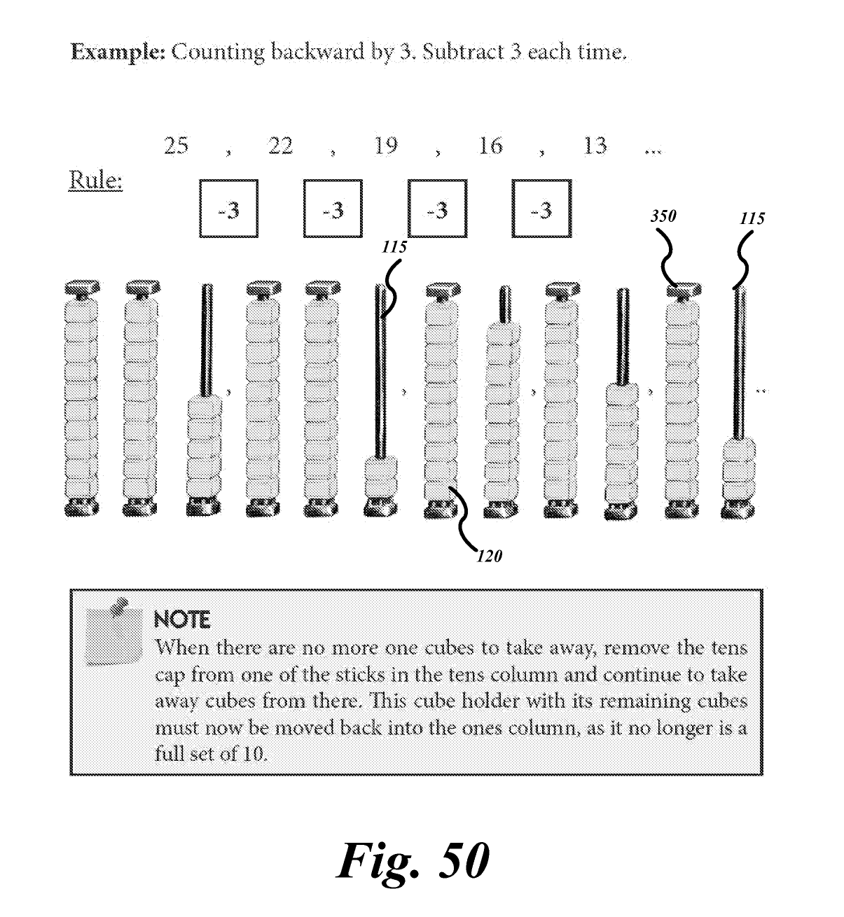

FIG. 50 schematically illustrates a method for Counting Backward by three in which 3 is deducted each time for the number sequence 25, 22, 19, 16, 13 and smaller numbers. Counting backward also provides a good review of the concept of place value and the base 10 system. As shown number 25 is comprised of two filled sticks 115 each having ten cubes 120 and tens cap 350 and a third partially filed stick having 5 cubes 120. Then these cubes are progressively removed until number 13 is reached with a single filled peg 115 and a partially filled peg 115 having 3 cubes 120. The students notice that when there are no more ones cubes 120 to take away, the tens cap 350 is removed from one of the sticks in the tens column and the student continues to take away cubes from there. The cube holder 115 with its remaining cubes now is moved into the ones column as it no longer holds a full set of ten cubes 120.

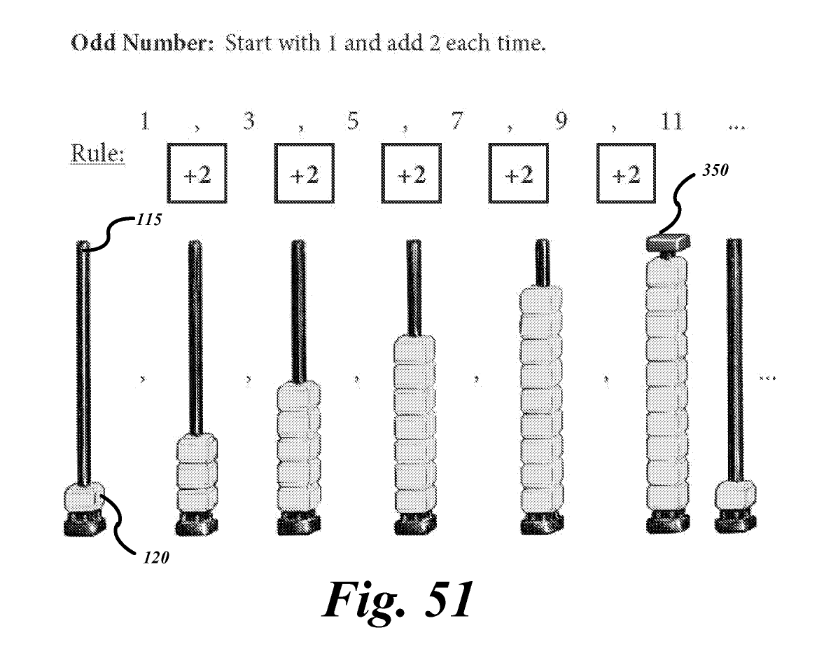

FIG. 51 schematically illustrates a method for demonstrating the development of an odd number sequence 1, 3, 5, 7, 9, 11 and beyond by adding two cubes 120 to a single peg 115 holding a single cube 120. The only difference between forming the sequences of odd and even numbers is the starting number. To generate the sequence off odd numbers, the student begins with the single peg 115 holding the single cube 120. Two cubes 120 are progressively added to generate the following number sequences 3, 5, 7, 9, and 11.

From this exercise the student learns that all odd numbers' ones digits end with 1, 3, 5, 7, and 9. When students produce an odd number, the one's digit obtained is one of those numbers. The student realizes that any number can be chosen for each of the other digits (i.e., 211, 305, 477).

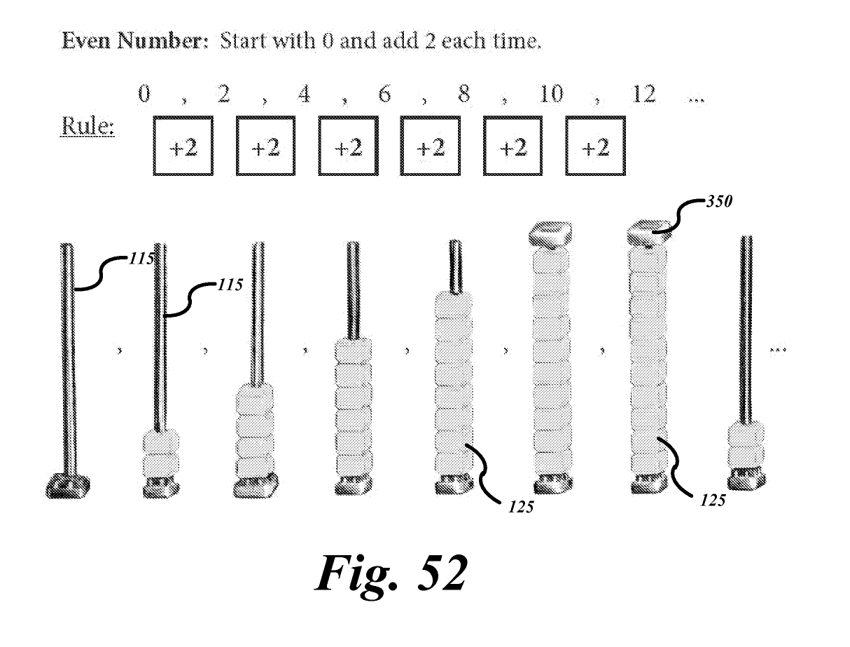

FIG. 52 schematically illustrates a method for demonstrating the development of an even number sequence 0, 2, 4, 6, 8, 10, 12, and beyond by adding two cubes 120 to a single empty peg 115 not holding any cubes 120. To generate a sequence of even numbers, an empty cube holder 115 is obtained to denote the first term, zero. From 0, the remaining even numbers 2, 4, 6, 8, 10 and 12 are obtained by adding 2 cubes 120 to the stick 115. The student notes that all even numbers end with 0, 2, 4, 6, and 8. To produce an even number the student makes sure that the one's digit is one of these numbers. The student notes that any number can be chosen for each of the digits (i.e., 30, 308, 334, etc).

Other exercises include having the student count out loud using the following rules, and simultaneously adding or taking away to construct the corresponding Numero Cube structure for each tem of the sequence:
a. Start with 0, add 3 each time
b. Start with 13, add 2 each time
c. Start with 52, subtract 1 each time
d. Start with 102, subtract 3 each time

Another exercise provides for querying the students to make up their own sequence, noting the starting pint and the counting rule. The students can challenge other students to construct the Numero Cube representations of the other student's sequences. Conversely, the students are encouraged to build sequences of their own using Numero Cubes and to see if they can write down the starting value and applying the counting rule for each one.

In yet another exercise the students build sequences for the following starting values and counting rules.
Start with 0, add 4 each time
Start with 1, add 6 each time
Start with 13, add 8 each time

Students can be queried whether the sequences generate odd or even numbers and to develop a rule about the occurrence. Students note or observe the ones column each time a new number is generated, and the fact that each of the above counting rules is a multiple of two.

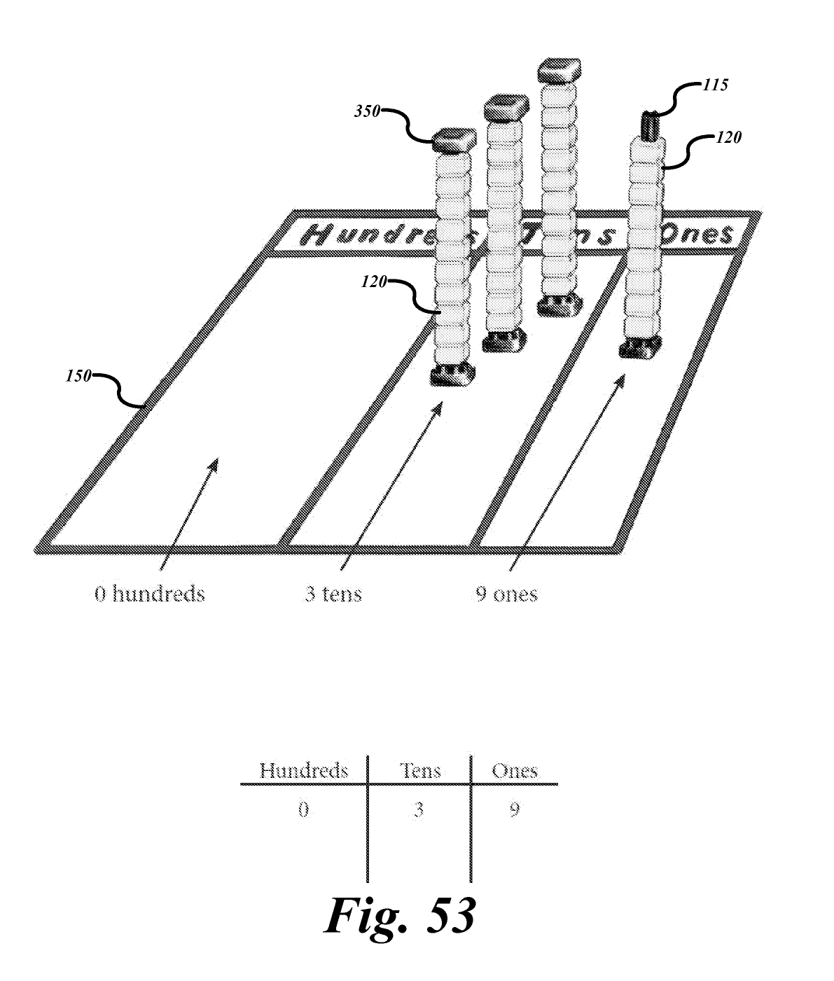

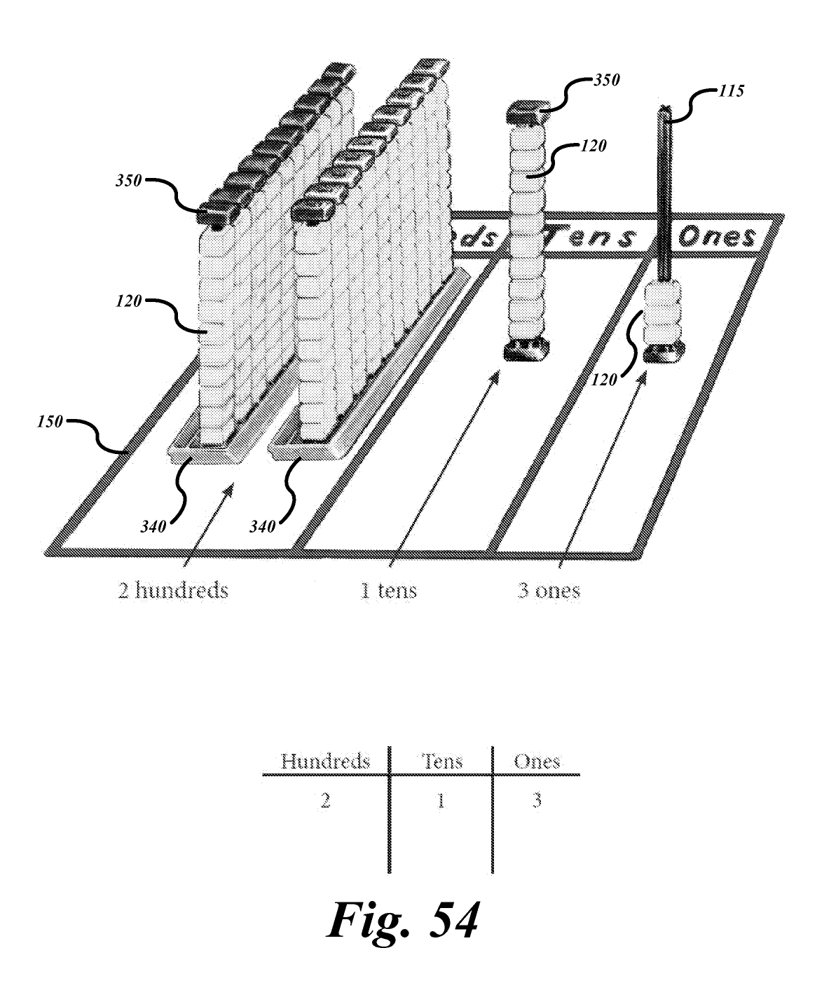

FIGS. 53 and 54 schematically illustrate a method of using the Numero Cube System 10 to visually demonstrate comparing numbers 39 and 213 respectively. Visually comparing any two numbers encompasses comparing the digits of the highest place value. For example, when comparing numbers 240 and 199, the hundreds place determines that 240 is larger than 199, since 200 is greater than 100. Since there is already a difference of 100 between 240 and 199, the other place values are ignored, as any difference in tens and ones will not overcome the difference in hundreds.

Students note that the largest place value digit is the same in both numbers, such as in the numbers 198 and 107. Then the next highest place value digit is considered; in this case, 9 tens would be compared to 0 tens. Thus 198 is larger than 107, and the ones place digit does not need to be considered. If there are the same numbers of hundreds and tens in each number, then the ones digits is compared.

Using the components of the Numero Cube System 10 allows construction of numbers that visually reinforces the concept of the value of each item in a place value column of the mat 150 and explains why the place values need to be considered in order from the highest to the lowest. Even though 39 has 2 more tens and 6 more ones in the tens and ones columns than 213 (a total difference of 26 cubes 120), 213 has 2 hundreds (2 trays 340) while 39 has 0 hundreds (no trays 340 mean 0 hundreds). Hence, 213 is larger than 39.

Suggested exercises to compare number pairs for students to visually construct and demonstrate are listed below:
a. 13 and 40
b. 6 and 21
c. 5 and 9
d. 87 and 78
e. 15 and 19
f. 33 and 38
g. 56 and 65
h. 87 and 78
i. 91 and 89
j. 71 and 80

As the students visually compare the numbers above, they can be encouraged to consider comparing the numbers of sticks 115 in each construction to determine which number is larger. If there is no difference, the students can compare the number of cubes 120 in the ones column to find the larger number.

The students can be partitioned into groups, say one to four in a group, and instructed to construct larger numbers, say 120, 210, 126, and 216. The students then place their Numero Cube constructions under the place value column headings of the same mat 150. The last two constructions will be off the mat 150. Each student group is instructed to write down the digits of their constructed numbers onto a table of place value columns, as indicated below:

Place Value Table

| Hundreds | Tens | Ones |
|---|---|---|
| 1 | 0 | 0 |
| 2 | 1 | 0 |
| 1 | 2 | 6 |
| 2 | 1 | 6 |

Students can be encouraged to discuss the algorithm behind ordering these numbers by size from largest to smallest.

Other exercises may be cumulative:

1. Students can construct each number using the Numero Cubes 120/220. As they proceed with number construction using it components, learning is enhanced as they write down both the standard form and the expanded form of the number.

a. 102 b. 97 c. 119 d. 135 e. 228 f. 163

2. Students may also construct both given numbers in each problem using the Numero Cube to compare the numbers. Use “>, <, or =” to indicate the correctly relationship between the numbers.

| | | | | | |
|---|---|---|---|---|---|
| a. | 98 □ 89 | b. | 110 □ 120 | c. | 74 □ 62 |
| d. | 56 □ 56 | e. | 127 □ 172 | f. | 91 □ 19 |

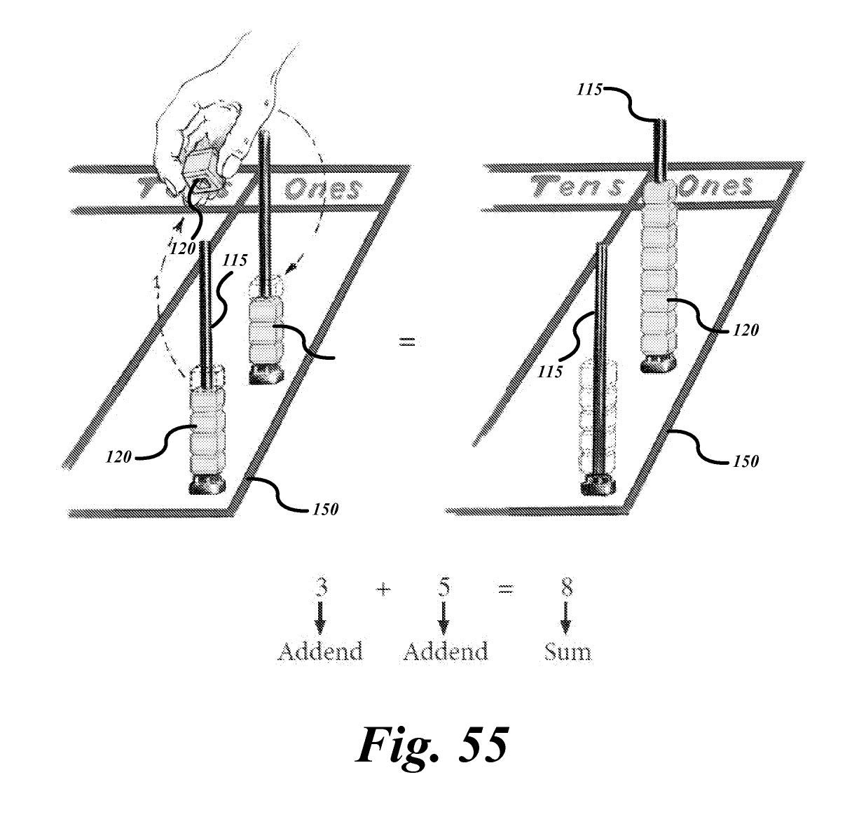

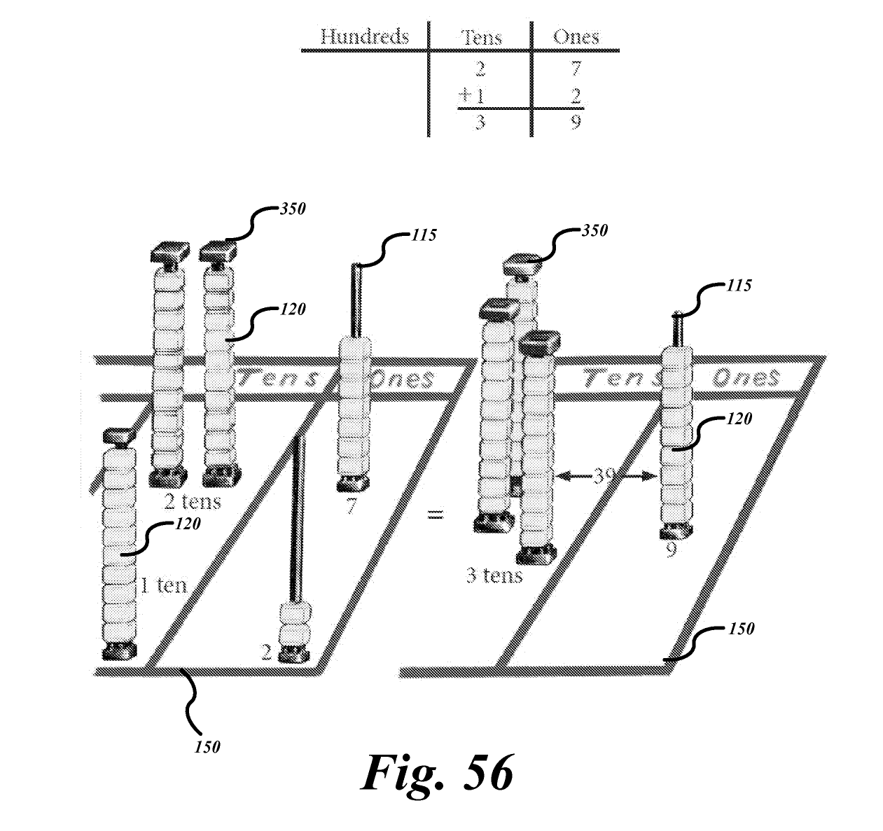

FIGS. 55-56 schematically illustrates methods of using the kit components of the Numero Cube System 10 with regards to teaching addition without regrouping. Addition involves combining the digits of the addends and carrying out the necessary transfers to make sure each place value does not exceed its limit. Keep in mind that the Numero Cube System 10 is easily suitable to represent sums up to 399 due the space of the place value mat 150.

In addition the terms adding, combining the terms, finding the total, and finding the sum have the same meaning. These terms mean combining things into one set and finding out how many there are in this set. Addition without regrouping simply involves combining the digits of the addends in each place vale column. This concept can easily be expanded to three digit numbers, though students conveniently learn with simple addition of smaller sums first before progressing to larger numbers.

FIG. 55 schematically illustrates methods of using the kit components of the Numero Cube System 10 with regards to teaching addition without regrouping for the addends 3 and 5 below depicted below to achieve the sum of 8.

| | | |
|---|---|---|
| Hundreds | Tens | Ones |

3
+5
8

As shown in FIG. 55 the student removes the cubes 120 from the cube holder 115 partially filled or loaded with cubes 120 and combines them to the second cube holder 115 initially loaded with three cubes 120. As the transfer process occurs (depicted in phantom outline) the student observes that the sum results gets larger until all of the cubes 120 from the first cube holder 115 are transferred to the second one. The sum result is equal to 8 cubes 120. The empty cube holder 115 is displaced away from the mat 150.

FIG. 56 schematically illustrates methods of using the kit components of the Numero Cube System 10 with regards to teaching addition without regrouping for the addends 27 and 12 below depicted below to achieve the sum of 39. Addend 27 is located on the upper portion distributed among three cube holders 115 (two completely filled and one partially filled with seven cubes 120), and addend 12 located on the lower portion of value mat 150 as shown on the left side of FIG. 56 that is distributed among two holders 115, one filled and the other partially filled with two blocks 120. Thus a total of 5 cube holders 115 are shown to for these two addends. Students similarly transfer cubes 120 described for FIG. 55 to that the sum of 39 is achieved as shown on the right side of FIG. 56 in which 39 is distributed among four holders 115 (three completely filled and one partially filled with nine cubes 120).

Use the Numero Cube System 10 to find each sum. Students may be encouraged to ascertain and explain whether patterns occur and repeat.

Exercise 1: Use the Numero Cube System 10 to find each sum. Are there patterns here that you can find? Explain.

| | | | | | | | |
|---|---|---|---|---|---|---|---|
| a. | 5 + 3 | b. | 6 + 0 | c. | 7 + 2 | d. | 4 + 4 |
| e. | 4 + 5 | f. | 8 + 1 | g. | 0 + 9 | h. | 6 + 3 |
| i. | 3 + 3 | j. | 7 + 0 | k. | 2 + 5 | l. | 5 + 2 |
| m. | 1 + 5 | n. | 4 + 3 | o. | 2 + 2 | p. | 1 + 1 |
| q. | 3 + 4 | r. | 0 + 4 | s. | 5 + 0 | t. | 9 + 1 |
| u. | 5 + 1 | v. | 0 + 3 | x. | 7 + 2 | y. | 5 + 2 |

Exercise 2: Use the Numero Cube System 10 to find each sum. Find all patterns.

| | | | | | | | |
|---|---|---|---|---|---|---|---|
| a. | 15 + 23 | b. | 16 + 10 | c. | 37 + 21 | d. | 14 + 14 |
| e. | 41 + 50 | f. | 81 + 11 | g. | 20 + 39 | h. | 63 + 23 |
| i. | 38 + 31 | j. | 71 + 21 | k. | 28 + 50 | l. | 15 + 23 |
| m. | 15 + 54 | n. | 41 + 30 | o. | 27 + 20 | p. | 19 + 30 |
| q. | 44 + 14 | r. | 10 + 33 | s. | 25 + 41 | t. | 15 + 14 |
| u. | 24 + 42 | v. | 17 + 20 | w. | 14 + 14 | x. | 30 + 12 |

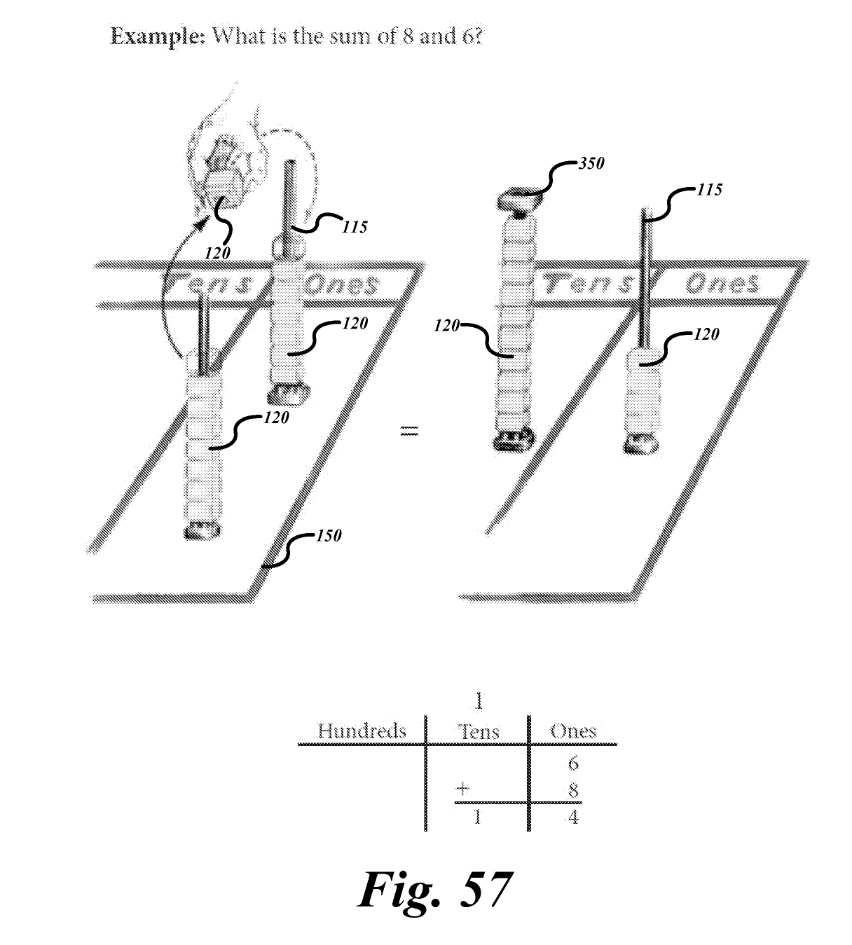

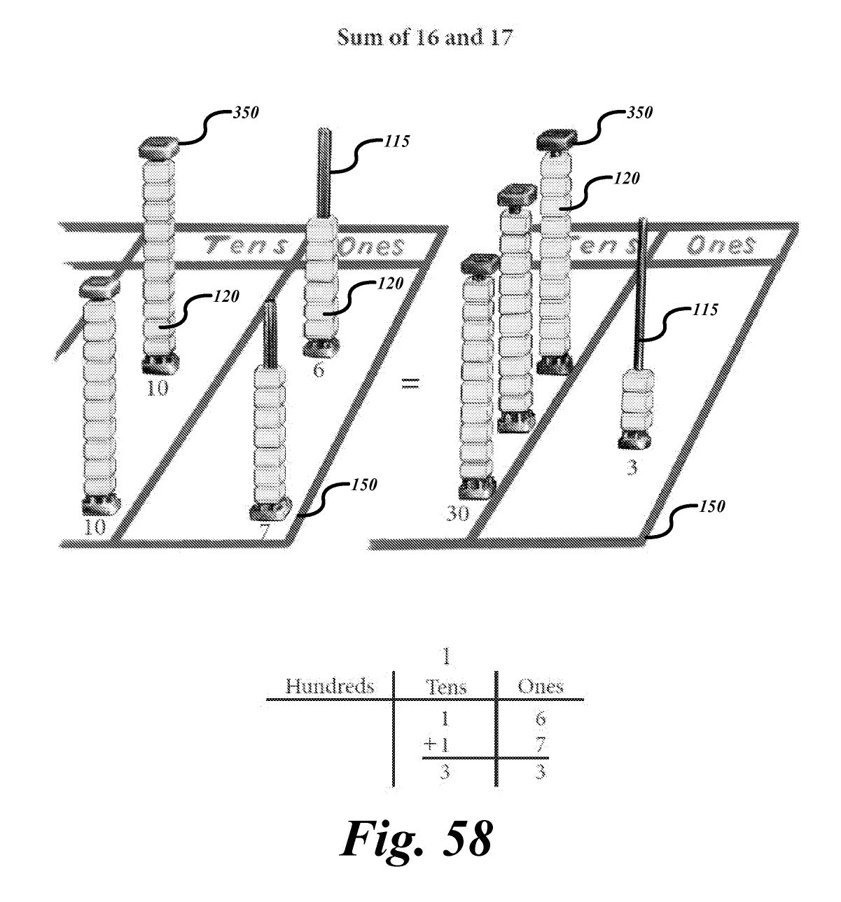

FIGS. 57-58 schematically illustrates methods of using the kit components of the Numero Cube System 10 with regards to teaching addition with regrouping. Addition involves combining the digits of the addends and carrying out the necessary transfers to make sure each place value does not exceed its limit. Users of the particular embodiments will be aware of spatial restrictions in that the Numero Cube System 10 is easily suitable to represent sums up to 399 due the space or size of the place value mat 150.

FIG. 57 schematically illustrates the addition with regrouping of the sum for 8 and 6. In the case of adding 8 and 6, Students can proceed by obtaining two cube holders 115 and place in the ones column, one cube holder 115 partially filled with eight cubes 120, the other holder 115 partially filled with 6 cubes 120. The cubes 120 are transferred one by one from the 6 cube holder 115 to the eight cube holder 115 with the remaining four cubes 120 in the ones column. The resulting configuration represents the sum of 14.

FIG. 58 schematically illustrates the addition with regrouping of the sum for 16 and 17.

Exercise 2: Students can use the Numero Cube System 10 to find each sum and any and all patterns. Students can also be encourage to explain step-by-step each pattern that appears from the following numbers:

| | | | | | | | |
|---|---|---|---|---|---|---|---|
| a. | 5 + 9 | b. | 5 + 7 | c. | 3 + 9 | d. | 1 + 3 |
| e. | 4 + 7 | f. | 8 + 9 | g. | 3 + 8 | h. | 6 + 5 |
| i. | 8 + 8 | j. | 8 + 6 | k. | 4 + 8 | l. | 2 + 8 |
| m. | 7 + 5 | n. | 9 + 7 | o. | 8 + 4 | p. | 9 + 9 |
| q. | 7 + 7 | r. | 5 + 5 | s. | 7 + 9 | t. | 9 + 3 |
| u. | 9 + 5 | v. | 9 + 3 | w. | 9 + 2 | x. | 9 + 6 |

Students can evaluate whether special patterns exist below.

| | | | | | | | |
|---|---|---|---|---|---|---|---|
| a. | 15 + 23 | b. | 16 + 17 | c. | 37 + 21 | d. | 24 + 19 |
| e. | 41 + 29 | f. | 45 + 36 | g. | 58 + 24 | h. | 37 + 23 |
| i. | 38 + 31 | j. | 71 + 21 | k. | 28 + 50 | l. | 15 + 23 |
| m. | 15 + 54 | n. | 41 + 30 | o. | 27 + 20 | p. | 19 + 30 |
| q. | 44 + 14 | r. | 10 + 33 | s. | 25 + 41 | t. | 15 + 14 |
| u. | 29 + 55 | v. | 31 + 39 | w. | 73 + 19 | x. | 49 + 49 |

Exercise 3: Similarly, the Numero Cube System 10 can be utilized by the student to find each sum and any special patterns arising within the following numbers:

| | | | | | | | |
|---|---|---|---|---|---|---|---|
| a. | 48 + 52 | b. | 55 + 45 | c. | 79 + 21 | d. | 66 + 34 |
| e. | 27 + 73 | f. | 19 + 81 | g. | 24 + 76 | h. | 89 + 11 |
| i. | 25 + 75 | j. | 34 + 64 | k. | 12 + 88 | l. | 15 + 85 |
| m. | 33 + 67 | n. | 47 + 53 | o. | 57 + 43 | p. | 64 + 36 |
| q. | 51 + 49 | r. | 21 + 79 | s. | 15 + 85 | t. | 29 + 71 |
| u. | 62 + 28 | v. | 43 + 57 | w. | 49 + 51 | x. | 49 + 49 |

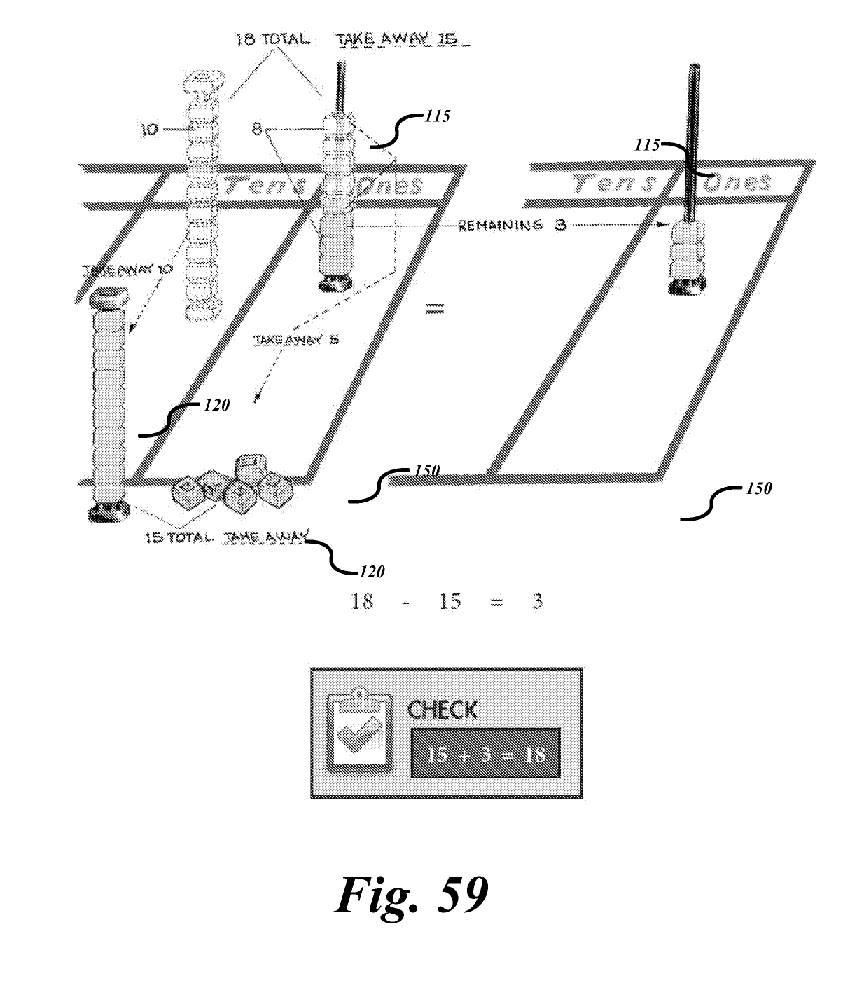

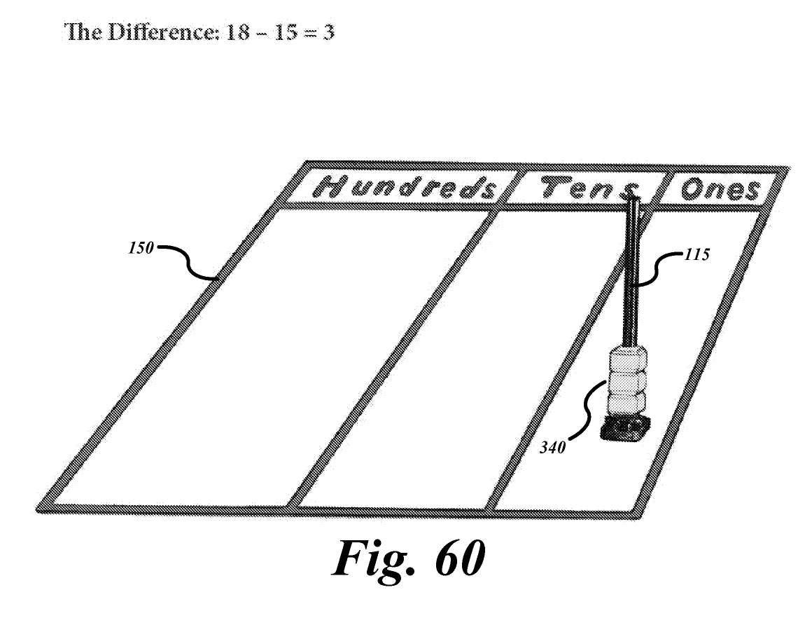

FIGS. 59-60 schematically illustrates methods of using the kit components of the Numero Cube System 10 with regards to teaching subtraction without Regrouping. Subtraction is about removing items from a group. Subtracting, taking away, removing items, or finding the difference has the exact same meaning.

Example: Take away 15 from 18.

| Hundreds | Tens | Ones |
|---|---|---|
| | 1 | 8 |
| | −1 | 5 |
| | | 3 |
| 18 − 13 = | 3 | |
| | ↓ | |
| | Difference | |

CHECK: Use addition to make sure the subtraction process was done correctly. Simply put back the cubes that were removed to obtain the original number.

15+3=18

FIG. 59 schematically illustrates the checking process of taking 15 away from 18. A completely filled cube holder 115 is removed from tens column to reside outside the tens column off the card 150. Similarly, 5 of the 8 cubes are taken from the cube holder 115 residing within the ones column and set aside or off the card 150. Dashed phantoms depict the translocation of filled cube holders 115 or partially depleted cube holders 115.

FIG. 60 illustrates the difference of 3 wherein a remaining 3 cubes 120 are occupying a cube holder 115 residing in the ones column. This difference of 3 is the mathematical equivalent of 18−15=3. When the student comes out to have exactly the same number of cubes 120 they started out with, the subtraction process is confirmed to be done correctly. Students employing subtraction without regrouping remove the exact number of cubes 120 needed and then perform a check procedure by adding what they removed to the left over cubes 120. If the result comes out to be exactly what they started out with, the subtraction process is confirmed to have been done correctly.

Exercise 1: Students can use the Numero Cube System 10 to find each difference in the number sets below:

| | | | | | | | |
|---|---|---|---|---|---|---|---|
| a. | 15 − 4 | b. | 28 − 8 | c. | 37 − 6 | d. | 25 − 3 |
| e. | 19 − 8 | f. | 35 − 5 | g. | 46 − 5 | h. | 49 − 7 |
| i. | 38 − 7 | j. | 16 − 6 | k. | 45 − 4 | l. | 82 − 1 |
| m. | 45 − 3 | n. | 27 − 6 | o. | 55 − 5 | p. | 96 − 5 |
| q. | 59 − 6 | r. | 48 − 4 | s. | 24 − 4 | t. | 48 − 5 |
| u. | 75 − 2 | v. | 75 − 4 | w. | 54 − 1 | x. | 78 − 4 |

Exercise 2: Students can use the Numero Cube System 10 to find each difference in the number sets below:

| | | | | | | | |
|---|---|---|---|---|---|---|---|
| a. | 24 − 14 | b. | 37 − 14 | c. | 20 − 10 | d. | 7 − 12 |
| e. | 59 − 16 | f. | 58 − 37 | g. | 50 − 40 | h. | 47 − 17 |
| i. | 39 − 14 | j. | 63 − 14 | k. | 62 − 14 | l. | 84 − 31 |
| m. | 47 − 15 | n. | 82 − 31 | o. | 91 − 70 | p. | 95 − 23 |
| q. | 58 − 45 | r. | 79 − 34 | s. | 56 − 40 | t. | 78 − 36 |
| u. | 87 − 67 | v. | 88 − 44 | w. | 76 − 42 | x. | 61 − 40 |

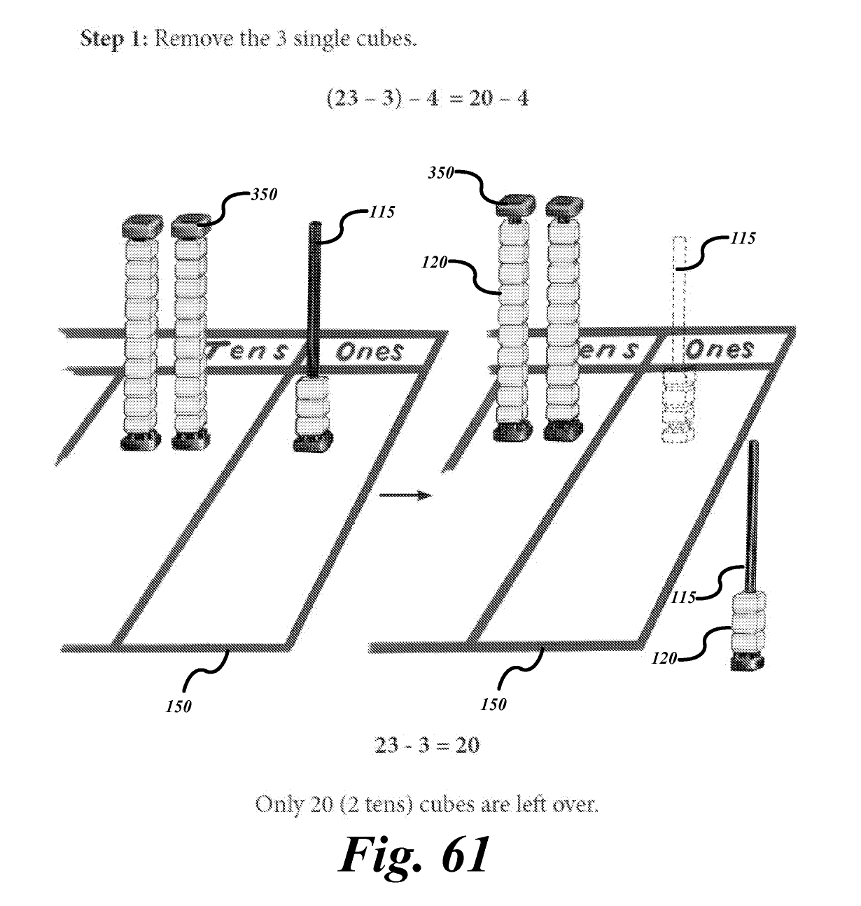

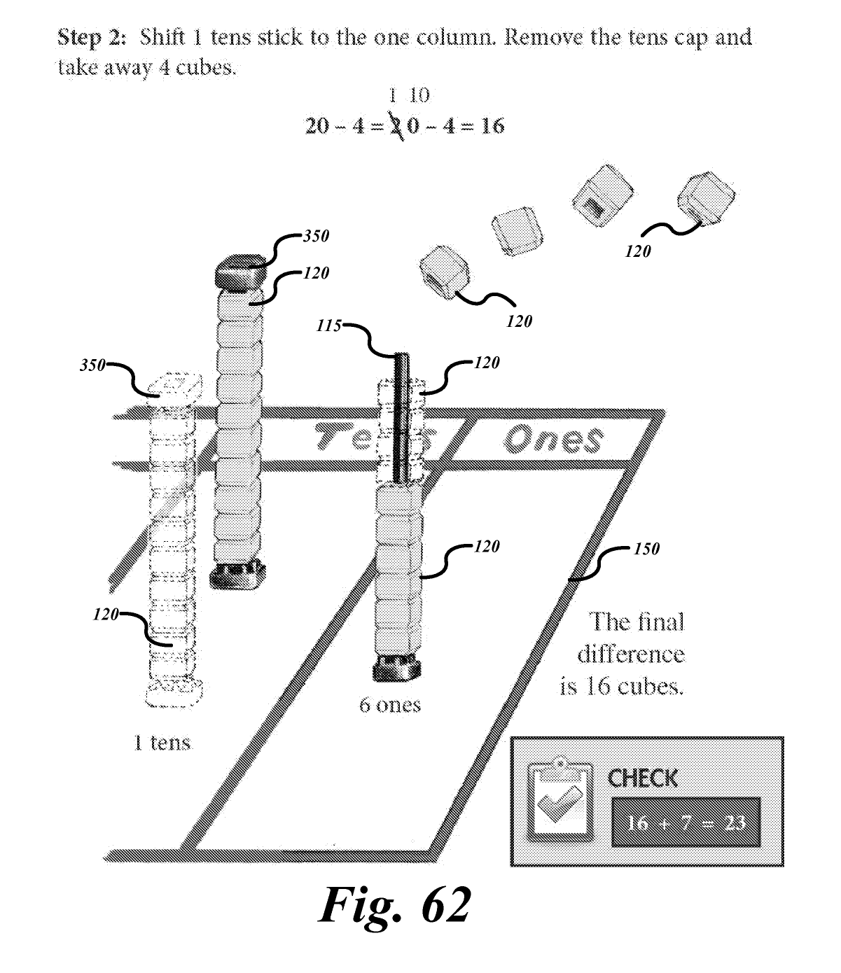

FIGS. 61 and 62 schematically illustrate a first method of using the kit components of the Numero Cube System 10 with regards to teaching subtraction with Regrouping for the term 23-7. Method 1 commences with removing cubes 120 from the ones column first. When there are no more cubes to take away in this column, move a stick or peg 115 from the tens column into the ones column, remove the tens cap, and continue to take away cubes until the subtraction has been completed. To represent the final difference, remove the empty cube holder 115. There are three steps to the first method.

Beginning with step 1, a student removes the 3 cubes in the ones column first. There are only 2 tens sticks left over. He/she needs to remove 4 more cubes and the subtraction process is done. This step is shown in FIGS. 61 and 62. Algebraically, this is expressed as (23−3)−4=20−4.

For step 2, there are only 2 tens sticks left over. The student needs to remove 4 cubes and the subtraction process is done. In order to do this task, the student has to shift 1 tens stick to the ones column and take the tens cap off. Now the student can remove four cubes from the 10 ones.

20−4=20−4=16

In step 3, the student checks to make sure the subtraction process was done correctly by putting back all the cubes 120 that the student took away. If the student got the total number of cubes to be 23, then the subtraction process was done properly.

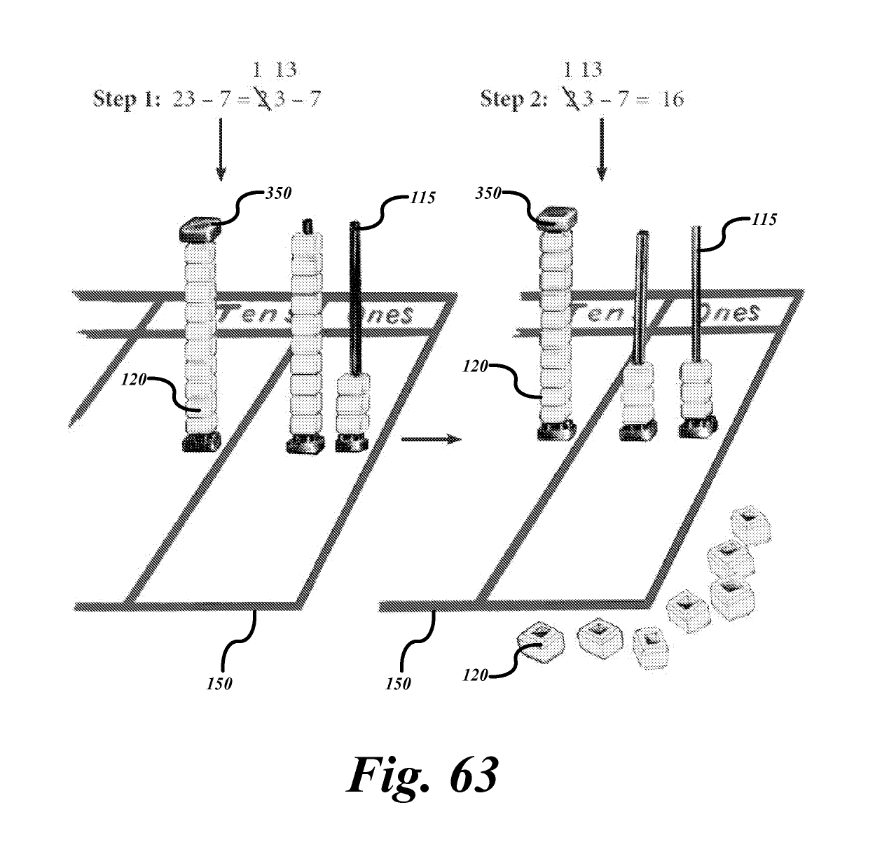

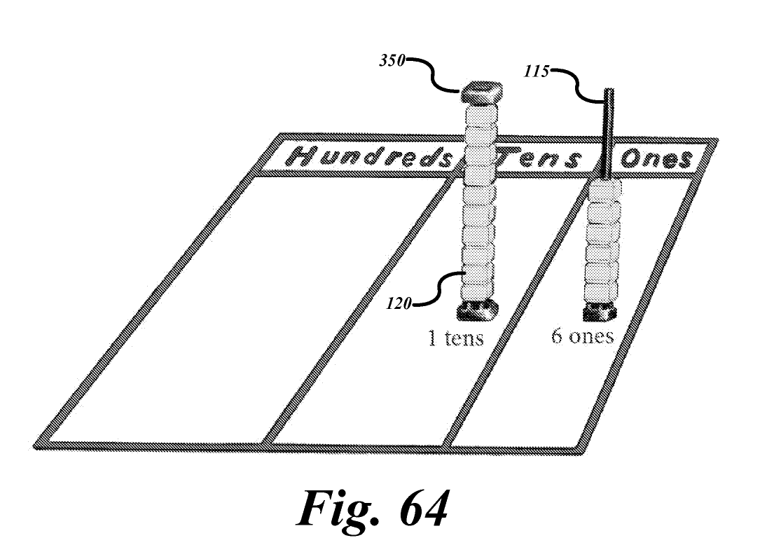

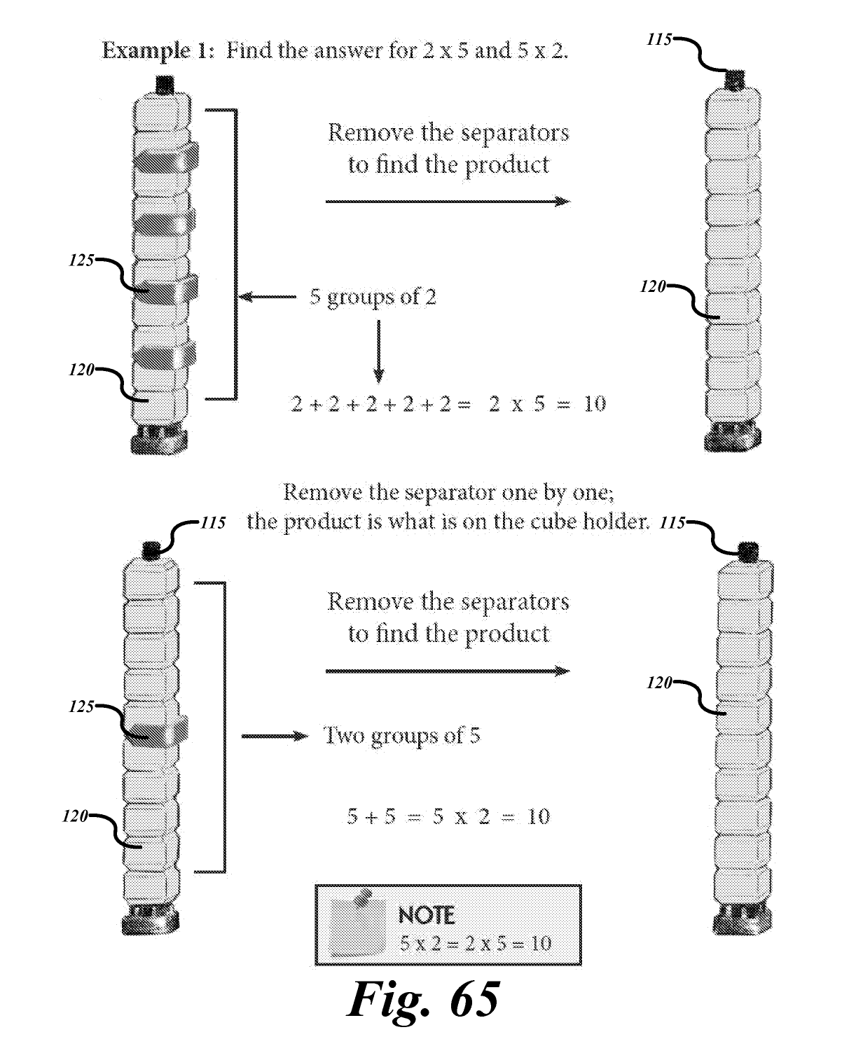

The check procedure employs three steps illustrated in FIGS. 63 and 64.

Method 2 includes four steps.

Beginning with step 1, the student removes the tens cap 350 from the two sticks 115 in the tens column and shifts this to the ones column. At this point, there are exactly 1 tens and 13 ones.

In step 2, the student removes 7 cubes form the 10 ones to leave 3 left on the cube holder 115.

In step 3, the student transfers the 3 left over cubes onto the cube holder 115 that already has the original 3 cubes. The empty cube holder is then set aside or discarded. At this juncture there are totally 16 cubes left over comprise 1 tens and 6 ones.

Step 4 employs a check procedure in that all cubes taken out are put back. Upon doing this, the student should notice that if the sum is exactly equal to 23 cubes, the subtraction process was done correctly. The student can determine this from the table below that conveys a complete mathematical subtraction process.

| | | |
|---|---|---|
| Hundreds | Tens | Ones |

| | |
|---|---|
| 1 | 13 |
| [symbol] | [symbol] |
| − | 7 |
| 1 | 6 |

Procedurally, step 4 further includes taking the tens cap 350 is taken from one of the two sticks or pegs 115 and shifted to the ones column. At this point there should be 1 tens and 13 ones. This is equivalent to the calculations shown on the left half of FIG. 63.

For step 2, 7 cubes 120 are removed from the 10 ones. There are 3 cubes left over on the cube holder 115. This is equivalent to the calculations shown on the right half of FIG. 63.

For step 3, 3 cubes 120 are transferred onto the cube holder 115 that already has 3 cubes. The empty cube holder 115 is set aside or discarded.

Exercise 3: Students can use the Numero Cube System 10 to find each difference in the number sets below:

| | | | | | | | |
|---|---|---|---|---|---|---|---|
| a. | 15 − 8 | b. | 28 − 9 | c. | 37 − 9 | d. | 25 − 6 |
| e. | 12 − 8 | f. | 35 − 8 | g. | 46 − 7 | h. | 40 − 7 |
| i. | 33 − 7 | j. | 12 − 6 | k. | 25 − 9 | l. | 22 − 5 |
| m. | 45 − 9 | n. | 21 − 6 | o. | 50 − 5 | p. | 31 − 8 |
| q. | 50 − 6 | r. | 43 − 4 | s. | 21 − 4 | t. | 43 − 5 |
| u. | 25 − 7 | v. | 30 − 6 | w. | 14 − 8 | x. | 18 − 9 |

Exercise 4: Students can use the Numero Cube System 10 to find each difference in the number sets below:

| | | | | | | | |
|---|---|---|---|---|---|---|---|
| a. | 15 − 4 | b. | 28 − 8 | c. | 37 − 6 | d. | 25 − 3 |
| e. | 19 − 8 | f. | 35 − 5 | g. | 46 − 5 | h. | 49 − 7 |
| i. | 38 − 7 | j. | 16 − 6 | k. | 45 − 4 | l. | 82 − 1 |
| m. | 45 − 3 | n. | 27 − 6 | o. | 55 − 5 | p. | 96 − 5 |
| q. | 59 − 6 | r. | 48 − 4 | s. | 24 − 4 | t. | 48 − 5 |

FIGS. 65-68 schematically illustrate methods of using the kit components of the Numero Cube System 10 with regards to teaching multiplication and factoring exercises. Multiplication comes from the word multiple and means many of the same kind. Multiplying or finding the product means substantially the same thing. Multiplication is a short cut for addition of the same number several fold as shown below.

Example: Rewriting the following sum in the product form is

2+2+2+2+2=2×5=10

The above sum also can be rewritten as following:

5+5=5×2=10

Multiplication commutative property:

2×5=5×2=10

Exercise 1: Students can use the Numero Cube System 10 to rewrite each problem below as a product form:

| | | | |
|---|---|---|---|
| a. | 3 + 3 + 3 + 3 + 3 + 3 | b. | 7 + 7 + 7 + 7 + 7 + 7 + 7 + 7 |
| c. | 8 + 8 + 8 | d. | 9 + 9 + 9 + 9 + 9 |
| e. | 5 | f. | 6 + 6 |
| g. | 9 + 9 + 9 + 9 | h. | 4 + 4 + 4 + 4 + 4 + 4 + 4 + 4 + 4 |
| i. | 2 + 2 + 2 + 2 + 2 | j. | 5 + 5 + 5 + 5 + 5 + 5 + 5 |

FIG. 651 schematically illustrates a method to find an answer for the product of a mathematical operation involving the terms 2×5 and 5×2. In the upper half of this illustration, the student obtains a peg 115 and loads ten cubes 120, then interposes four number separators 125 after every second two-cube 120. Shown are four number separators 125 that define five groups of two cubes 120. The addition operation 2+2+2+2+2 is visually apparent to the student to be equivalent to the product of 2 cubes 120 and 5 groups, that is, the product of factors 2 and 5, or equivalently expressed as 2×5. Upon removal of the four number separators 125, an answer of ten is obtained in which ten cubes 120 are shown stacked on the shaft or cube holder 115.

Similarly, in the lower half of this illustration, a single number separator 125 is inserted between two five-cube 120 groups. The addition operation 5+5 is shown to be the multiplicative equivalent of the product of factors 5 and 2, or equivalently expressed as 5×2. Removing the single number separator 125 reveals a stack of ten cubes 120 are shown held on cube holder 115.

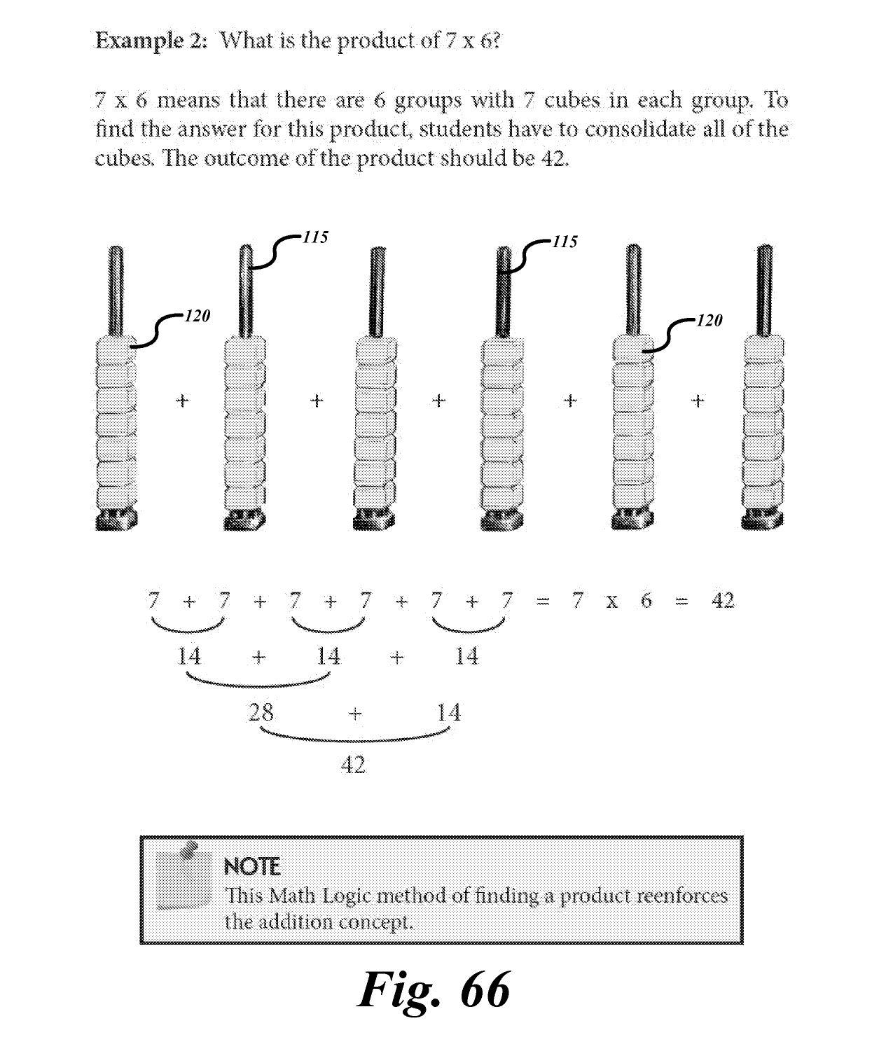

FIG. 66 schematically illustrates a method to find an answer for the product of 7×6. As shown “7×6” means that there are six groups with seven cubes in each group. The answer is found for this product when students learn to consolidate all of the cubes. The outcome of the product upon consolidation is 42.

The logic exercises arising from the manipulation of the kit components as shown in FIGS. 65 and 66 above for the purposes of finding a product reinforces the addition concept. In FIG. 62 every two seven-cube 120 groups can be summed to three groups having 14 that eventually sum to 42.

Exercise 1: Use the Numero Cube System 10 to find each product and further illustrate how multiplication serves as a shortcut for addition. Follow the example as illustrated in FIG. 61:

| | | | | | | | |
|---|---|---|---|---|---|---|---|
| a. | 5 × 0 | b. | 3 × 1 | c. | 5 × 4 | d. | 3 × 8 |
| e. | 4 × 4 | f. | 5 × 3 | g. | 3 × 3 | h. | 3 × 7 |
| i. | 2 × 7 | j. | 2 × 8 | k. | 3 × 2 | l. | 2 × 9 |
| m. | 6 × 4 | n. | 3 × 6 | o. | 4 × 6 | p. | 2 × 5 |
| q. | 9 × 2 | r. | 5 × 4 | s. | 7 × 8 | t. | 2 × 4 |
| u. | 4 × 5 | v. | 6 × 3 | w. | 3 × 5 | x. | 7 × 4 |

Exercise 2: Use the Numero Cube System 10 to find large products. Follow example of number consolidation as illustrated in FIG. 65.

| | | | | | | | |
|---|---|---|---|---|---|---|---|
| a. | 9 × 0 | b. | 7 × 5 | c. | 7 × 9 | d. | 6 × 8 |
| e. | 9 × 9 | f. | 9 × 6 | g. | 8 × 8 | h. | 8 × 7 |
| i. | 7 × 7 | j. | 9 × 9 | k. | 3 × 5 | l. | 4 × 8 |
| m. | 6 × 6 | n. | 8 × 6 | o. | 6 × 5 | p. | 8 × 9 |
| q. | 9 × 7 | r. | 5 × 9 | s. | 7 × 6 | t. | 9 × 8 |

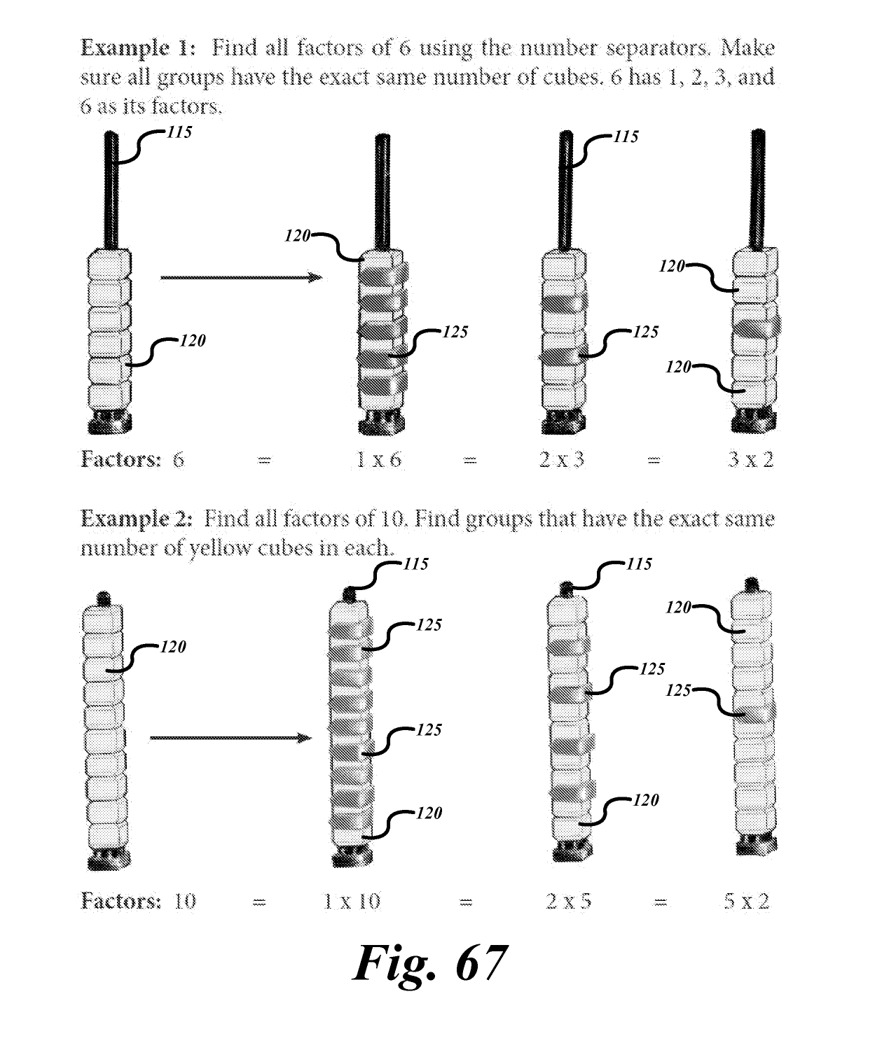

FIG. 67 schematically illustrates a method using the kit components of the Numero Cube System 10 to find all factors of a number. As exemplarity depicted in the upper portion of this illustration, in example 1 students can use a peg 115 loaded with six cubes 120 and distribute the six-cube loaded peg 115 to be inserted with five number separators 125 that partitions the loaded peg into six single-cube 120 groups. Alternatively, two number separators 125 that partitions the loaded peg into three double-cube 120 groups, or a single number separator 125 interposed to partition the loaded peg into two triple-cube 120 groups. The respective factor pairs are 1×6, 2×3, and 3×2.

Similarly, as shown in example 2 in the bottom portion of FIG. 63, the possible factors for 10 are shown to have a 10 cube loaded peg to be portioned as 1×10, 2×5, and 5×2.

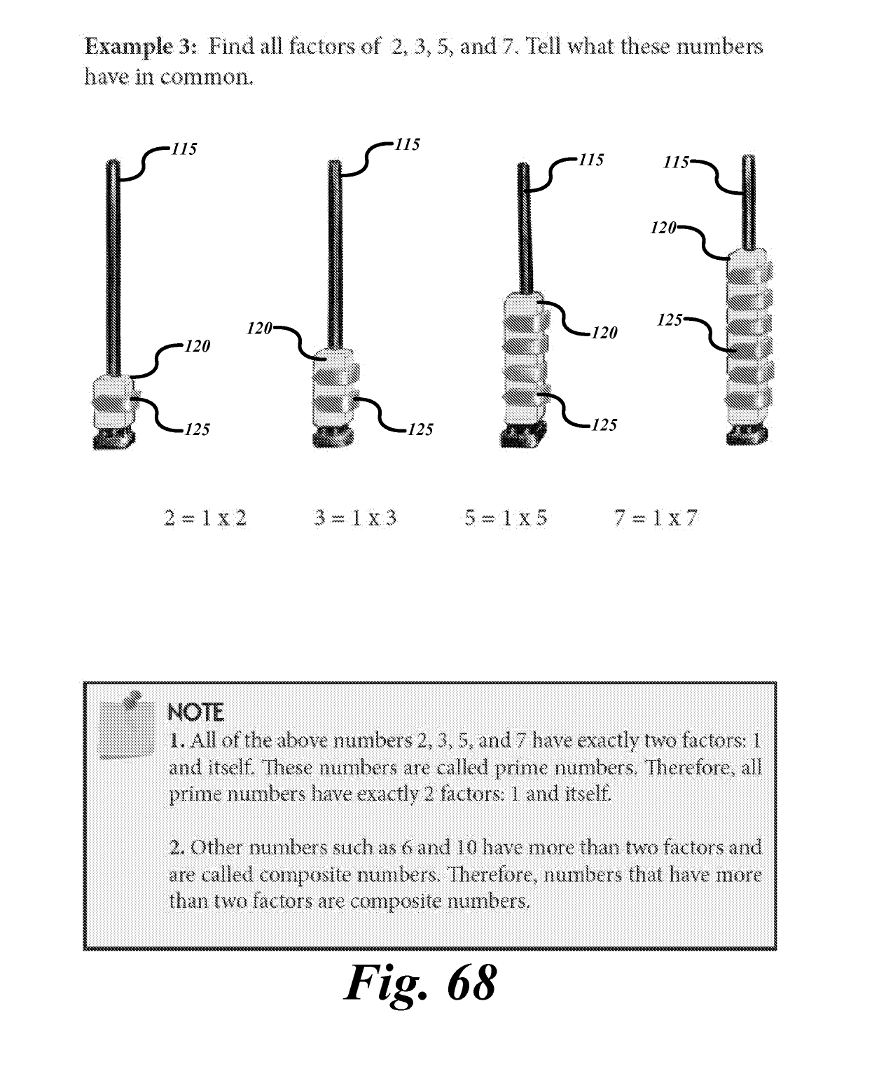

FIG. 68 schematically illustrates a method using the kit components of the Numero Cube System 10 to find all factors of a prime number. In this example 3, all the numbers examined are 2, 3, 5, and 7 that have exactly two factors: One and itself. A number expressed as a product of only one and itself are defined as prime numbers. Therefore, all prime numbers have exactly two factors: one and itself. The other numbers such as 6 and 10 as shown in FIG. 68 have more than two factors and are called composite numbers. Therefore, numbers that have more than two factors are composite numbers.

Exercise 1: Student can find all factors of each number below to ascertain patterns of prime and composite numbers using the Numero Cube System 10. Algorithms depicted similar to the number sequencing or consolidation depicted in FIGS. 67 and 68 to find all factors of a number.

| | | | | | | | |
|---|---|---|---|---|---|---|---|
| a. | 4 | b. | 10 | c. | 18 | d. | 28 |
| e. | 9 | f. | 15 | g. | 17 | h. | 29 |
| i. | 11 | j. | 14 | k. | 21 | l. | 31 |
| m. | 8 | n. | 13 | o. | 24 | p. | 30 |
| q. | 16 | r. | 16 | s. | 26 | t. | 32 |
| u. | 12 | v. | 19 | w. | 22 | x. | 35 |

Exercise 2: Find all factors of these large numbers without using the Numero Cube System 10. Algorithms depicted similar to the number sequencing or consolidation depicted in FIGS. 61 and 62 can be used in finding all factors of the large numbers.

| | | | | | | | |
|---|---|---|---|---|---|---|---|
| a. | 18 | b. | 54 | c. | 28 | d. | 25 |
| e. | 20 | f. | 64 | g. | 30 | h. | 29 |
| i. | 28 | j. | 32 | k. | 40 | l. | 43 |
| m. | 32 | n. | 25 | o. | 39 | p. | 42 |
| q. | 27 | r. | 36 | s. | 48 | t. | 35 |

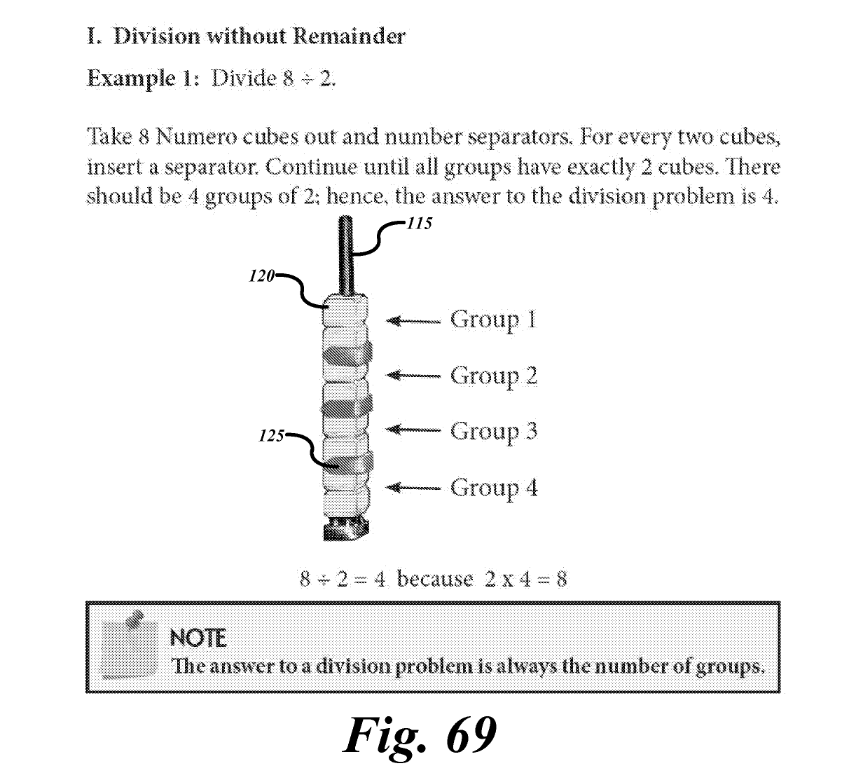

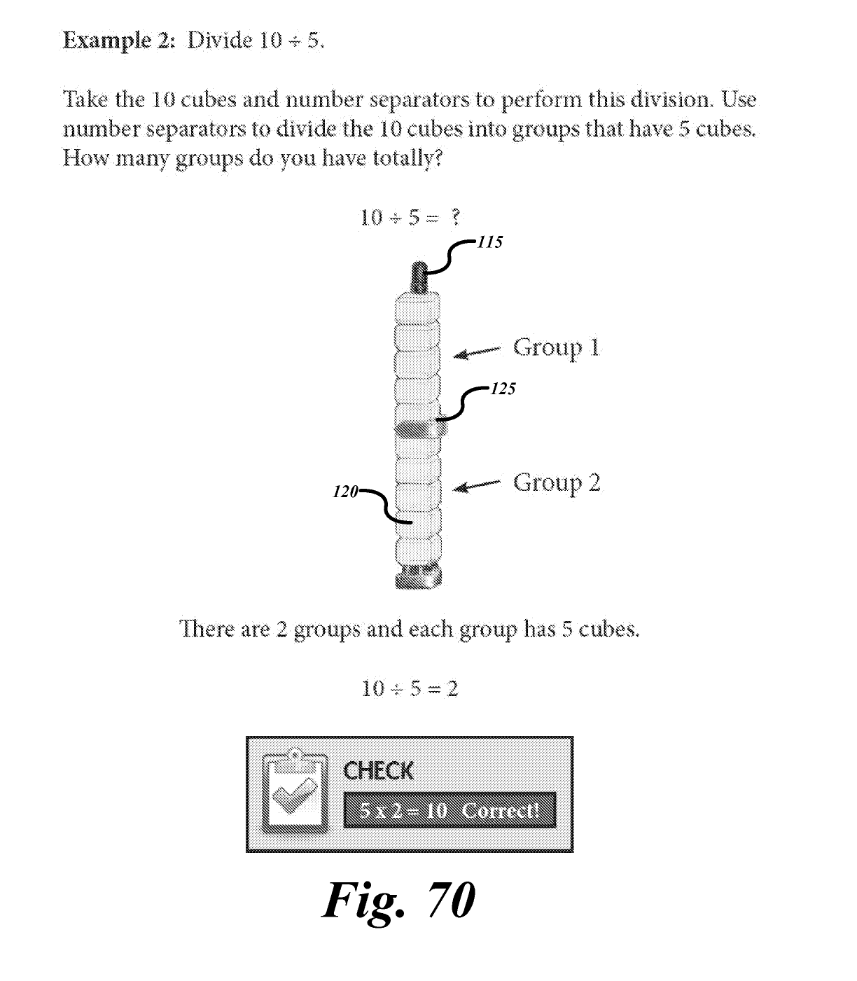

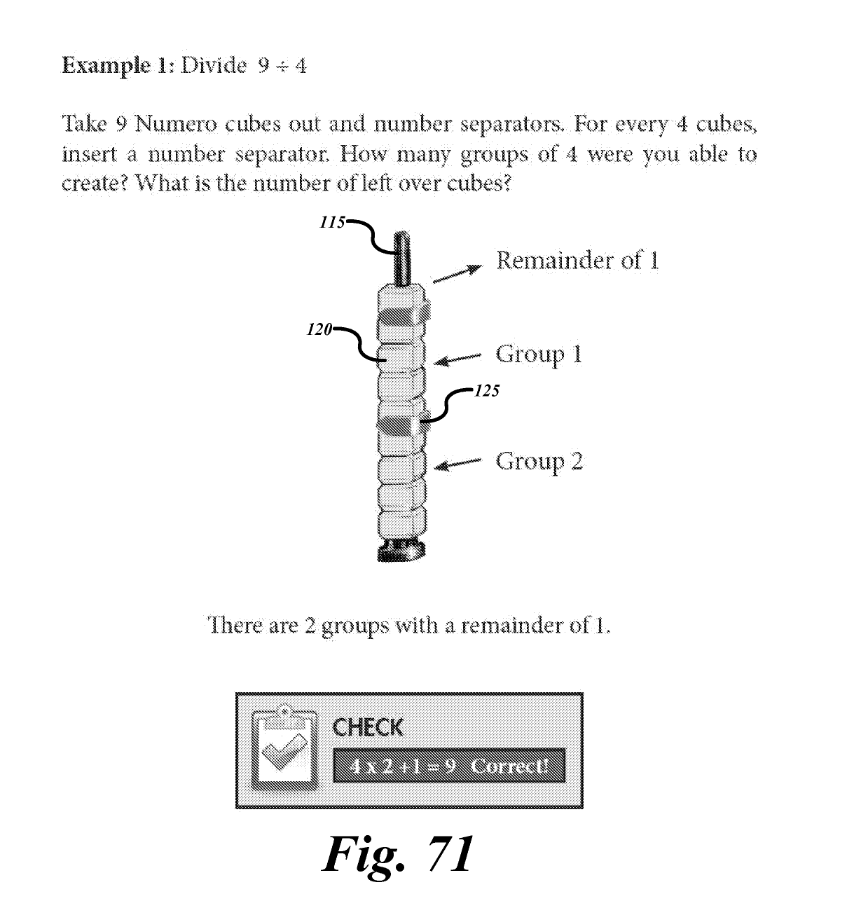

FIGS. 69-72 schematically illustrate methods of using the Numero Cube System 10 in algebraic operations involving division having no remainders or having remainders. Division is the reverse process of multiplication. Students are given a number of kit items from the Numero Cube System 10 to manipulate and may be split into different student groups using the kit items to engage in division exercises described below.

FIG. 69 schematically illustrates a method of using the Numero Cube System 10 in an algebraic operation involving division in which the answer to the division problem does not have a remainder. The answer to the division problem is visualized by the number of equally numbered cube 120 sets or groups in which the number separator 125 is interposed between the equally numbered cube 120 groups. In this illustration the students can manipulate the components of the system 10 with regards to the term 8÷2. Step 1 involves obtaining 8 cubes 120 and three number separators 125. For every group of 2 cubes 120, the number separator 125 is inserted between each group. This is continued until the student observes that there are groups of two cubes 120 without any cubes 120 leftover for assignment to a remainder group. That is, the remainder group does not exist because it is not visualized next to an equally-numbered 2-cube 120 group set having a number separator 125 located between each group. Thus the student will observe that the number separators 125 divide the 8 cubes 120 into four groups having 2 cubes 120 each, between which the number separator 125 is inserted to occupy the space between Group 1 and Group 2, Group 2 and Group 3, and Group 3 and Group 4. The student visually Observes that the answer to the division problem for terms not having remainders is the number of equal-cube 120 containing groups.

FIG. 70 schematically illustrates a method of using the Numero Cube System 10 in another algebraic operation involving division in which the answer to the division problem is visualized by the number of equally numbered cube 120 sets or groups in which the number separator 125 is interposed between the equally numbered cube 120 groups. In this illustration the students can manipulate the components of the system 10 with regards to the term 10÷5. Step 1 involves obtaining 10 cubes 120 and one number separators 125. For every group of five cubes 120, the number separator 125 is inserted between each group. This is continued until the student observes that there are groups of five cubes without any cubes 120 leftover in a remainder group. That is, the remainder group does not exist because it is not visualized next to an equally-numbered 5-cube 120 group set having a number separator 125. Thus the student will observe that the number separators 125 divide the ten cubes 120 into two groups having 5 cubes 120 each, between which the number separator 125 is inserted to occupy the space between the 5th cube 120 of the Group 2 set located in the bottom portion of the peg or stick 115 and the 1st cube 120 of the Group 1 set located in the upper portion of the peg or stick 115.

FIG. 71 schematically illustrates another use of the Numero Cube System 10 in an algebraic operation involving division and to determine the remainder of a division operation through use of the number separators 125. In this illustration the students can manipulate the components of the system 10 with regards to the term 9÷4, Step 1 involves obtaining 9 cubes 120 and two number separators 125. For every four cubes 120, the number separator 125 is inserted between. This is continued until the student observes that there are groups of four cubes 120 and some left over cubes 120 in a remainder group. In this illustration there are two four-cube 120 groups, i.e., group 1 and group 2, along with a remainder group having less than 5 cubes 120. In this example, the remainder group includes a single cube 120 to denote a remainder of one. To assist the student in learning, queries may be presented that ask how many four cube 120 groups totals are there, and how many cube 120 occupy the remainder group. In this illustration there is a 4-cube 120 Group 2 located at the bottom, a number separator 125, a 4-cube 120 Group 1, another number separator 125, and a remainder group having a single cube 120.

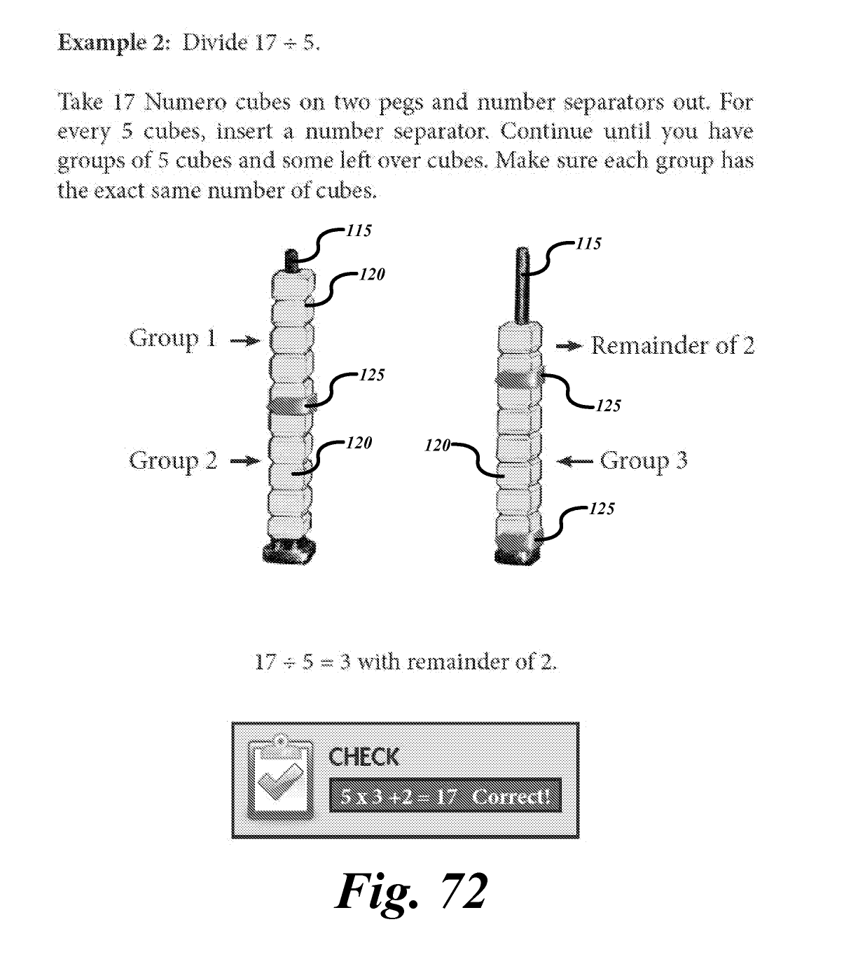

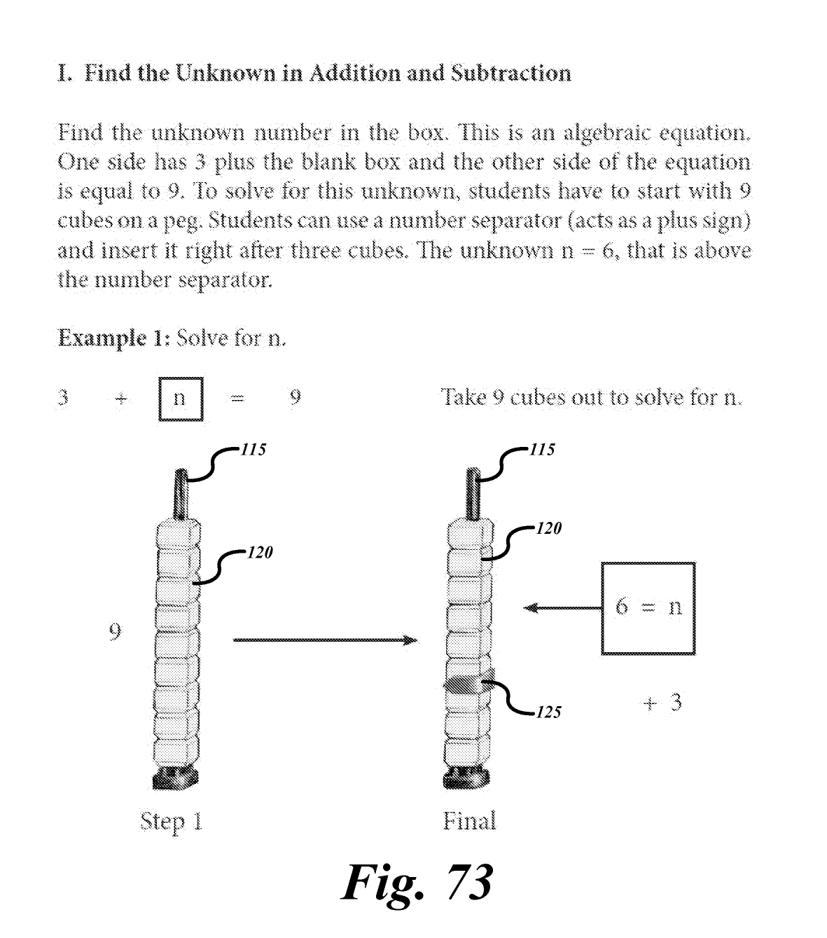

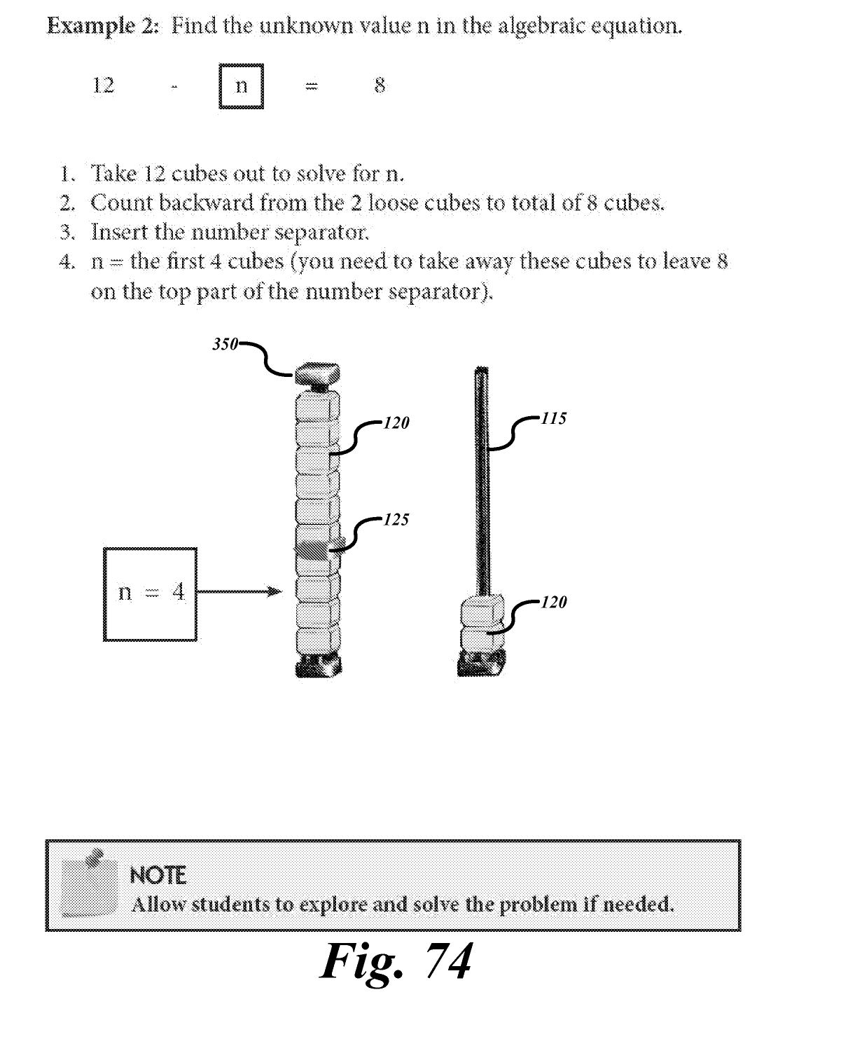

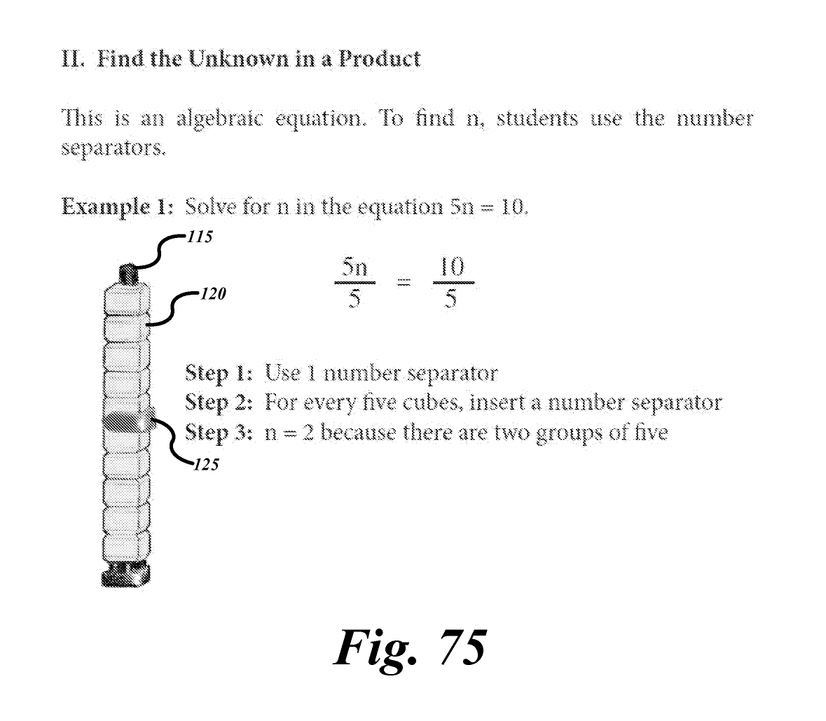

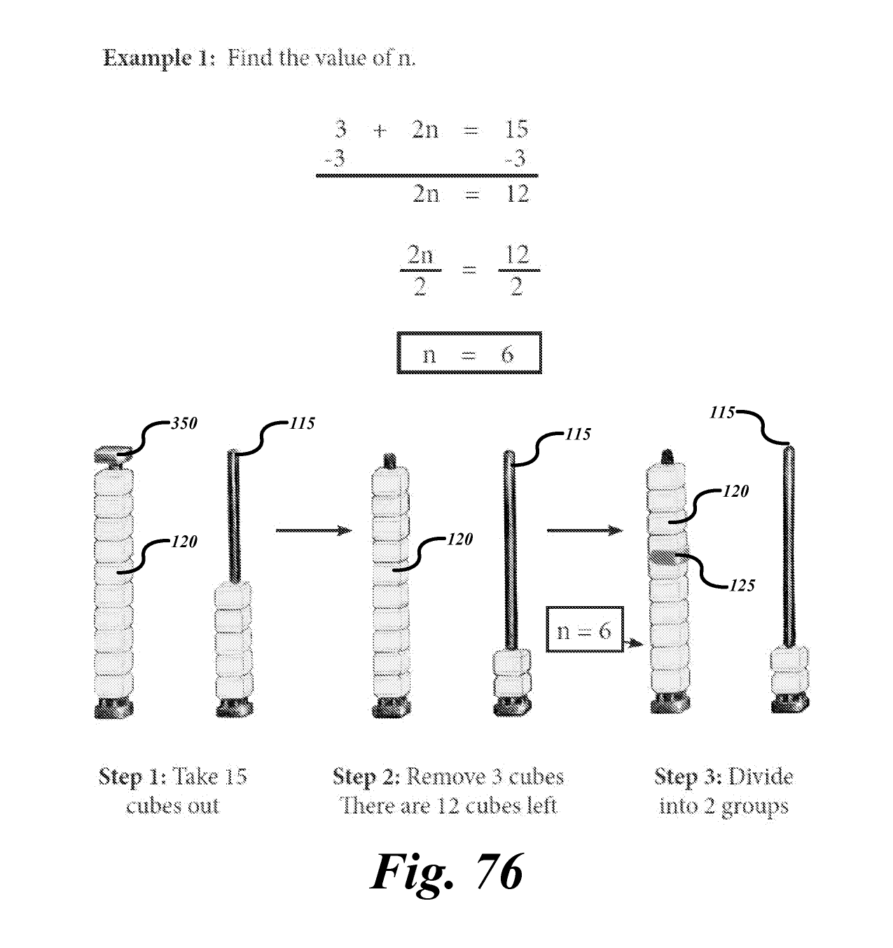

FIG. 72 schematically illustrates another use of the Numero Cube System 10 in an algebraic operation involving division and to determine the remainder of a division operation through use of the number separators 125 in this illustration the students can manipulate the components of the system 10 with regards to the term 17÷5. Step 1 involves obtaining 17 cubes 120, three number separators 125, and two pegs 115. For every five cubes 120, the number separator 125 is inserted between. This is continued until the student observes that there are groups of five cubes 120 and some left over cubes 120. In this illustration there are three five-cube 120 groups, i.e., groups 1, 2, and 3, and a remainder group having less than 5 cubes 120. Groups 1 and 2 occupy the first peg 115 with a number separator 125 inserted between Groups 1 and 2, and Group 3 and the remainder group occupy the second peg 115, with two number separators 125. The Group 3 set is bracketed by two number separator 125 located at the bottom of the peg 115 adjacent to the base 100, and one inserted between the remainder group and Group 3. In this example, the remainder group includes two cubes 120 to denote a remainder of two.

Exercise 1 provides a representative series of algebraic terms involving division that will have no remainders. The students may be encouraged to come up with other algebraic terms employing division without remainders.

| | | | | | | | |
|---|---|---|---|---|---|---|---|
| a. | 12 ÷ 4 | b. | 8 ÷ 2 | c. | 0 ÷ 5 | d. | 15 ÷ 5 |
| e. | 18 ÷ 6 | f. | 20 ÷ 5 | g. | 16 ÷ 4 | h. | 14 ÷ 2 |
| i. | 7 ÷ 7 | j. | 21 ÷ 3 | k. | 13 ÷ 13 | l. | 9 ÷ 3 |
| m. | 18 ÷ 9 | n. | 12 ÷ 3 | o. | 24 ÷ 6 | p. | 25 ÷ 5 |
| q. | 27 ÷ 9 | r. | 21 ÷ 3 | s. | 24 ÷ 4 | t. | 30 ÷ 5 |

Exercise 2 provides a representative series of algebraic terms involving division that will have remainder groups. The students may be encouraged to come up with other algebraic terms employing division with remainders.

| | | | | | | | |
|---|---|---|---|---|---|---|---|
| a. | 13 ÷ 2 | b. | 7 ÷ 4 | c. | 9 ÷ 5 | d. | 17 ÷ 3 |
| e. | 18 ÷ 7 | f. | 20 ÷ 8 | g. | 24 ÷ 9 | h. | 14 ÷ 5 |
| i. | 9 ÷ 2 | j. | 18 ÷ 4 | k. | 17 ÷ 13 | l. | 13 ÷ 6 |
| m. | 18 ÷ 6 | n. | 20 ÷ 3 | o. | 24 ÷ 9 | p. | 25 ÷ 7 |
| q. | 22 ÷ 5 | r. | 17 ÷ 5 | s. | 19 ÷ 6 | t. | 21 ÷ 5 |
| u. | 18 ÷ 4 | v. | 18 ÷ 7 | w. | 22 ÷ 8 | x. | 25 ÷ 4 |

FIGS. 73-76 schematically illustrate methods of using the components of the Numero Cube System 10 for solving for the unknown “n” in addition, subtraction, a product, and in a complex algebraic equation.

FIG. 73 schematically illustrates use of the Numero Cube System 10 in pre-algebra operations to determine the unknown in equations involving addition and subtraction through use of the number separators 125. In this illustration the students can manipulate the components of the system 10 to find “n” for an equation 3+n=9. Step 1 involves obtaining nine cubes 120. Thereafter, step 2 the student then inserts the number separator 125, wherein at the student determines that n=6 because the student has to take away these cubes to leave six cubes 120 on the top part of the shaft 115 in which the number separator 125 is lodged or resides.

This describes that the number “n” in the box of the algebraic equation 3+n=9 can be determined. One side has 3 plus the blank box and the other side of the equation is equal to nine. To solve for this unknown “n”, the students start with 9 cubes 120 on the shaft or peg 115. The students can use the number separator 125 to acts as a plus sign and insert it right after the three cubes. The unknown is n=6, the number of cubes 120 located above the number separator 125.

FIG. 74 schematically illustrates use of the Numero Cube System 10 in pre-algebra operations to determine the unknown in equations involving addition and subtraction through use of the number separators 125. In this illustration the students can manipulate the components of the system 10 to find “n” for an equation 12−n=8. Step 1 involves obtaining twelve cubes 120. Step 2 has the student counting backward from the two loose cubes 120 to a total of eight cubes 120. Thereafter, step 3 the student then inserts the number separator 125, wherein at step 4 the student determines that n=4 because the student has to take away these cubes to leave eight cubes on the top part of the shaft 115 in which the number separator 125 is lodged or resides.

Exercise 1 provides for solving “n” in each equation among a representative example of equations involving addition using the components of system 10.

| | | | | | | | |
|---|---|---|---|---|---|---|---|
| a. | n + 2 = 5 | b. | n + 1 = 7 | c. | n + 7 = 9 | d. | n + 3 = 14 |
| e. | 4 + n = 9 | f. | n + 8 = 12 | g. | n + 9 = 15 | h. | n + 4 = 13 |
| i. | 9 + n = 10 | j. | 7 + n = 18 | k. | 7 + n = 11 | l. | n + 10 = 18 |
| m. | 5 + n = 15 | n. | 9 + n = 16 | o. | 5 + n = 14 | p. | 9 + n = 15 |
| q. | 4 + n = 12 | r. | 8 + n = 17 | s. | 8 + 11 = 19 | t. | n + 8 = 11 |
| u. | 7 + n = 16 | v. | 1 + n = 13 | w. | 3 + n = 10 | x. | n + 5 = 10 |

Exercise 2 provides for solving “n” in each equation among a representative example of equations involving addition using the components of system 10.

| | | | | | | | |
|---|---|---|---|---|---|---|---|
| a. | n − 2 = 10 | b. | n − 5 = 10 | c. | n − 7 = 10 | d. | n − 4 = 10 |
| e. | n − 7 = 16 | f. | n − 4 = 16 | g. | n − 9 = 15 | h. | n − 3 = 11 |
| i. | 15 − n = 8 | j. | 13 − n = 8 | k. | 15 − n = 9 | l. | 9 − n = 15 |
| m. | 17 − n = 11 | n. | 12 − n = 6 | o. | 14 − n = 7 | p. | 16 − n = 8 |
| q. | 15 − n = 8 | r. | 11 − n = 5 | s. | n − 7 = 16 | t. | 12 − n = 9 |

In the series above the students can be allowed to explore and solve the problem.

FIG. 73 schematically illustrates a method of using the Numero Cube System 10 to determine the value “n” for a series of equations involving addition and subtraction. Step 1 involves taking 15 cubes 120 out. Step 2 involves removing 2 cubes 120 from the shaft 115 such that there are 12 cubes 120 left. Thereafter, step 3 involves dividing the cubes 120 into two number groups in which the number separator 125 is lodged between the two number groups.

FIG. 73 schematically illustrate a method of finding an unknown number “n” enclosed in the box depicted for the algebraic equation 3+n=9. One side has 3 plus the blank box and the other side of the equation is equal to 9. To solve for this unknown “n”, students have to start with 9 cubes 120/220 on a peg 115. Students can use the number separator 125 and construe that it functions as a plus sign. The number separator 125 is inserted right after three cubes. The unknown n=6 is above the number separator. Nine cubes 120/220 are taken out to solve for “n”.

FIG. 74 schematically illustrate a method of finding an unknown number “n” enclosed in the box depicted for the algebraic equation 12−n=8. Here 12 cubes 120 are distributed between two pegs 115, one peg 115 being filled and capped with a tens cap 350, and other peg 115 partially loaded with two cubes 120. The students count backward from the 2 loose cubes 120 to a total of 8 cubes 120. The number separator 125 is inserted. The solution for “n” is n=4 since n=the first 4 cubes 120 (attained by taking away these cubes to leave 8 on the top part of the number separator 125).

Exercise 1 provides for solving “n” in each equation among a representative example of equations involving addition using the components of system 10.

| | | | | | | | |
|---|---|---|---|---|---|---|---|
| a. | n + 2 = 5 | b. | n + 1 = 7 | c. | n + 7 = 9 | d. | n + 3 = 14 |
| e. | 4 + n = 9 | f. | n + 8 = 12 | g. | n + 9 = 15 | h. | n + 4 = 13 |
| i. | 9 + n = 10 | j. | 7 + n = 18 | k. | 7 + n = 11 | l. | n + 10 = 18 |
| m. | 5 + n = 15 | n. | 9 + n = 16 | o. | 5 + n = 14 | p. | 9 + n = 15 |
| q. | 4 + n = 12 | r. | 8 + n = 17 | s. | 8 + n = 19 | t. | n + 8 = 11 |
| u. | 7 + n = 16 | v. | 1 + n = 13 | w. | 3 + n = 10 | x. | n + 5 = 10 |

Exercise 2 provides for solving “n” in each equation among a representative example of equations involving subtraction using the components of system 10.

| | | | | | | | |
|---|---|---|---|---|---|---|---|
| a. | n − 2 = 10 | b. | n − 5 = 10 | c. | n − 7 = 10 | d. | n − 4 = 10 |
| e. | n − 7 = 16 | f. | n − 4 = 16 | g. | n − 9 = 15 | h. | n − 3 = 11 |
| i. | 15 − n = 8 | j. | 13 − n = 8 | k. | 15 − n = 9 | l. | 9 − n = 15 |
| m. | 17 − n = 11 | n. | 12 − n = 6 | o. | 14 − n = 7 | p. | 16 − n = 8 |
| q. | 15 − n = 8 | r. | 11 − n = 5 | s. | n − 7 = 16 | t. | 12 − n = 9 |

In the series above the students can be allowed to explore and solve the problem.

FIG. 75 schematically illustrate methods of using the components of the Numero Cube System 10 for solving for the unknown “n” in a product of an algebraic equation 5n=10. To find n, the students use the number separators 125. For every 5 cubes 120 in a filled peg 115 with tens cap 350, the number separator 125 is inserted. The student visually determines that the solution for “n” is n=2 because there are two groups of five cubes 120.

The students are encouraged to explore the product equations below and solve for “n” using the components of the Numero Cube System 10.

Exercise 1 below provides a representative example of product equation series for the students to solve for “n” in each equation using the components of system 10

| | | | | | | | |
|---|---|---|---|---|---|---|---|
| a. | 4n = 8 | b. | 2n = 10 | c. | 3n = 9 | d. | 5n = 10 |
| e. | 3n = 12 | f. | 5n = 20 | g. | 3n = 15 | h. | 4n = 16 |
| i. | 2n = 6 | j. | 6n = 12 | k. | 2n = 16 | l. | 5n = 25 |
| m. | 7n = 14 | n. | 3n = 15 | o. | 4n = 12 | p. | 3n = 18 |
| q. | 9n = 36 | r. | 7n = 28 | s. | 3n = 15 | t. | 6n = 36 |

FIG. 76 schematically illustrate methods of using the components of the Numero Cube System 10 for solving for the unknown “n” in complex algebraic equation 3+2n=15. To find n, step 1 involves the students obtaining 15 cubes 120 distributed among two pegs 115, one completely filled with 10 cubes 120 and wearing a tens cap 350, the other partially filled with 5 cubes 120. Step 2 the student removes 3 cubes 120 to leave 12 cubes 120. Step 3 the student divides the remaining 12 cubes 120 into two groups with the number separator 125. The answer for “n” is n=6.

Exercise 4 below provides a representative example addition equation series for the students to solve for “n” in each complex equation using the components of system 10.

| | | | | | | | |
|---|---|---|---|---|---|---|---|
| a. | 2n + 2 = 12 | b. | 3n + 3 = 15 | c. | 4n + 5 = 25 | d. | 2n + 6 = 26 |
| e. | 4n + 5 = 13 | f. | 6n + 4 = 28 | g. | 3n + 9 = 12 | h. | 5n + 7 = 22 |
| i. | 5n + 1 = 6 | j. | 7n + 2 = 16 | k. | 3n + 5 = 23 | l. | 4n + 2 = 14 |
| m. | 6n + 6 = 18 | n. | 3n + 5 = 26 | o. | 7n + 4 = 18 | p. | 9n + 1 = 10 |
| q. | 3n + 2 = 11 | r. | 4n + 1 = 13 | s. | n + 1 = 13 | t. | 6n + 3 = 15 |
| u. | 5n + 3 = 16 | v. | 5n + 5 = 20 | w. | 9n + 9 = 19 | x. | 4n + 5 = 9 |

Exercise 5 below provides a representative example of subtraction equation series for the students to solve for “n” in each complex equation using the components of system 10.

| | | | | | | | |
|---|---|---|---|---|---|---|---|
| a. | 2n − 2 = 12 | b. | 3n − 3 = 15 | c. | 4n − 5 = 11 | d. | 2n − 6 = 20 |
| e. | 4n − 5 = 11 | f. | 6n − 4 = 20 | g. | 3n − 9 = 3 | h. | 5n − 7 = 8 |
| i | 5n − 1 = 9 | j. | 7n − 2 = 12 | k. | 3n − 5 = 16 | l. | 4n − 2 = 14 |
| m. | 6n − 6 = 18 | n. | 3n − 5 = 13 | o. | 7n − 4 = 10 | p. | 9n − 1 = 8 |
| q. | 3n − 2 = 10 | r. | 4n − 1 = 15 | s. | 5n − 1 = 14 | t. | 6n − 3 = 9 |
| u. | 5n − 3 = 12 | v. | 5n − 5 = 20 | w. | 9n − 9 = 9 | x. | 4n − 5 = 15 |

While the preferred embodiment of the invention has been illustrated and described, as noted above, many changes may be made without departing from the spirit and scope of the invention. Accordingly, the scope of the invention is not limited by the disclosure of the preferred embodiment.

I claim:

1. A system to teach mathematics of the base 10 number system comprising:
at least one cube denoting a value increment of 1;
at least one peg denoting a value increment of zero, the at least one peg configured to hold one to ten at least one cubes; and
a card labeled with a ones column, a tens column, and a hundreds column;
wherein the at least one peg is placed to occupy the ones column, the tens column, or the hundreds column depending on the presence and quantity of cubes held by other at least one pegs and the location of the other at least one pegs within the ones column, the tens column, and the hundreds column.

2. The system of claim 1, further including a tray to receive up to ten at least one pegs each holding ten at least one cubes.

3. The system of claim 1, wherein the at least one peg includes a shaft with a base to allow the at least one peg to stand on the card.

4. The system of claim 1, further including a cap insertable on the at least one peg when the at least one peg holds ten at least one cubes.

5. A system to teach mathematics of the base 10 number system comprising:
at least one cube denoting a value increment of 1;
at least one peg denoting a value increment of zero, the at least one peg configured to hold one to ten at least one cubes;
wherein removal of any at least one cubes from the at least one peg denotes subtraction and placing of any at least one cubes to the at least one peg denotes addition.

6. The system of claim 5, further including:
a wedge insertable between any two at least one cubes occupying the at least one peg to indicate at least one number decomposition exercise.

7. The system of claim 5, further including:
a plurality of wedges, wherein different wedges are insertable between any two at least one cubes at different locations occupying the at least one peg to indicate at number decomposition exercises involving more than two numbers.

8. A method to teach mathematics of the base 10 number system comprising:
obtaining a card having at least one base 10 number group;
placing at least one peg denoting a value increment of zero within the at least one base 10 number group;
placing at least one cube denoting a value increment of 1 on the at least one peg to denote a number other than zero; and
manipulating the at least one peg to represent addition and subtraction in the base 10 systems within at least one base 10 number group.

9. The method of claim 8, wherein the manipulation further includes demonstrating number decomposition, conversion from standard to expanded form, number comparing, number multiplication, number factoring, and number division.

10. The method of claim 9, wherein number division includes answers having a remainder and answers not having a remainder.
